(19) United States
(12) Patent Application Publication
(10) Pub. No.: US 2025/0056588 A1
(43) Pub. Date: Feb. 13, 2025

(54) METHOD AND APPARATUS FOR CONTROL AND DATA CHANNEL TRANSMISSION AND RECEPTION IN WIRELESS COMMUNICATION SYSTEM

(71) Applicant: Samsung Electronics Co., Ltd., Gyeonggi-do (KR)

(72) Inventors: Sungjin PARK, Gyeonggi-do (KR); Hyunsuk RYU, Gyeonggi-do (KR); Kyoungmin PARK, Gyeonggi-do (KR); Seunghoon CHOI, Gyeonggi-do (KR)

(21) Appl. No.: 18/798,044

(22) Filed: Aug. 8, 2024

(30) Foreign Application Priority Data
Aug. 9, 2023 (KR) 10-2023-0104300

(51) Int. Cl. H04W 72/40; H04L 5/00; H04W 72/563

(52) U.S. Cl. CPC H04W 72/40; H04L 5/0053; H04W 72/563

(57) ABSTRACT

Methods and devices are provided in a wireless communication system. A plurality of physical sidelink shared channels (PSSCHs) is received, at a first user equipment (UE), from a second UE, on a first plurality of carriers. A plurality of physical sidelink feedback channels (PSFCHs) is transmitted, to the second UE, on a second plurality of carriers based on a first maximum number of simultaneous PSFCH transmissions in a slot. Each PSFCH of the plurality of PSFCHs corresponds to a respective PSSCH of the plurality of PSSCHs.

### CROSS-REFERENCE TO RELATED APPLICATION(S)

This application is based on and claims priority under 35 U.S.C. § 119 to Korean Patent Application No. 10-2023-0104300, filed on Aug. 9, 2023, in the Korean Intellectual Property Office, the disclosure of which is incorporated herein by reference in its entirety.

### BACKGROUND

### 1. Field

The disclosure relates generally to wireless communication systems, and more particularly, to a method and an apparatus for allocating resources in a wireless communication system

### 2. Description of Related Art

5^{th} generation (5G) mobile communication technologies define broad frequency bands such that high transmission rates and new services are possible, and can be implemented not only in “Sub 6 GHz” bands such as 3.5 gigahertz (GHz), but also in “Above 6 GHz” bands referred to as millimeter wave (mmWave) including 28 GHz and 39 GHz. Additionally, 6^{th} generation (6G) mobile communication technologies (also referred to as “beyond 5G systems”) may be implemented in terahertz (THz) bands (e.g., 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced mobile broadband (eMBB), ultra reliable low latency communications (URLLC), and massive machine-type communications (mMTC), there has been ongoing standardization regarding beamforming and massive multiple input-multiple output (MIMO) for mitigating radio-wave path loss and increasing radio-wave transmission distances in mmWave, supporting numerologies (e.g., operating multiple subcarrier spacings) for efficiently utilizing mmWave resources and dynamic operation of slot formats, initial access technologies for supporting multi-beam transmission and broadbands, definition and operation of bandwidth part (BWP), new channel coding methods such as a low density parity check (LDPC) code for large amount of data transmission and a polar code for highly reliable transmission of control information, layer-2 (L2) pre-processing, and network slicing for providing a dedicated network specialized to a specific service.

There have been discussions regarding improvement and performance enhancement of initial 5G mobile communication technologies in view of services to be supported by 5G mobile communication technologies, and there has been physical layer standardization regarding technologies such as vehicle-to-everything (V2X) for aiding driving determination by autonomous vehicles based on information regarding positions and states of vehicles transmitted by the vehicles and for enhancing user convenience, new radio-unlicensed (NR-U) aimed at system operations conforming to various regulation-related requirements in unlicensed bands, new radio (NR) user equipment (UE) power saving, non-terrestrial network (NTN) which is UE-satellite direct communication for providing coverage in an area in which communication with terrestrial networks is unavailable, and positioning.

Moreover, there has been ongoing standardization in air interface architecture/protocol regarding technologies, such as industrial Internet of things (IIoT), for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-step random access for simplifying random access procedures (2-step RACH for NR). There has been ongoing standardization in system architecture/service regarding a 5G baseline architecture (e.g., service based architecture or service based interface) for combining network functions virtualization (NFV) and software-defined networking (SDN) technologies, and mobile edge computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended reality (XR) for efficiently supporting augmented reality (AR)), virtual reality (VR), mixed reality (MR) and the like, 5G performance improvement and complexity reduction by utilizing artificial intelligence (AI) and machine learning (ML), AI service support, metaverse service support, and drone communication.

Furthermore, such development of 5G mobile communication systems will serve as a basis for developing not only new waveforms for providing coverage in THz bands of 6G mobile communication technologies, multi-antenna transmission technologies such as full dimensional MIMO (FD-MIMO), array antennas and large-scale antennas, metamaterial-based lenses and antennas for improving coverage of THz band signals, high-dimensional space multiplexing technology using orbital angular momentum (OAM), and reconfigurable intelligent surface (RIS), but also full-duplex technology for increasing frequency efficiency of 6G mobile communication technologies and improving system networks, AI-based communication technology for implementing system optimization by utilizing satellites and AI from the design stage and internalizing end-to-end AI support functions, and next-generation distributed computing technology for implementing services at levels of complexity exceeding the limit of UE operation capability by utilizing ultra-high-performance communication and computing resources.

### SUMMARY

An aspect of the disclosure provides a method and an apparatus for allocating resources in a wireless communication system.

According to an embodiment, a method performed by a first UE in a wireless communication system is provided. A plurality of physical sidelink shared channels (PSSCHs) is received, from a second UE, on a first plurality of carriers. A plurality of physical sidelink feedback channels (PSFCHs) is transmitted, to the second UE, on a second plurality of carriers based on a first maximum number of simultaneous PSFCH transmissions in a slot. Each PSFCH of the plurality of PSFCHs corresponds to a respective PSSCH of the plurality of PSSCHs.

According to an embodiment, a method performed by a second UE in a wireless communication system is provided. A plurality of PSSCHs is transmitted, to a first UE, on a first plurality of carriers. A plurality of PSFCHs is received, from the first UE, on a second plurality of carriers based on a first maximum number of simultaneous PSFCH transmissions in a slot. Each PSFCH of the plurality of PSFCHs corresponds to a respective PSSCH of the plurality of PSSCHs.

According to an embodiment of the disclosure, a first UE is provided in a wireless communication system. The first UE includes a transceiver and a controller coupled to the transceiver. The controller is configured to receive, from a second UE, a plurality of PSSCHs on a first plurality of carriers, and transmit, to the second UE, a plurality of PSFCHs on a second plurality of carriers based on a first maximum number of simultaneous PSFCH transmissions in a slot. Each PSFCH of the plurality of PSFCHs corresponds to a respective PSSCH of the plurality of PSSCHs.

According to an embodiment, a second UE is provided in a wireless communication system. The second UE includes a transceiver; and a controller coupled to the transceiver. The controller is configured to transmit, to a first UE, a plurality of PSSCHs on a first plurality of carriers, and receive, from the first UE, a plurality of PSFCHs on a second plurality of carriers based on a first maximum number of simultaneous PSFCH transmissions in a slot. Each PSFCH of the plurality of PSFCHs corresponds to a respective PSSCH of the plurality of PSSCHs.

### BRIEF DESCRIPTION OF THE DRAWINGS

The above and other aspects, features, and advantages of embodiments of the disclosure will be more apparent from the following description taken in conjunction with the accompanying drawings, in which:

FIG. 1 is a diagram illustrating a system, according to an embodiment;

FIG. 2 is a diagram illustrating a V2X communication method, according to an embodiment;

FIG. 3 is a diagram illustrating a protocol of a V2X UE, according to an embodiment;

FIG. 4 is a diagram illustrating an example of a V2X communication procedure according to an embodiment;

FIG. 5 is a diagram illustrating a V2X communication procedure, according to an embodiment;

FIG. 6 is a diagram illustrating a sidelink (SL) resource pool for performing V2X communication by a V2X UE, according to an embodiment;

FIG. 7 is a diagram illustrating a multiplexing scheme of an SL control channel, an SL data channel, and an SL feedback channel in an SL resource pool, according to an embodiment;

FIG. 8A is a diagram illustrating an example of time axis resource allocation of an SL feedback channel, according to an embodiment;

FIG. 8B is a diagram illustrating another example of time axis resource allocation of an SL feedback channel, according to an embodiment;

FIG. 9A is a diagram illustrating an example of a resource structure of an SL feedback channel, according to an embodiment;

FIG. 9B is a diagram illustrating another example of a resource structure of an SL feedback channel, according to an embodiment;

FIG. 10 is a diagram illustrating an example of frequency resource allocation of an SL feedback channel, according to an embodiment;

FIG. 11 is a diagram illustrating another example of frequency resource allocation of an SL feedback channel, according to an embodiment;

FIG. 12 is a diagram illustrating another example of time axis resource allocation of an SL feedback channel, according to an embodiment;

FIG. 13A is a diagram illustrating another example of frequency resource allocation of an SL feedback channel, according to an embodiment;

FIG. 13B is a diagram illustrating another example of frequency resource allocation of an SL feedback channel, according to an embodiment;

FIG. 13C is a diagram illustrating another example of frequency resource allocation of an SL feedback channel, according to an embodiment;

FIG. 13D is a diagram illustrating another example of frequency resource allocation of an SL feedback channel, according to an embodiment;

FIG. 13E is a diagram illustrating an example of calculating the number of bits of feedback information transmitted via an SL feedback channel, according to an embodiment;

FIG. 14 is a diagram illustrating another example of frequency resource allocation of an SL feedback channel, according to an embodiment;

FIG. 15 is a diagram illustrating another example of frequency resource allocation of an SL feedback channel, according to an embodiment;

FIG. 16 is a diagram illustrating another example of frequency resource allocation of an SL feedback channel, according to an embodiment;

FIG. 17 is a diagram illustrating another example of frequency resource allocation of an SL feedback channel, according to an embodiment;

FIG. 18 is a diagram illustrating another example of frequency resource allocation of an SL feedback channel, according to an embodiment;

FIG. 19 is a diagram illustrating another example of frequency resource allocation of an SL feedback channel, according to an embodiment;

FIG. 20A is a diagram illustrating another example of frequency resource allocation of an SL feedback channel, according to an embodiment;

FIG. 20B is a diagram illustrating another example of frequency resource allocation of an SL feedback channel, according to an embodiment;

FIG. 21A is a diagram illustrating another example of frequency resource allocation of an SL feedback channel, according to an embodiment;

FIG. 21B is a diagram illustrating another example of frequency resource allocation of an SL feedback channel, according to an embodiment;

FIG. 22A is a flowchart illustrating an operation of a reception UE for SL hybrid automatic repeat request (HARQ) feedback transmission, according to an embodiment;

FIG. 22B is a flowchart illustrating an operation of a reception UE for SL HARQ feedback transmission, according to an embodiment;

FIG. 23 illustrates a transmission power control method of an SL feedback channel, according to an embodiment;

FIG. 24 is a block diagram illustrating a transmission UE, according to an embodiment;

FIG. 25 is a block diagram illustrating a reception UE, according to an embodiment;

FIG. 26 is a block diagram illustrating a base station, according to an embodiment;

FIG. 27 is a diagram illustrating a V2X communication method, according to an embodiment;

FIG. 28 is a diagram illustrating a method in which a UE allocates transmission power for multiple PSFCH transmissions, according to an embodiment; and

FIG. 29 is a diagram illustrating PSFCHs scheduled in resource pools in multiple carriers, according to an embodiment of the disclosure.

### DETAILED DESCRIPTION

Embodiments of the disclosure are described in detail below with reference to the accompanying drawings. Similar components may be designated by the same or similar reference numerals although they are illustrated in different drawings.

In describing the embodiments, descriptions related to technical contents well-known in the relevant art and not associated directly with the disclosure will be omitted. Such an omission of unnecessary descriptions is intended to prevent obscuring of the main idea of the disclosure and more clearly transfer the main idea.

For the same reason, in the accompanying drawings, some elements may be exaggerated, omitted, or schematically illustrated. Furthermore, the size of each element does not completely reflect the actual size.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference signs indicate the same or like elements.

Herein, each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block in the flowchart illustrations may represent a module, segment, or portion of code, which includes one or more executable instructions for implementing the specified logical function(s). In some alternative implementations, the functions noted in the blocks may occur out of order. For example, two blocks shown in succession may in fact be executed substantially concurrently or the blocks may sometimes be executed in the reverse order, depending upon the functionality involved.

As used in embodiments of the disclosure, the “unit” refers to a software element or a hardware element, such as a field programmable gate array (FPGA) or an application specific integrated circuit (ASIC), which performs a predetermined function. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” may be implemented to reproduce one or more central processing units (CPUs) within a device or a security multimedia card. Furthermore, the “unit” in embodiments may include one or more processors.

The following detailed description of embodiments of the disclosure is mainly directed to NR as a radio access network and packet core (5G system or 5G core network or next generation core (NG Core)) as a core network in the 5G mobile communication standards specified by the 3rd generation partnership project (3GPP) that is a mobile communication standardization group, but based on determinations by those skilled in the art, the main idea of the disclosure may be applied to other communication systems having similar backgrounds through some modifications without significantly departing from the scope of the disclosure.

In the following description, some of terms and names defined in the 3GPP long term evolution (LTE) standards (standards for 5G, NR, LTE, or similar systems) may be used for the convenience of description. However, the disclosure is not limited by these terms and names, and may be applied in the same way to systems that conform other standards.

In the following description, terms for identifying access nodes, terms referring to network entities, terms referring to messages, terms referring to interfaces between network entities, terms referring to various identification information, and the like are illustratively used for the sake of descriptive convenience. Therefore, the disclosure is not limited by the terms as used herein, and other terms referring to subjects having equivalent technical meanings may be used.

In the following description, a base station is an entity that allocates resources to terminals, and may be at least one of a gNode B, an eNode B, a Node B, a base station (BS), a wireless access unit, a BS controller, and a node on a network. A terminal may include a UE, a mobile station (MS), a cellular phone, a smartphone, a computer, or a multimedia system capable of performing a communication function. Of course, the BS is not limited to the above examples. Herein, a “downlink (DL)” refers to a radio link via which a base station transmits a signal to a terminal, and an “uplink (UL)” refers to a radio link via which a terminal transmits a signal to a base station. To meet the demand for wireless data traffic having increased since deployment of 4G communication systems, efforts have been made to develop an improved 5G communication system (NR). The 5G communication system has been designed to support ultrahigh frequency (mmWave) bands (e.g., 28 GHz frequency bands) so as to accomplish higher data rates. To decrease propagation loss of the radio waves and increase the transmission distance in the ultrahigh frequency bands, beamforming, massive MIMO, FD-MIMO, array antenna, analog beam forming, large scale antenna techniques are under discussion in the 5G communication systems. Also, unlike in LTE, in the 5G communication systems, various subcarrier spacings including 15 kHz, 30 kHz, 60 kHz, and 120 kHz are supported, physical control channels use polar coding, and physical data channels use LDPC. In addition, cyclic prefix (CP)-orthogonal frequency division multiplexing (OFDM), as well as discrete Fourier transform-spread (DFT-S)-OFDM, is also used as a waveform for UL transmission. While HARQ retransmission in units of transport blocks (TBs) are supported in LTE, HARQ retransmission based on a code block group (CBG) including a bundle of a plurality of code blocks (CBs) may be additionally supported in 5G.

In addition, in the 5G communication system, technical development for system network improvement is under way based on evolved small cells, advanced small cells, cloud radio access networks (RANs), ultra-dense networks, device-to-device (D2D) communication, wireless backhaul, moving network, cooperative communication, coordinated multi-points (CoMPs), reception-end interference cancellation, and the like.

The Internet, which is a human centered connectivity network where humans generate and consume information, is now evolving to the Internet of things (IoT) where distributed entities, such as things, exchange and process information without human intervention. The Internet of everything (IoE), which is a combination of the IoT technology and the big data processing technology through a connection with a cloud server, etc. has emerged. As technology elements, such as “sensing technology”, “wired/wireless communication and network infrastructure”, “service interface technology”, and “security technology” have been demanded for IoT implementation, a sensor network, a machine-to-machine (M2M) communication, machine type communication (MTC), and so forth have recently been researched. Such an IoT environment may provide intelligent Internet technology (IT) services that create a new value to human life by collecting and analyzing data generated among connected things. IoT may be applied to a variety of fields including smart home, smart building, smart city, smart car or connected cars, smart grid, health care, smart appliances and advanced medical services through convergence and combination between existing information technology (IT) and various industrial applications.

In line with this, various attempts have been made to apply the 5G communication system to IoT networks. For example, technologies such as a sensor network, MTC, and M2M communication are implemented by beamforming, MIMO, and array antenna techniques that are 5G communication technologies. Application of a cloud radio access network (RAN) as the above-described big data processing technology may also be considered an example of convergence of the 5G technology with the IoT technology. As described above, a plurality of services may be provided to a user in a communication system, and in order to provide such a plurality of services to a user, a method for providing each service within the same time period according to the characteristics and an apparatus using the same are required. Various services to be provided in the 5G communication system are being studied, and one of them is a service that satisfies requirements for low latency and high reliability.

In the case of vehicle communication, LTE-based V2X has completed, based on a D2D communication structure, standardization in 3GPP Rel-14 and Rel-15, and efforts are currently underway to develop V2X based on 5G NR. NR V2X is scheduled to support unicast communication between UEs, groupcast (or multicast) communication, and broadcast communication. In addition, unlike LTE V2X, which aims to transmit and receive basic safety information necessary for vehicles to travel on the road, NR V2X aims to provide more advanced services, such as platooning, advanced driving, extended sensor, or remote driving.

The NR V2X reception UE may transmit SL control information and data information to the NR V2X reception UE. The NR V2X reception UE having received the information may transmit an acknowledgement (ACK) or negative acknowledgement (NACK) for the received SL data information to the NR V2X transmission UE. The ACK/NACK information may be referred to as SL feedback control information (SFCI). The SFCI may be transmitted through the PSFCH of the physical layer.

Meanwhile, the NR V2X transmission UE may transmit an SL reference signal to allow the NR V2X reception UE to obtain information about the SL channel state. In this case, the SL reference signal may be a demodulation reference signal (DMRS) used for the NR V2X reception UE to perform channel estimation or channel state information reference signal (CSI-RS) for obtaining channel state information (CSI). When the CSI-RS is used, it may be transmitted using a time/frequency/code resource different from that of the DMRS. The NR V2X reception UE having obtained the CSI about the SL channel through the DMRS or the CSI-RS transmitted by the NR V2X transmission UE may report the obtained CSI to the NR V2X transmission UE. In this case, the CSI may be the above-described SFCI and may be transmitted through the SL feedback channel. As another example, HARQ-ACK/NACK information and CSI report information may be multiplexed and simultaneously transmitted through an SL feedback channel.

An embodiment is proposed to support the above-described scenario and is to provide a method and an apparatus for transmitting or receiving an SL feedback channel by an NR V2X UE.

The disclosure relates to a method for allocating resources of a feedback channel in a wireless communication system and, specifically, to a method and an apparatus for allocating resources for transmission and reception of an SL feedback channel between UEs.

An embodiment provides a method and an apparatus for allocating resources for transmitting and receiving an SL feedback channel by a UE in a wireless communication environment in which the SL feedback channel between UEs exists.

Herein, terms and names defined in 5GS and NR standards, which are the standards specified by the 3GPP group among the existing communication standards, will be used for the sake of descriptive convenience. However, the disclosure is not limited by these terms and names, and may be applied in the same way to systems that conform other standards. For example, the disclosure may be applied to the 3GPP 5GS/NR (5G mobile communication standards).

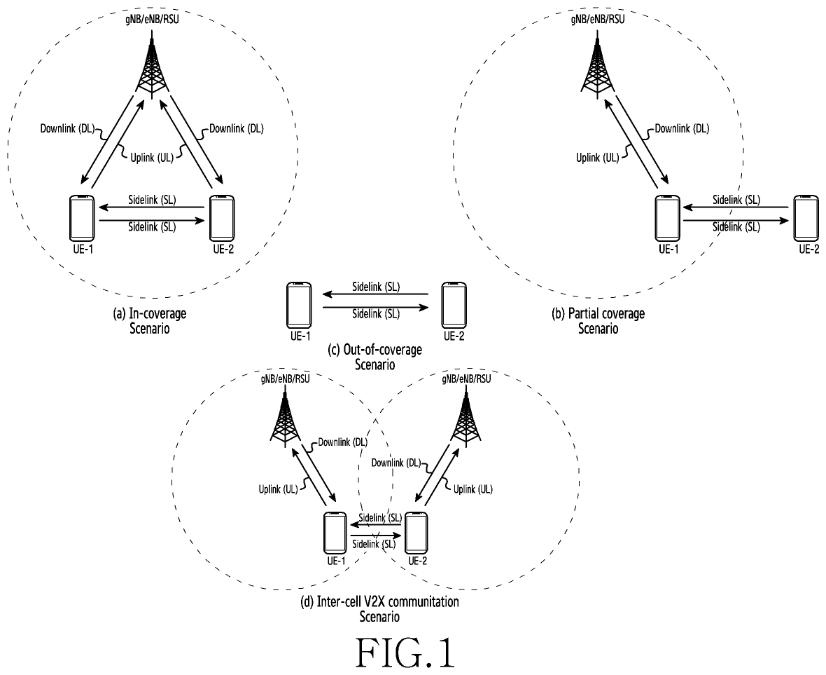

FIG. 1 is a diagram illustrating a system, according to an embodiment.

Part (a) of FIG. 1 illustrates an example in which all V2X UEs (UE-1 and UE-2) are positioned within the coverage (in-coverage) of a base station (gNB/eNB/RSU).

All V2X UEs (UE-1 and UE-2) may receive data and control information from the BS (gNB/eNB/RSU) through a DL, or transmit data and control information to the base station through a UL. In this case, the data and control information may be data and control information for V2X communication. Alternatively, the data and control information may be data and control information for normal cellular communication. In addition, V2X UEs (UE-1 and UE-2) may transmit/receive data and control information for V2X communication through an SL.

Part (b) of FIG. 1 illustrates an example in which UE-1 among V2X UEs is positioned within the coverage of the BS (gNB/eNB/RSU) and UE-2 is positioned out of the coverage of the base station (gNB/eNB/RSU). The example according to part (b) of FIG. 1 may be referred to as an example of partial coverage.

UE-1 positioned in the coverage of the BS (gNB/eNB/RSU) may receive data and control information from the BS (gNB/eNB/RSU) through a DL or transmit data and control information to the BS (gNB/eNB/RSU) through a UL.

UE-2 positioned out of the coverage of the BS (gNB/eNB/RSU) cannot receive data and control information from the BS (gNB/eNB/RSU) through the DL, and cannot transmit data and control information to the BS (gNB/eNB/RSU) through the UL.

UE-2 may transmit or receive data and control information for V2X communication to or from UE-1 through an SL.

Part (c) of FIG. 1 illustrates an example in which all the V2X UEs (UE-1 and UE-2) are positioned out of the coverage (out-of-coverage) of the base station (gNB/eNB/RSU).

Accordingly, UE-1 and UE-2 cannot receive data and control information from the BS (gNB/eNB/RSU) through the DL, and cannot transmit data and control information to the BS (gNB/eNB/RSU) through the UL.

UE-1 and UE-2 may transmit or receive data and control information for V2X communication to or from each other through an SL.

Part (d) of FIG. 1 is an example in which V2X communication is performed between UEs positioned in different cells. Specifically, part (d) of FIG. 1 illustrates a case where a V2X transmission UE and a V2X reception UE are connected to different BSs (gNB/eNB/RSU) (a radio resource control (RRC)-connected state) or camp on different BSs (an RRC connection released state, i.e., RRC idle state) (inter-cell V2X communication). In this case, UE-1 may be a V2X transmission UE, and UE-2 may be a V2X reception UE. Alternatively, UE-1 may be a V2X reception UE and UE-2 may be a V2X transmission UE. UE-1 may receive a V2X-dedicated system information block (SIB) from a BS (gNB/eNB/RSU) to which UE-1 is connected (or on which UE-1 camps), and UE-2 may receive a V2X-dedicated SIB from another base station to which UE-2 is connected (or on which UE-2 camps). In this case, the V2X-dedicated SIB information received by UE-1 and the V2X-dedicated SIB information received by UE-2 may differ from each other. Therefore, it is necessary to match information to perform V2X communication between UEs positioned in different cells.

In FIG. 1, for convenience of description, a V2X system including two UEs (UE-1 and UE-2) is shown, but the disclosure is not limited thereto, and multiple UEs may participate in the V2X system. In addition, the UL and DL between the BS (gNB/eNB/RSU) and the V2X UEs (UE-1 and UE-2) may be referred to as Uu interfaces, and the SL between the V2X UEs (UE-1 and UE-2) may be referred to as a PC5 interface. Therefore, these may be interchangeably used herein.

Herein, a vehicle may mean a vehicle supporting vehicle-to-vehicle (V2V) communication, a vehicle or a pedestrian's handset supporting vehicle-to-pedestrian (V2P) communication, a vehicle supporting vehicle-to-network (V2N) communication, or a vehicle supporting vehicle-to-infrastructure (V2I) communication. In addition, a UE may be a road side unit (RSU) equipped with a UE function, an RSU equipped with a BS function, an RSU equipped with a part of the BS function and a part of the UE function, etc.

In addition, the BS may be pre-defined as a BS supporting both V2X communication and general cellular communication, or a BS supporting only V2X communication. In addition, in this case, the BS may be a 5G BS (gNB), a 4G BS (eNB), or a RSU. Therefore, unless otherwise described, the BS and the RSU may be used to have the same concept, and thus, the BS and the RSU may be used interchangeably.

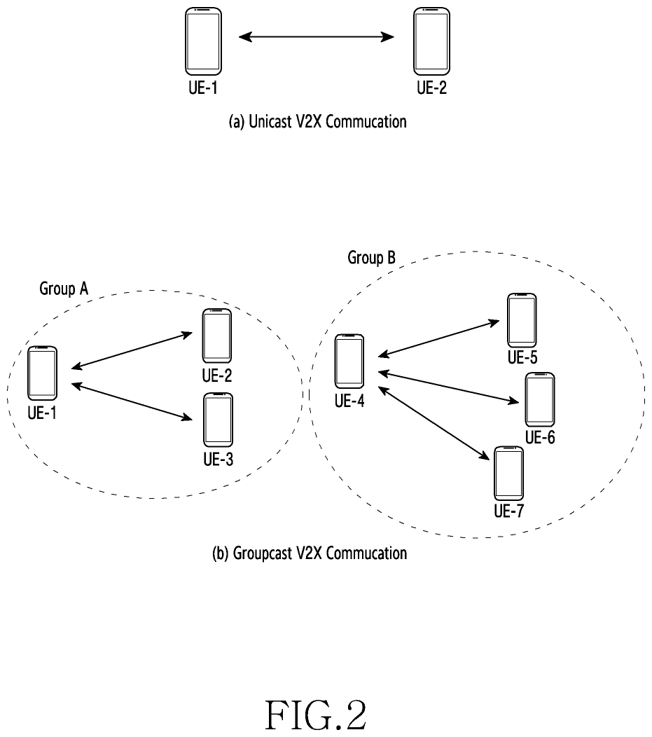

FIG. 2 is a diagram illustrating a V2X communication method, according to an embodiment.

As shown in part (a) of FIG. 2, a transmission (TX) UE and a reception (RX) UE may perform one-to-one communication, which may be referred to as unicast communication.

As shown in part (b) of FIG. 2, a TX UE and a RX UE may perform one-to-many communication. This may be referred to as groupcast or multicast communication.

Part (b) of FIG. 2 illustrates that UE-1, UE-2, and UE-3 form one group (group A) to perform groupcast communication, and UE-4, UE-5, UE-6, and UE-7 form another group (group B) to perform groupcast communication. Each UE may perform groupcast communication only within the group to which it belongs and perform communication with UEs present in different groups through unicast, groupcast or broadcast communication. Part (b) of FIG. 2 illustrates that two groups are formed, but the disclosure is not limited thereto, and more groups may be formed.

V2X UEs may perform broadcast communication. Broadcast communication may mean a case in which all V2X UEs can receive the data and control information transmitted by a V2X transmission UE through an SL. For example, when it is assumed that UE-1 in part (b) of FIG. 2 is a transmission UE for broadcast, all the UEs (UE-2, UE-3, UE-4, UE-5, UE-6, and UE-7) may receive the data and control information transmitted by UE-1.

According to an embodiment, the SL broadcast, groupcast, and unicast communication methods may be supported in the in-coverage, out-of-coverage, and partial-coverage scenarios.

An NR V2X system may consider support of a transmission form in which a vehicle UE transmits data to only one specific UE through unicast and a transmission form in which a vehicle UE transmits data to a number of specific UEs through groupcast, unlike an LTE V2X system. For example, these unicast and groupcast techniques can be useful when considering service scenarios, such as platooning, which is a technique for connecting two or more vehicles via one network to allow the vehicles to travel in group. Specifically, unicast communication may be required for the purpose of controlling one specific UE by a leader UE of a group connected via platooning, and groupcast communication may be needed for the purpose of simultaneously controlling a group including a specific number of UEs.

Resource allocation in the V2X system according to an embodiment may use the following methods.

### Mode 1 Resource Allocation

Mode 1 resource allocation may mean a scheduled resource allocation method by the BS. More specifically, in mode 1 resource allocation, the base station may allocate resources used for SL transmission to RRC-connected UEs in a dedicated scheduling scheme. The scheduled resource allocation method may be effective for interference management and resource pool management (dynamic allocation and/or semi-persistent transmission) because the base station may manage SL resources. If there is data to be transmitted to the other UE(s), the RRC connected mode UE may transmit information notifying the base station that there is data to be transmitted to the other UE(s) by means of an RRC message or medium access control (MAC) control element (CE). For example, the RRC message may be a SidelinkUEInformation or UEAssistanceInformation message, and may correspond to a scheduling request (SR) or buffer status report (BSR) MAC CE including at least one of an indicator indicating that the MAC CE is a BSR for V2X communication, information about the size of the data buffered for SL communication, etc. The SL transmission UE receives resource scheduling by the base station, and thus the mode 1 resource allocation is applicable only when the V2X transmission UE is in the coverage of the base station.

### Mode 2 Resource Allocation

Mode 2 resource allocation may mean a method in which an SL transmission UE autonomously selects resources (UE autonomous resource selection). More specifically, mode 2 resource allocation is a method in which the base station provides the UE with an SL transmission/reception resource pool for V2X through system information or an RRC message (e.g., an RRCReconfiguration message or a PC5-RRC message), and the transmission UE selects a resource pool and resources according to a determined rule. In the above-described example, the base station provides configuration information about the SL transmission/reception resource pool, and thus, the mode 2 resource allocation is applicable when the V2X transmission/reception UE is in the coverage of the BS. When the V2X transmission/reception UE is out of the coverage of the BS, the V2X transmission/reception UE may perform a mode 2 resource allocation operation in a preconfigured transmission/reception resource pool. The UE autonomous resource selection method may include zone mapping, sensing-based resource selection, random selection, etc.
Additionally, although the V2X transmission/reception UE is in the coverage of the base station, scheduled resource allocation or resource allocation or resource selection in the UE autonomous resource selection mode may not be performed, and in this case, the UE may perform V2X SL communication through a preconfigured SL transmission/reception resource pool.

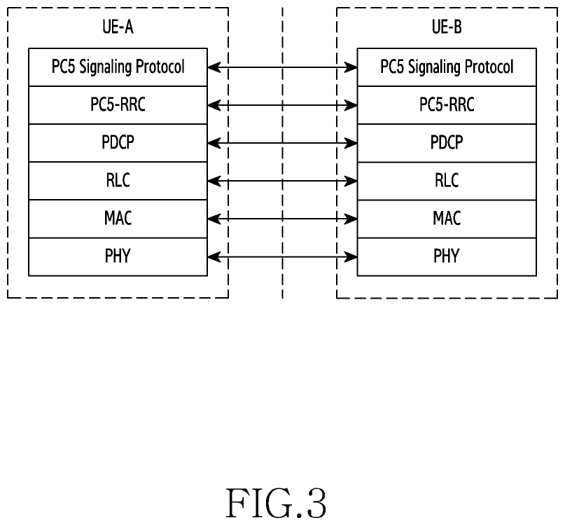

FIG. 3 is a diagram illustrating a protocol of a V2X UE, according to an embodiment.

Application layers of UE-A and UE-B may perform service discovery. In this case, service discovery may include discovery of a V2X communication scheme (e.g., unicast, groupcast, or broadcast) performed by each UE. Accordingly, in FIG. 3, it may be assumed that UE-A and UE-B have recognized to perform the unicast communication scheme via the service discovery process performed on the application layer. The NR V2X UEs may obtain information about a source ID and a destination ID for NR V2X unicast communication in the above-described service discovery process.

If the service discovery process is completed, the PC5 signaling protocol layer shown in FIG. 3 may perform a direct link setup procedure between UEs. In this case, security configuration information for direct communication between UEs may be transmitted or received.

If the direct link setup procedure is completed, a PC5-RRC setup procedure between UEs may be performed in the PC5-RRC layer of FIG. 3. In this case, information about capabilities of UE-A and UE-B may be exchanged, and access stratum (AS) layer parameter information for unicast communication may be exchanged.

When the PC5-RRC configuration procedure is completed, UE-A and UE-B may perform unicast communication.

Although unicast communication has been described above, it may be similarly applied to group cast communication. For example, when UE-A, UE-B, and UE-C perform group cast communication, as described above, the service discovery between UE-A and UE-B, the direct link setup, and the PC5-RRC setup procedure may be performed in UE-B and UE-C, and UE-A and UE-C.

More specifically, the NR V2X UEs may obtain information about the source ID and destination ID for NR V2X groupcast communication in the above-described service discovery process. If the service discovery process is completed, the PC5 signaling protocol layer shown in FIG. 3 may perform a direct link setup procedure between UEs. In this case, security configuration information for direct communication between UEs may be transmitted or received.

If the direct link setup procedure is completed, a PC5-RRC setup procedure between UEs may be performed in the PC5-RRC layer of FIG. 3. In this case, information about capabilities of UE-A, UE-B, and UE-C may be exchanged, and AS layer parameter information for groupcast communication may be exchanged. However, when there are three or more UEs, a lot of signaling overhead and communication latency may occur in exchanging information about their capabilities and AS layer parameter information. Therefore, in the case of groupcast communication, if the described direct link setup procedure is completed, the PC5-RRC setup procedure between UEs may be omitted.

When the PC5-RRC setup procedure is completed (or when the direct link setup procedure is completed in the case where the PC5-RRC setup procedure is omitted), UE-A, UE-B, and UE-C may perform groupcast communication.

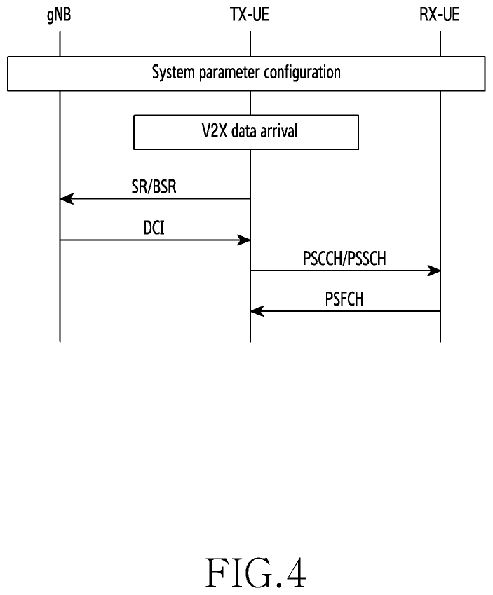

FIG. 4 is a diagram illustrating an example of a V2X communication procedure, according to an embodiment.

More specifically, FIG. 4 illustrates a V2X communication procedure based on the mode 1 resource allocation described in FIG. 2. In FIG. 4, the gNB may configure parameters for V2X communication to the V2X UE in the cell through system information. For example, the gNB may configure information about a resource pool in which V2X communication may be performed in its own cell. In this case, the resource pool may refer to a transmission resource pool for V2X transmission or a reception resource pool for V2X reception. In addition, the resource pool may refer to an SL control information resource pool for transmitting or receiving V2X control information, an SL data information resource pool for transmitting or receiving V2X data information, or an SL feedback information resource pool for transmitting or receiving V2X feedback information.

The V2X UE may receive configuration of information about one or more resource pools from the gNB. The gNB may configure unicast, group cast, and broadcast communication to be performed in different resource pools through system information. For example, resource pool 1 may be used for unicast communication, resource pool 2 may be used for groupcast, and resource pool 3 may be used for broadcast communication. As another example, the BS may configure unicast, group cast, and broadcast communication to be performed in the same resource pool. At least one piece of the following information may be included in the resource pool information configured by the gNB.
Time axis information about a resource pool in which a physical SL control channel (PSCCH) and a (PSSCH can be transmitted: Specifically, the information may include an index and a period of a slot in which the PSCCH and the PSSCH can be transmitted, an index of a slot in which the PSCCH and the PSSCH can be transmitted, an index and a period of a symbol in the corresponding slot, etc.
Frequency axis information about a resource pool in which the PSCCH and the PSSCH can be transmitted: Specifically, the information may include an index of a resource block in which the PSCCH and the PSSCH can be transmitted or an index of a sub-channel including two or more resource blocks.
Information about whether SL HARQ-ACK is operated may be included in resource pool configuration information.
   At least one piece of the following information may be included for the case where SL HARQ-ACK is operated.
      Number of maximum retransmissions
      HARQ-ACK timing: This means a time interval from a time point at which the V2X reception UE receives SL control information and data information from the V2X transmission UE to a time point at which the V2X reception UE transmits HARQ-ACK/NACK information to the V2X transmission UE. In this case, a time unit may be a slot or one or more OFDM symbols.
      Format of physical SL feedback channel (PSFCH): When two or more PSFCH formats are operated, one PSFCH format may be used to transmit HARQ-ACK/NACK information including 1 bit or 2 bits. Another PSFCH format may be used to transmit HARQ-ACK/NACK information including 3 bits or more. When the above-described HARQ-ACK/NACK information is transmitted through a PSFCH, ACK information and NACK information each may be transmitted through the PSFCH. In this case, the NR V2X reception UE may transmit an ACK through the PSFCH when decoding of the PSSCH transmitted from the NR V2X transmission UE is successfully performed. If decoding fails, NACK may be transmitted through the PSFCH. As another example, the NR V2X reception UE may not transmit ACK when decoding of the PSSCH transmitted from the NR V2X transmission UE is successfully performed, but may transmit NACK through the PSFCH only when decoding fails.
      Time/frequency/code resource or set of resources constituting PSFCH: A time resource may include a slot index or a symbol index and period for PSFCH transmission. A frequency resource may include a start point and an end point (or a start point and the length of a frequency resource) of the sub-channel including two or more contiguous blocks or a frequency resource block (RB) in which the PSFCH is transmitted.
   When SL HARQ-ACK is not operated, information related to an SL feedback channel may not be included.
Information about whether blind retransmission is operated may be included in resource pool configuration information.
   Unlike HARQ-ACK/NACK-based retransmission, blind retransmission may mean that the NR transmission UE does not receive feedback information about ACK or NACK from the NR reception UE but the NR transmission UE repeatedly perform transmission. When blind retransmission is operated, the number of blind retransmissions may be included in resource pool information. For example, in a case where the number of blind retransmissions is set to 4, the NR transmission UE may always transmit the same information four times when transmitting the PSCCH/PSSCH to the NR reception UE. In this case, a redundancy version (RV) value may be included in SL control information (SCI) transmitted through the PSCCH.
Information about a DMRS pattern that may be used in a PSSCH transmitted in the corresponding resource pool.
   Depending on the speed of the UE, the DMRS pattern that may be used in the PSSCH may be different. For example, it is necessary to increase the number of OFDM symbols used for DMRS transmission on the time axis to enhance the accuracy of channel estimation when the speed is high. In addition, since the accuracy of channel estimation may be guaranteed even when a small number of DMRS symbols are used when the speed of the UE is low, it is necessary to reduce the number of OFDM symbols used for DMRS transmission on the time axis to reduce DMRS overhead. Accordingly, information about the resource pool may include information about the DMRS pattern usable in the corresponding resource pool. In this case, two or more DMRS patterns may be configured in one resource pool, and the NR V2X transmission UE may select and use one DMRS pattern from DMRS patterns configured according to its own speed. In addition, the NR V2X transmission UE may transmit the information about the DMRS pattern selected by itself to the NR V2X reception UE through the SCI of the PSCCH. The NR V2X reception UE may receive the same and obtain DMRS pattern information, may perform channel estimation for PSSCH, and may perform demodulation and decoding process to obtain SL data information.
Whether SL CSI-RS is operated
   At least one piece of the following information may be included when the SL CSI-RS is operated.
      CSI-RS transmission start time point: This may mean a start time point at which the V2X transmission UE needs to transmit the CSI-RS to the V2X reception UE. The start time point may refer to an index of a slot where the CSI-RS is transmitted or an index of a symbol where the CSI-RS is transmitted or both the slot index and the symbol index.
      CSI reporting timing: This means a time interval from a time point of reception of the CSI-RS by the V2X reception UE from the V2X transmission UE (i.e., the received slot index or the symbol index in the received slot) to a time point at which the V2X reception UE transmits CSI reporting to the V2X transmission UE (i.e., the slot index where the CSI reporting is transmitted or the symbol index in the slot index transmitted). In this case, a time unit may be a slot or one or more OFDM symbols.
   When SL CSI-RS is not operated, the information may not be included.
      Parameter for SL transmission power control

The above-described information has been exemplified to be included in the resource pool configuration for V2X communication, but the disclosure is not limited thereto. In other words, the above-described information may be configured for the V2X transmission UE or the V2X reception UE independently from resource pool configuration.

As shown in FIG. 4, when data to be transmitted to the V2X RX-UE is generated in the V2X TX-UE, the V2X transmission UE may request, from the gNB, an SL resource to be transmitted to the V2X reception UE by using a SR and/or BSR. The gNB having received the BSR may identify that the UE has data for SL transmission and determine, based on the BSR, resources necessary for SL transmission.

The gNB may transmit, to the V2X transmission UE, an SL scheduling grant including at least one of resource information for SL data transmission and resource information for SCI transmission. The SL scheduling grant is information for granting dynamic scheduling in the SL and may be DL control information (DCI) transmitted on a physical DL control channel (PDCCH). The SL scheduling grant may include information indicating a BWP where SL transmission is performed and a carrier indicator field (CIF) or carrier frequency indicator where SL transmission is performed in a case where the base station is an NR base station, and may include only the CIF in a case where the base station is an LTE base station. In addition, the SL scheduling grant may further include resource allocation-related information of the PSFCH transmitting feedback information (A/N information) for the SL data. The resource allocation information may include information for allocating multiple PSFCH resources for multiple UEs in the group when the SL transmission is groupcast. In addition, the resource allocation-related information of the feedback information may be information indicating at least one of a set of a plurality of feedback information resource candidates configured via higher layer signaling.

The V2X TX-UE having received the SL scheduling grant transmits the SCI scheduling SL data according to the SL scheduling grant to the V2X RX-UE through a PSCCH and transmits SL data through the PSSCH. The SCI may include at least one of resource allocation information used for transmission of the SL data, modulation and coding scheme (MCS) information applied to the SL data, group destination ID information, source ID information, unicast destination ID information, power control information of SL power control, timing advance (TA) information, DMRS configuration information for SL transmission, packet repetitive transmission-related information (e.g., the number of packet repetitive transmissions, resource allocation-related information upon packet repetitive transmission, RV, and a HARQ process ID). In addition, the SCI may further include information indicating the resource where feedback information (A/N information) for SL data is transmitted.

The V2X RX-UE having received the SCI receives SL data. Thereafter, the V2X RX-UE transmits ACK/NACK information indicating whether decoding of SL data succeeds or fails to the V2X transmission UE on the PSFCH. The feedback information transmission for SL may be applied to unicast transmission or groupcast transmission, but does not exclude broadcast transmission. If the SL transmission corresponds to groupcast transmission, each UE having received the groupcast data may transmit feedback information by using different PSFCH resources. Alternatively, each UE having received groupcast data may transmit feedback information by using the same PSFCH resource, and in this case, feed back only NACK information (i.e., the UE having received data does not perform feedback in the case of ACK). In this case, the PSFCH resources may include not only resources distinguished in the time and/or frequency domain but also resources distinguished using a code such as a scrambling code or an orthogonal cover code and resources distinguished using different sequences (and cyclic shift applied to the sequence).

FIG. 4 assumes a scenario in which the V2X TX-UE is in a state of being connected to the gNB via UL connection (i.e., an RRC-connected state), and both the V2X TX-UE and the V2X RX-UE are present in the coverage of the gNB. When the V2X transmission UE is in a state of not being connected to the gNB via UL connection (i.e., an RRC idle state), the V2X TX-UE may perform a random access procedure for a UL connection configuration with the gNB. In addition, in a scenario where the V2X TX-UE is present in the coverage of the gNB and the V2X RX-UE is present out of the coverage of the gNB, the V2X RX-UE may be previously configured with and use the above-described information for V2X communication. Meanwhile, the V2X TX-UE may be configured with information for V2X communication from the gNB as shown in FIG. 4.

When both the V2X TX-UE and the V2X RX-UE are present out of the coverage of the gNB, the V2X TX-UE and the V2X RX-UE may be previously configured with and use the above-described information for V2X communication. In this case, when being previously configured, it may mean that a value stored in the UE when the release of the UE is used. In another sense, when the V2X TX-UE or RX-UE has accessed the gNB and has obtained information about V2X communication through an RRC configuration or has an experience of having obtained the information about V2X communication through system information of the base station, it may mean the latest obtained information.

In addition, it may be assumed that the V2X TX-UE has completed the service discovery, direct link setup procedure, and PC5 RRC configuration with the V2X RX-UE through the procedure described in FIG. 3 before transmitting an SR/BSR to the gNB.

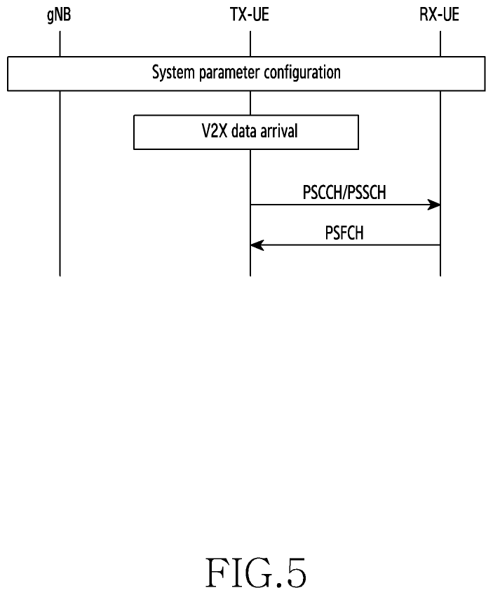

FIG. 5 is a diagram illustrating another V2X communication procedure, according to an embodiment.

More specifically, FIG. 5 illustrates a V2X communication procedure based on the mode 2 resource allocation described in FIG. 2. In FIG. 5, the gNB may configure parameters for V2X communication to the V2X transmission/reception UEs in the cell through system information. In this case, the parameters may include at least one of the parameter information illustrated in FIG. 4.

As shown in FIG. 5, when data to be transmitted from the V2X TX-UE to the V2X RX-UE is generated, the V2X TX-UE may transmit SCI to the V2X RX-UE through the PSCCH and transmit SL data through the PSSCH. The SCI may include at least one of resource allocation information used for transmission of the SL data, MCS information applied to the SL data, group destination ID information, source ID information, unicast destination ID information, power control information of SL power control, timing advance information, DMRS configuration information for SL transmission, packet repetitive transmission-related information (e.g., the number of packet repetitive transmissions, resource allocation-related information upon packet repetitive transmission, an RV, and a HARQ process ID). In addition, the SCI may further include information indicating the resource where feedback information (A/N information) for SL data is transmitted.

The V2X RX-UE having received the SCI may receive SL data. Thereafter, the V2X RX-UE may transmit ACK/NACK information indicating whether decoding of SL data succeeds or fails to the V2X TX-UE on the PSFCH. The feedback information transmission for SL may be applied to unicast transmission or groupcast transmission, but does not exclude broadcast transmission. If the SL transmission corresponds to groupcast transmission, each UE having received the groupcast data may transmit feedback information by using different PSFCH resources. Alternatively, each UE having received groupcast data may transmit feedback information by using the same PSFCH resource, and in this case, feed back only NACK information (i.e., the UE having received data does not perform feedback upon determining ACK). In this case, the PSFCH resources may include not only resources distinguished in the time and/or frequency domain but also resources distinguished using a code such as a scrambling code or an orthogonal cover code and resources distinguished using different sequences (and cyclic shift applied to the sequence).

In FIG. 5, a scenario in which all the V2X transmission/reception UEs are present in the coverage of the gNB may be assumed. The example of FIG. 5 may be applied even when all the V2X transmission/reception UEs are present out of the coverage of the gNB. In this case, the V2X transmission/reception UEs may be previously configured with the above-described information for V2X communication. In addition, the example of FIG. 5 may be applied even in a scenario where one UE among the V2X transmission/reception UEs is present in the coverage of the gNB, and the remaining UEs are present out of the coverage of the gNB. In this case, the UE present in the coverage of the gNB may be configured with the information for V2X communication by the gNB, and the UE present out of the coverage of the gNB may previously be configured with the information for V2X communication. In the example, the “information for V2X communication” may be interpreted as information about at least one of the parameters for V2X communication as described in FIG. 4 above. In addition, in an example, when being previously configured, it may mean that a value stored in the UE when the UE is released is used. In another sense, when the V2X TX-UE or V2X RX-UE has accessed the gNB and obtained information about V2X communication through RRC configuration or has an experience of having obtained the information about V2X communication through the system information, it may mean the latest obtained information obtained.

It may be assumed that the V2X TX-UE has completed the service discovery, direct link setup procedure, and PC5 RRC configuration with the V2X RX-UE through the procedure described in FIG. 3 before the V2X transmission UE transmits the PSCCH/PSSCH to the V2X RX-UE.

Although unicast communication, where there is only one V2X RX-UE, is described in FIG. 5, the same example of FIG. 5 may be applied to groupcast communication and broadcast communication where there are two or more V2X RX-UEs.

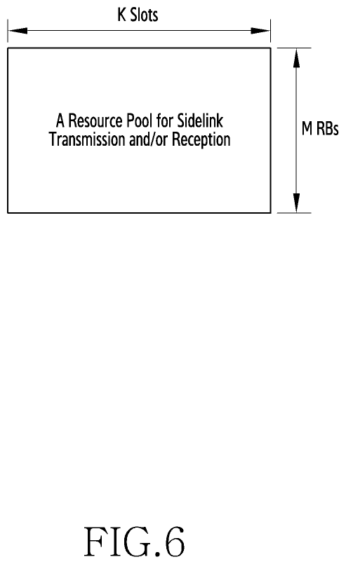

FIG. 6 is a diagram illustrating an SL resource pool for performing V2X communication by a V2X UE, according to an embodiment.

Specifically, the SL resource pool of FIG. 6 may include K slots on the time axis and M RBs on the frequency axis. One slot is generally composed of 14 OFDM symbols, but may not be limited thereto. In other words, one slot constituting the SL resource pool may be less than 14 OFDM symbols. In addition, in K slots constituting the SL resource pool, each slot may include the same number of OFDM symbols (that is, each slot includes L symbols in K slots), or each slot may include a different number of OFDM symbols. One resource block may include 12 subcarriers.

The K slots may be physically contiguous or logically contiguous on the time axis (if the slots are logically contiguous, the slots may be physically non-contiguous). Similarly, M resource blocks may be physically contiguous or logically contiguous on the frequency axis (if the blocks are logically contiguous, the blocks may be physically non-contiguous).

The V2X transmission UE may use the SL resource pool of FIG. 6 to transmit SL control information, data information or feedback information. In addition, the V2X reception UE may use the SL resource pool of FIG. 6 to receive SL control information or data information and transmit SL feedback information.

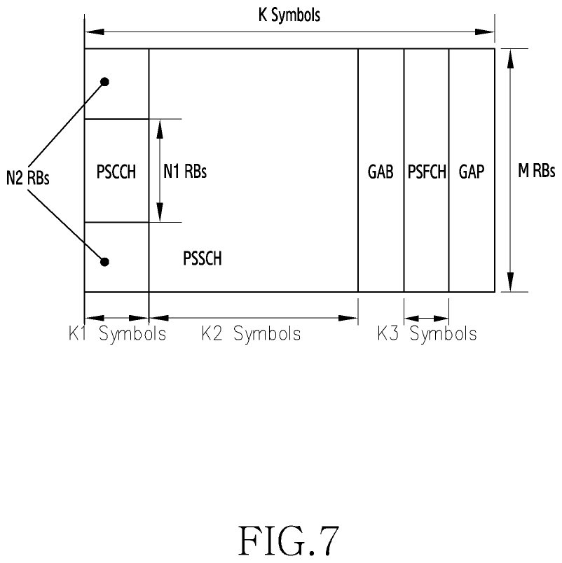

FIG. 7 is a diagram illustrating a multiplexing scheme of an SL control channel, an SL data channel, and an SL feedback channel in an SL resource pool, according to an embodiment.

FIG. 7 illustrates that a PSCCH is multiplexed with a PSSCH on the time axis and frequency axis (i.e., time division multiplexing (TDM) and frequency division multiplexing (FDM)). In this case, the PSCCH and the PSSCH may include different numbers of resource blocks on the frequency axis. In other words, as illustrated in FIG. 7, the PSCCH may include N1 resource blocks on the frequency axis, and the PSSCH may include M resource blocks. In this case, N1 may be smaller than M (N1<M). However, a case where the PSCCH and the PSSCH include the same number of resource blocks (M RBs) on the frequency axis, or a case where the number of resource blocks of the PSCCH is greater than the number of resource blocks of the PSSCH (i.e., N1>M) may not be excluded.

In addition, as illustrated in FIG. 7, the PSCCH and the PSSCH are frequency division multiplexed in K1 OFDM symbols on the time axis, and in the remaining K2 symbols, only the PSSCH may be transmitted without transmitting the PSCCH. In other words, the PSCCH may include N1 frequency blocks on the frequency axis and K1 OFDM symbols on the time axis. The PSSCH may include N2 frequency blocks for the length of K1 OFDM symbols, and may be frequency-divided with the PSCCH. In addition, the PSSCH may include M frequency blocks without frequency division with the PSCCH for the length of K2 OFDM symbols. In this case, a sum of N2 and N1 may be equal to or different from M.

FIG. 7 illustrates that N1 frequency blocks constituting the PSCCH and (M−N2) frequency blocks constituting the PSSCH are physically contiguous, but they may not be physically contiguous (that is, logically contiguous but physically non-contiguous). Values of K1 and K2 may be equal to or different from each other, and when the values of K1 and K2 are different from each other, K1>K2 or K1<K2. The V2X transmission UE may include time/frequency allocation information of the PSSCH in SL control information transmitted through the PSCCH and transmit the same. After receiving and decoding the PSCCH, the V2X reception UE may obtain time/frequency allocation information of the PSSCH and decode the PSSCH. Although FIG. 7 illustrates that K2 symbols constituting the PSSCH are physically continuously positioned after K1 symbols constituting the PSCCH, the symbols may not be physically contiguous (that is, they may be logically contiguous but physically non-contiguous).

FIG. 7 illustrates a case in which an PSFCH exists in an SL resource including K OFDM symbols. In this case, one slot may include a PSCCH K1 symbol, a PSSCH K2 symbol (when considering only symbols not FDMed with the PSCCH; if considering a case of being FDMed with the PSCCH, the PSSCH is K1+K2 symbols), a guard symbol (GAP), a PSFCH K3 symbol, and a guard symbol GAP in the time axis. In other words, K1+K2+guard symbol 1+K3+guard symbol 2=K. In this case, guard symbol 1 and guard symbol 2 may be one OFDM symbol or two or more OFDM symbols. Guard symbol 1 may be required for conversion between transmission and reception for the V2X transmission UE to transmit the PSCCH and PSSCH and receive the PSFCH. Conversely, from the perspective of the V2X reception UE, guard symbol 1 may be required for conversion between reception and transmission for the V2X reception UE to receive the PSCCH and PSSCH and transmit the PSFCH. Similarly, guard symbol 2 may be required for conversion between reception and transmission for the V2X transmission UE to receive the PSFCH from the V2X reception UE and transmit the PSCCH and PSSCH in the next SL resource. Conversely, from the perspective of the V2X reception UE, guard symbol 2 may be required for conversion between transmission and reception for the V2X reception UE to transmit the PSFCH to the V2X transmission UE and to receive the PSCCH and PSSCH in the next SL resource.

One of guard symbol 1 and guard symbol 2 may be 0. For example, when the V2X transmission UE receives the PSFCH and receives the PSCCH and the PSSCH from another UE in the next SL resource, conversion between reception and transmission is not required, and thus the number of guard symbols 2 may be 0. In addition, a case where at least one of K1, K2, and K3 is 0 may not be excluded.

Although the frequency resource block size of the PSFCH is shown as being the same as that of the PSSCH in FIG. 7 (i.e., M RBs), the resource block size of PSFCH on the frequency axis may be identical to or different from the resource block size of the PSCCH and the PSSCH. After decoding the PSSCH, the V2X reception UE may include the success result (i.e., ACK/NACK information) in the PSFCH and transmit the same to the V2X transmission UE.

In the above-described examples, the time and frequency resources of the PSFCH transmitted by one V2X UE may be defined as K3 OFDM symbols and M resource blocks, respectively. In this case, all the V2X UEs may use the same K3 value and M value regardless of the location of the UE (in coverage, out of coverage, or partial coverage of the base station). As another example, at least one of K3 and M may be configured by the base station or the V2X UE. More specifically, the base station may transmit information about the SL resource pool to V2X UEs present in its cell through system information (SIB) or RRC configuration. In this case, information about the resource pool may include at least one of K3 and M. As another example, when V2X transmission/reception UE pairs performing unicast or groupcast communication exchange AS layer parameters through PC-5 RRC configuration as described in FIG. 3, at least one of K3 and M may be configured. As another example, at least one of K3 and M may be a pre-configured value.

When the PSFCH uses two or more formats (e.g., one PSFCH format is used to transmit SL feedback information of 2 bits or less, and another PSFCH format is used to transmit SL feedback information including more than 2 bits), at least one PSFCH format may use a fixed value for at least one of K3 and M.

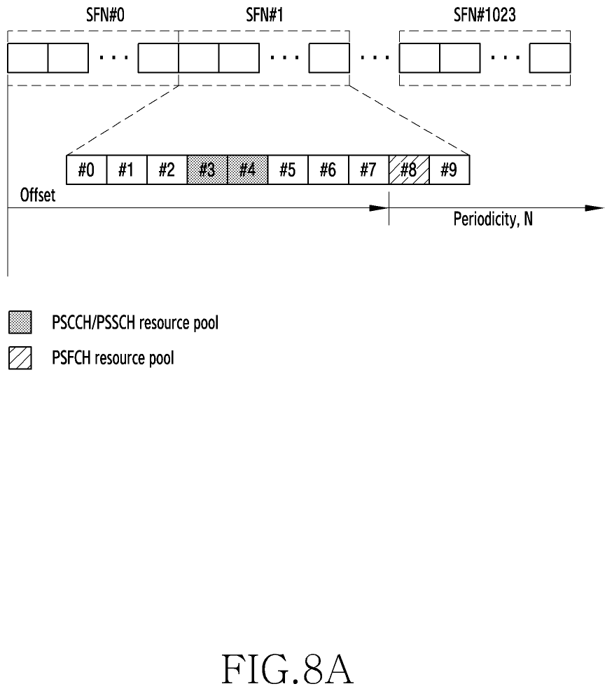

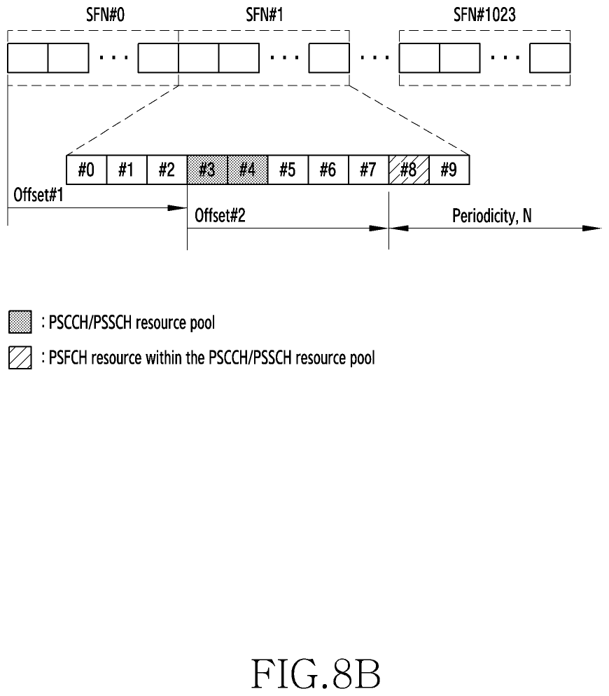

FIGS. 8A and 8B are diagrams illustrating an example of time axis resource allocation of an SL feedback channel, according to an embodiment.

Resource allocation on the time axis of the PSFCH may mean a start point of a resource where the PSFCH can be transmitted and a period in which a resource where the PSFCH can be transmitted exists. Specifically, the start point of the resource where the PSFCH can be transmitted may include the index of the slot where the PSFCH can be transmitted or the index of the slot where the PSFCH can be transmitted and the symbol index in the corresponding slot.

FIG. 8A is a diagram illustrating a method for allocating a resource pool of a PSFCH and illustrates a case where the resource pool of the PSFCH is allocated independently from configuration of a resource pool where a PDCCH and a PSSCH are transmitted. In other words, it is illustrated that the PSFCH resource starts from slot index 8 of system frame “1” with reference to system frame number “0”, and such a PSFCH time axis resource is repeated with period N. The V2X reception UE may transmit, based on such information, its HARQ-ACK/NACK information to the V2X transmission UE through the PSFCH in the slot where the PSFCH is present.

When there is no base station (i.e., when the V2X reception UE is present out of the coverage of the base station), the start point of the resource pool where the PSFCH can be transmitted may be configured with reference to direct frame number (DFN) 0.

The above-described PSFCH time axis resource allocation method may be seen as described in terms of the system. In other words, in the V2X system, a start slot and period of a PSFCH resource pool may be configured, which may not mean that one V2X reception UE needs to always use the corresponding resource. As an example, in terms of the system, the PSFCH resource pool may start from slot “8” of system frame “1” and the period may have N slots as shown in FIG. 8A. A specific V2X reception UE may use the PSFCH resource only when the V2X reception UE needs to transmit the PSFCH of the PSFCH resource pool configured in terms of the system. For example, a time point at which the V2X reception UE needs to transmit the PSFCH may be K slots after a time point at which the V2X reception UE receives the PSCCH and the PSSCH from the V2X transmission UE. The timing relationship “K” between the PSCCH/PSSCH and the PSFCH may be configured for each PSFCH resource pool. “K” may differ for each PSFCH resource pool or may use the same value in the entire PSFCH resource pool.

In terms of the system, PSFCH resource pool period N may be set to 1 or an integer greater than 1. According to the described relationship between N and K (i.e., N=K, N<K, or N>K), the resource of the PSFCH that needs to be transmitted by a specific V2X reception UE may not be present in the corresponding slot. For example, when N is assumed to be 4 in FIG. 8A, a PSFCH time axis resource may be present every four slots in terms of the system. In other words, the PSFCH time axis resource may be present in slot 2 and slot 6 of system frame 2 and slot 0, slot 4, and slot 8 of system frame 3 with reference to slot 8 of system frame 1. In this case, when it is assumed that K=4 (i.e., the PSFCH is transmitted four slots after the V2X reception UE receives the PSCCH/PSSCH from the V2X transmission UE) and the V2X reception UE receives the PSCCH/PSSCH in slot 9 of system frame 1 from the V2X transmission UE, the V2X reception UE needs to transmit HARQ-ACK/NACK information through the PSFCH in slot 3 of system frame 2. However, since the corresponding slot has no PSFCH resource, the V2X reception UE may fail to transmit the PSFCH. In such a case, the V2X reception UE may transmit the PSFCH in the PSFCH slot existing earliest with reference to the slot where the V2X reception UE needs to transmit the PSFCH. In other words, in the above-described example, the V2X reception UE may transmit HARQ-ACK/NACK information through the PSFCH in slot 6 of system frame 2.

FIG. 8B is a diagram illustrating another example of time axis resource allocation of an SL feedback channel, according to an embodiment.

FIG. 8A illustrates a case where a PSFCH resource pool is allocated independently from configuration of the resource pool for transmitting a PSCCH and a PSSCH. Unlike FIG. 8A, FIG. 8B illustrates a method in which the PSFCH resource pool is configured in the resource pool where the PSCCH and the PSSCH are transmitted. In other words, the resource of the PSCCH and the PSSCH may start from slot index 3 of system frame “1” with reference to system frame number “0”. The start point may be known as offset 1. Since the PSFCH is present in the resource pool of the PSCCH and the PSSCH, the start point of the PSFCH may be known through offset 2 with reference to a time point at which the PSCCH/PSSCH starts. In other words, the start of the PSFCH resource may be identified in slot index “8” which is 5 slots after slot index 3 of system frame “1”. FIG. 8B illustrates that the PSFCH time axis resource is repeated by period N. The V2X reception UE may transmit, based on such information, HARQ-ACK/NACK information to the V2X transmission UE through the PSFCH in the slot where the PSFCH is present.

The above-described PSFCH time axis resource allocation method may be seen as described in terms of the system. Accordingly, as described in FIG. 8A, in terms of the system, the PSFCH resource may not be present in the slot where a specific V2X reception UE needs to transmit the PSFCH. In such a case, the V2X reception UE may transmit the PSFCH in the PSFCH slot present earliest with reference to the slot where the V2X reception UE needs to transmit the PSFCH, as described in FIG. 8A.

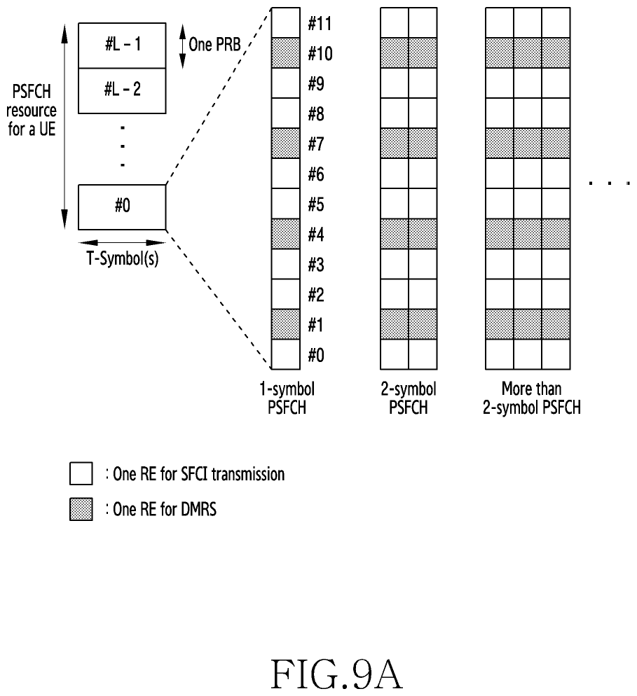

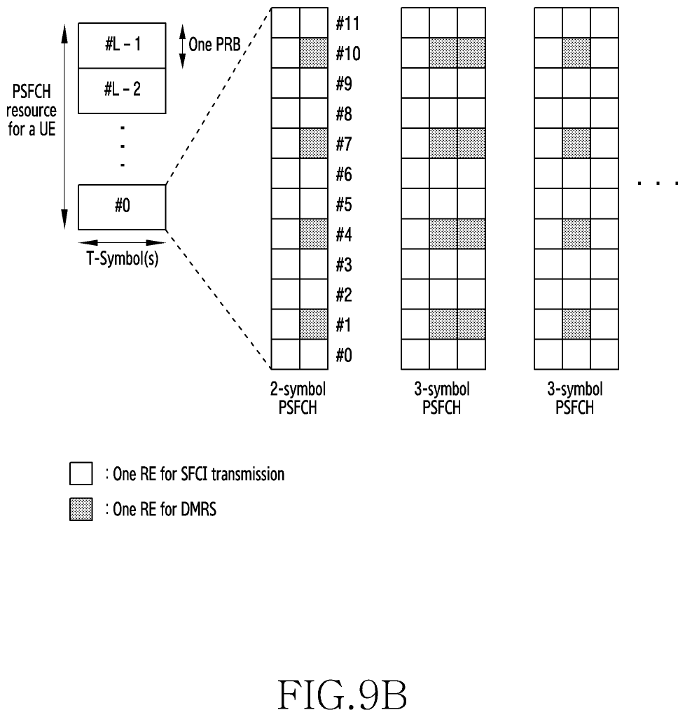

FIG. 9A is a diagram illustrating an example of a resource structure of an SL feedback channel, according to an embodiment. FIG. 9B is a diagram illustrating an example of a resource structure of an SL feedback channel, according to an embodiment.

Referring to FIGS. 9A and 9B, a PSFCH resource structure of FIGS. 9A and 9B may mean a resource structure of the PSFCH transmitted to the V2X transmission UE by the V2X reception UE in the unicast communication procedure illustrated in FIGS. 4 and 5. In addition, the PSFCH resource structure of FIGS. 9A and 9B may mean the resource structure of the PSFCH used in a case (Option 2) where each of the V2X reception UEs in the group transmits HARQ ACK information and NACK information to the V2X transmission UE in groupcast communication as described in FIG. 4. Furthermore, the PSFCH resource structure of FIGS. 9A and 9B may mean the resource structure of the PSFCH used in a case (Option 1) where multiple V2X reception UEs in the group transmit only NACK information to the V2X transmission UE in groupcast communication as described in FIG. 4.

In the above-described unicast and groupcast communication, each V2X reception UE may transmit SL feedback control information (SFCI) to the V2X transmission UE by using the PSFCH resource structure of FIGS. 9A and 9B. In this case, the PSFCH used for SFCI transmission by one V2X reception UE may include T symbols on the time axis and L frequency blocks (resource blocks (RBs)) on the frequency axis, as illustrated in FIG. 9A or 9B. T and L may include 1, and when T=L=1, each V2X reception UE may transmit a PSFCH including one OFDM) symbol and one RB on the time axis to the V2X transmission UE. In this case, one RB may include 12 subcarriers or 12 reference elements (REs). In addition, when L>1 in FIGS. 9A and 9B, one PSFCH resource including L RBs may be regarded as one PSFCH subchannel. In this case, the number of PSFCH subchannels that one V2X reception UE can use for SFCI transmission may be [x]. In this case, a value of [x] may be 1 or a value greater than 1, and may be configured through RRC from the base station or configured through PC-5 RRC (or value [x] may be set in advance). Information on the above-described value [x] may be included in SL resource pool configuration information.

In FIGS. 9A and 9B, the DMRS overhead is assumed to be ⅓ (i.e., among 12 resource elements (REs), four REs are used as the DMRS), but the disclosure is not limited thereto. For example, if the DMRS overhead is ¼, that is, if three of 12 REs are used as the DMRS, the DMRS may be mapped to RE indices 1, 5, and 9 (or 2, 6, and 10), and the SFCI may be mapped to the remaining RE indices. Although FIGS. 9A and 9B illustrate the PSFCH structure for one RB including 12 REs, the same PSFCH structure are applicable to the PSFCH including two or more RBs. In other words, when two RBs are assumed to be the size of the PSFCH frequency resource transmitted by one V2X reception UE, the DMRS may be mapped to RE indices 1, 4, 7, 10, 13, 16, 19, and 22, and the SFCI may be mapped to the remaining RE indices. According to this principle, a PSFCH structure including RBs greater than 2 (L>2) may be extended and determined.

Meanwhile, when the PSFCH transmitted by one V2X reception UE includes two or more OFDM symbols on the time axis, the PSFCH including one OFDM symbol may be repeated. In other words, as illustrated in FIG. 9A, a PSFCH including two or more OFDM symbols has a repetitive structure of a PSFCH including one OFDM symbol, and a DMRS may exist in an RE at the same location in each OFDM symbol. In a PSFCH including two or more OFDM symbols, the location of the RE in which a DMRS exists may vary for each OFDM symbol. This may be intended to reduce the DMRS overhead. For example, a DMRS may exist only in odd-numbered OFDM symbols and may not exist in even-numbered OFDM symbols. Alternatively, a DMRS may exist only in even-numbered OFDM symbols and may not exist in odd-numbered OFDM symbols.

As another example, although FIG. 9A illustrates that the DMRS exists in the same RE on the frequency axis even when the number of OFDM symbols increases, the location of the DMRS may vary for each OFDM symbol. For example, DMRS positions in the first OFDM symbol and the second OFDM symbol may be different. In other words, in comparison with the PSFCH structure including two OFDM symbols of FIG. 9A, the DMRS may be positioned at RE indexes 0 and 7 in the first OFDM symbol, and the DMRS may be positioned at RE indexes 3 and 11 in the second OFDM symbol. Alternatively, DMRS positions in even-numbered OFDM symbols and odd-numbered OFDM symbols may be different, but DMRS positions in even-numbered OFDM symbols may be identical (i.e., the DMRS positions in the second and fourth OFDM symbols may be identical), and the DMRS positions in odd-numbered OFDM symbols may be identical (i.e., the DMRS positions in the first and third OFDM symbols are identical). This may be generalized as meaning that the positions of DMRS REs may be identical in at least two or more OFDM symbols.

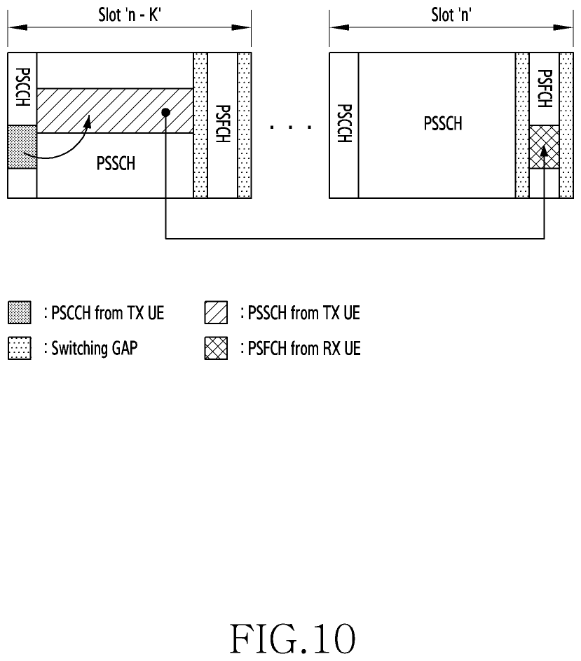

SFCI information may be mapped to all the REs of the PSFCH without the DMRS in FIG. 9A. In this case, there may be a disadvantage that channel estimation cannot be performed because there is no DMRS. However, when SFCI information is transmitted based on a sequence, a reception end may receive SFCI without channel estimation, and thus, it is possible to enhance the reception performance of PSFCH by increasing the sequence length for SFCI transmission and reducing DMRS overhead. A specific example of the sequence-based SFCI transmission method is described in detail with reference to FIG. 10.

FIG. 9B is a diagram illustrating another example of a resource structure of an SL feedback channel, according to an embodiment.

Referring to FIG. 9B, a PSFCH resource structure is a structure assisting a receiver of a transmission UE for receiving the PSFCH in configuring automatic gain control (AGC). More specifically, the receiver of the transmission UE needs to set an AGC range to receive the PSFCH. In this case, the reception UE for transmitting the PSFCH may be located adjacent to or may be located far away from the transmission UE for receiving the PSFCH. For example, it may be assumed that UE-A is located adjacent to the transmission UE for receiving the PSFCH, and UE-B is located far away from the transmission UE for receiving the PSFCH. In this case, the PSFCH transmitted by UE-A may be received by the transmission UE at high reception power, and the PSFCH transmitted by UE-B may be received by the transmission UE at low reception power. When the transmission UE for receiving the PSFCH configures AGC according to the PSFCH of UE-A, the PSFCH transmitted by UE-A may be quantized at wide intervals. In such a case, the PSFCH transmitted by UE-B has a low reception signal level and may thus be properly expressed as the above-described quantized value. Therefore, the PSFCH transmitted by UE-B may not properly be received. Similarly, when the transmission UE for receiving the PSFCH configures AGC according to the PSFCH of UE-B, the PSFCH transmitted by UE-B has a low reception signal, and thus the PSFCH reception signal transmitted by UE-A falls outside the AGC range, whereby the reception signal of the PSFCH transmitted by UE-A may be distorted. Accordingly, the PSFCH transmitted by UE-A may not properly be received. To address this problem, the receiver of the transmission UE needs to configure an AGC range with a sufficient time to secure many samples upon receiving the PSFCH.

To perform such AGC range configuration, as shown in FIG. 9B, a DMRS is not mapped but SFCI information may be mapped to the first symbol. More specifically, as shown in FIG. 9A, when the DMRS is mapped to the first symbol and the first symbol is used for AGC range configuration, channel estimation performance using the DMRS may be deteriorated. Accordingly, when the first symbol is used for AGC range configuration, the DMRS may not be mapped to the first symbol as shown in FIG. 9B. As another example, rather than SFCI information being mapped to the first symbol, a sequence for assisting the transmission UE for receiving the PSFCH in performing AGC configuration may be transmitted. In other words, a preamble for AGC training may be transmitted in the first symbol of the PSFCH. Except that no DMRS is mapped to the first symbol, the position of the DMRS mapped to the remaining symbols may follow one of the methods exemplified in FIG. 9A. For example, the position of the RE where the DMRS is present for each OFDM symbol may be identical or different.

As another example, the AGC preamble may be transmitted in the first symbol of FIG. 9B, and only SFCI, without DMRS, may be transmitted in the second symbol. In such a case, SFCI may be transmitted in the form of a sequence. As an example, when 1-bit HARQ ACK transmission is assumed, sequence-A may be used for ACK information transmission and sequence-B may be used for NACK information transmission. Such sequence-based transmission does not need to use channel estimation for demodulation and decoding, and thus the above-described feedback channel resource structure may be possible. A sequence-based SFCI transmission method is described in detail with reference to FIG. 10.

FIG. 10 is a diagram illustrating an example of frequency resource allocation of an SL feedback channel, according to an embodiment.

As illustrated in FIG. 10, the V2X transmission UE may transmit a PSCCH and a PSSCH in slot n−K. The V2X reception UE may decode the PSCCH to obtain SL control information and obtain information on time/frequency/code resources of the PSSCH therefrom. FIG. 10 illustrates that the PSCCH and the PSSCH are transmitted in the same slot, but the disclosure is not limited thereto. In other words, the PSCCH is transmitted in slot n−K, but the PSSCH may be transmitted in a subsequent slot. In such a case, the time relationship between the PSCCH and the PSSCH may be fixed (e.g., the PSSCH is transmitted 4 ms after PSCCH reception), or may be configured by the base station. As another example, the V2X transmission UE may indicate the time relationship between the PSCCH and the PSSCH in the SL control information that the V2X transmission UE transmits. The V2X reception UE having obtained the SL control information may decode the PSSCH through information on frequency/code resources of the PSSCH and the time relationship between the PSCCH and the PSSCH.

The V2X reception UE may receive the PSCCH and the PSSCH transmitted from the V2X transmission UE, perform decoding, and then feed back information on whether PSSCH decoding is successfully performed (i.e., HARQ-ACK/NACK) to the V2X transmission UE through a PSFCH. Therefore, the V2X reception UE needs to know information on the frequency and time resource of the PSFCH for transmitting HARQ-ACK and HARQ-NACK information. Accordingly, for the V2X transmission UE to receive PSFCH from the V2X reception UE, the V2X transmission UE needs to know information on the frequency and time resource of the PSFCH transmitted from the reception UE.

There may be various methods for allocating frequency resources of the PSFCH depending on the entity of allocating resources or how to design signaling for resource allocation.

As an example of an entity for allocating resources, the V2X reception UE itself may select resources of the PSFCH to transmit. More specifically, the base station may configure a PSFCH resource pool to the V2X reception UEs in the cell through system information and RRC configuration. When there is no base station, the PSFCH resource pool may be configured in advance. The V2X reception UEs may directly select the PSFCH resources which are to be transmitted by the V2X reception UEs, respectively, in the PSFCH resource pool configured or pre-configured from the base station. For example, the V2X reception UE may select PSFCH resources through a sensing operation. However, in this method, the PSFCH can be transmitted only when sensing is successfully performed, which may cause delay in a HARQ operation, and may thus be undesirable. In this case, the sensing operation may mean an operation of decoding SL control information transmitted on the SL control channel or decoding SL control information and measuring the reference signal received power (RSRP) through the DMRS transmitted on the SL data channel.

As another example of an entity for allocating resources, the base station may directly allocate frequency resources of the PSFCH, through DCI, to V2X reception UEs to which the PSFCH is to be transmitted. Alternatively, the base station may configure a set of frequency resources of the PSFCH, which may be used by each V2X reception UE, through RRC and indicate, through DCI, a frequency resource in the set of frequency resources to be used. This method may be applied only when the V2X reception UEs are in the RRC-connected state with the base station. Accordingly, the V2X reception UEs in the RRC-disconnected state need to perform random access for RRC connection configuration with the base station, which may cause an increase in signaling overhead. Furthermore, this method cannot be used when the V2X reception UE is out of coverage.

As another example for an entity for allocating resources, the base station may directly allocate frequency resources of the PSFCH to V2X transmission UEs which is to receive the PSFCH (i.e., V2X transmission UEs for transmitting the PSCCH and the PSSCH) through DCI. Alternatively, the base station may configure a set of frequency resources of the PSFCH, which may be used by each V2X transmission UE, through RRC and indicate a frequency resource in the set of frequency resources to be used, through DCI. This method may be used in mode 1 resource allocation method described in FIG. 2. However, in the case of mode 1 resource allocation method, the base station may transmit frequency resource allocation information of the PSCCH and the PSSCH to the V2X transmission UE through DCI. Accordingly, when the PSFCH frequency resource allocation information is included in the DCI, the amount of resource allocation information transmitted through DCI may increase. Furthermore, this method may be applicable only to mode 1 resource allocation method as described above but not to mode 2 resource allocation method.

To solve such a problem, in FIG. 10, a correlation between the frequency resource of the PSSCH transmitted by the V2X transmission UE (i.e., received by the V2X reception UE) and the frequency resource of PSFCH transmitted by the V2X reception UE (i.e., received by the V2X transmission UE) needs to be introduced, and at least one of the following methods may be used.

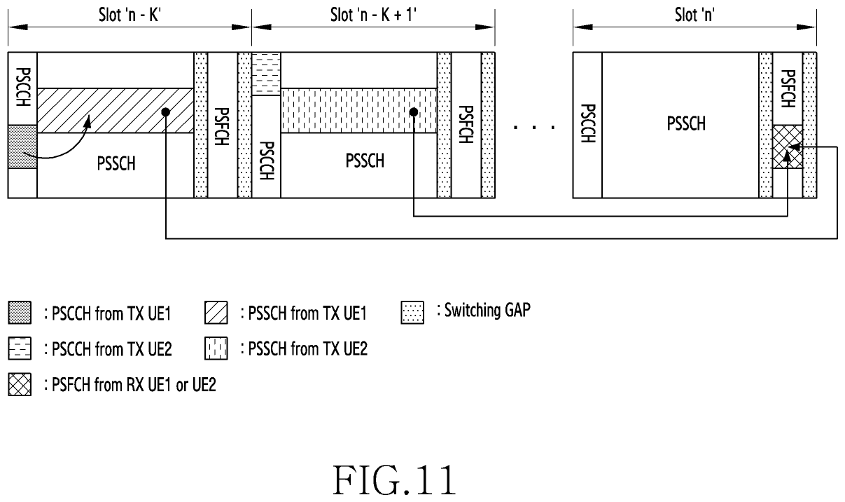

Method 1) The start physical resource block (PRB) index of the PSSCH transmitted in slot n−K by the V2X transmission UE may have a correlation with the start PRB index of the PSFCH transmitted in slot n by the V2X reception UE. These methods are described below in detail in with reference to FIGS. 11, 12, 13, 14, and 15.
For example, when the start PRB index of the PSSCH in slot n−K is M, the start PRB index of the PSFCH in slot n may be the same M. As another example, when the start PRB index of the PSSCH in slot n−K is M, the PSFCH in slot n may start at (M+offset) (or (M−offset)). In this case, the unit of the offset may be a PRB and may be a fixed value identically used by all the V2X UEs or a value configured to vary for each resource pool. For example, in resource pool 1, 10 may be used as the offset value, and in resource pool 2, 20 may be used as the offset value. In this case, K may be a value equal to or greater than 0.
Similar to the example, the last PRB index of the PSSCH transmitted in slot n−K by the V2X transmission UE may have a correlation with the start PRB index of the PSFCH transmitted in slot n by the V2X reception UE.

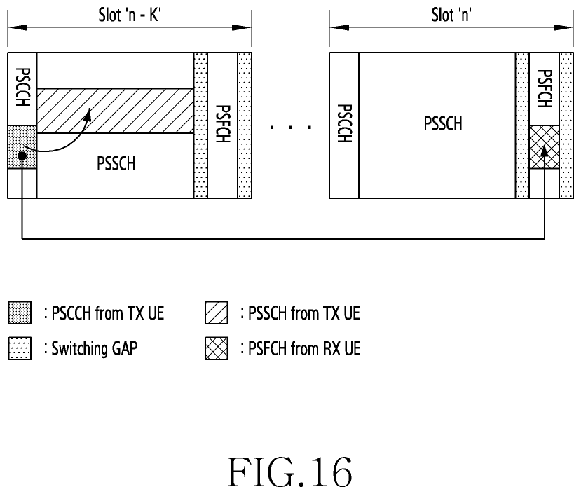

Method 2) The start PRB index of the PSCCH transmitted in slot n−K by the V2X transmission UE may have a correlation with the start PRB index of the PSFCH transmitted in slot n by the V2X reception UE. Method 2 is described in detail with reference to FIGS. 16, 17, 18, and 19.
Method 2 is similar to method 1 but may mean, unlike method 2, that the start PRB index of the PSFCH does not have a correlation with the PSSCH but has a correlation with the PSCCH. For example, when the start PRB index of the PSSCH in slot n−K is M, the start PRB index of the PSFCH in slot n may be the same M. As another example, when the start PRB index of the PSSCH in slot n−K is M, the PSFCH in slot n may start at (M+offset) (or (M−offset)). In this case, the unit of the offset may be a PRB and may be a fixed value identically used by all the V2X UEs or a value configured to vary for each resource pool. For example, in resource pool 1, 10 may be used as the offset value, and in resource pool 2, 20 may be used as the offset value. In this case, K may be a value equal to or greater than 0.

Method 3) Unlike methods 1 and 2, the start PRB of the PSFCH has no correlation with the PSSCH or the PSCCH.
For example, the V2X transmission UE may transmit the start PRB index of the PSFCH to the V2X reception UE through SL control information. This information may be a value configured for or indicated to the V2X transmission UE by the base station. In other words, the start PRB index of the PSFCH may be transferred to the V2X transmission UE through system information or RRC configuration or indicated via DCI. The V2X transmission UE having received the same may transmit the corresponding information to the V2X reception UE through SL control information. In this case, for the number of PRBs constituting a PSFCH, a fixed value may be always used. Alternatively, the number of PRBs, along with the start PRB index of the PSFCH, may also be transferred from the base station through DCI and may be included in the SL control information and transmitted to the V2X reception UE.
As another example, the start PRB index (or the last PRB index) of the PSFCH may be inferred by the V2X reception UE through a destination ID or a source ID transmitted through the PSCCH or the PSSCH. The V2X transmission UE may transfer information on the number of PRBs constituting a PSFCH to the V2X reception UE through SCI. Alternatively, for the number of PRBs constituting the PSFCH, a fixed value may be always used.
As another example, the base station may transfer a set of start PRB indices of the PSFCH to the V2X transmission UE through system information or RRC configuration, and the V2X transmission UE having received the same may select one from among the values included in the set and transmit the same to the V2X reception UE through SL control information.

As described in the examples above, the PSFCH frequency resource may need information on the number of resource blocks constituting the PSFCH as well as information on the start PRB of frequency. The information on the number of resource blocks constituting PSFCH may use at least one of the following methods, as well as the above-described methods.

PSFCH format 1 may transmit HARQ-ACK or HARQ-NACK information including one bit or two bits. When 1-bit HARQ-ACK/NACK information is transmitted, sequence 1 may mean HARQ-ACK information, and sequence 2 may mean HARQ-NACK information. When 2-bit HARQ-ACK/NACK information is transmitted, four sequences may be used, sequence 1 may mean (ACK, ACK), sequence 2 may mean (ACK, NACK), sequence 3 may mean (NACK, NACK), and sequence 4 may mean (NACK, ACK). Accordingly, PSFCH format 1 may be referred to as using sequence-based transmission. Unlike this, there may be a case of transmitting two or more bits of HARQ-ACK/NACK information. In this case, channel coding may be used, and such a format may be referred to as PSFCH format 2. For convenience of description, two PSFCH formats have been exemplified, but there may be more PSFCH formats depending on the type of SL feedback information transmitted through the PSFCH and the bit size of SL feedback information transmitted through the PSFCH.

The same number of PRBs may be used regardless of the exemplified PSFCH format. In this case, the PRB value is a fixed value previously known to all the V2X UEs. As another example, a different fixed value may be used depending on the exemplified PSFCH format. In other words, PSFCH format 1 may use one PRB, and PSFCH format 2 may use four PRBs.

As another example, for the number of PRBs used for the PSFCH, a different value may be used by a base station configuration or a pre-configuration. For example, the base station may include the presence or absence of the PSFCH in the resource pool configuration information, and when the PSFCH is present in the corresponding resource pool, information on the number of PRBs constituting the PSFCH may be included.

The HARQ-ACK/NACK information transmitted by one V2X reception UE in groupcast or unicast communication may be transmitted through one PSFCH resource or through two PSFCH resources. When the information is transmitted through one PSFCH, the above-described methods may be applied. However, when the information is transmitted through two PSFCH resources (i.e., one PSFCH resource is used for HARQ-ACK transmission, and the other PSFCH resource is used for HARQ-NACK transmission), a method for informing of start points of the two PSFCH resources may be required.

When the two PSFCH resources are contiguously present, the start PRB index of the first PSFCH resource may be derived from the start PRB index of the PSSCH as described above. In other words, the start PRB index of the first PSFCH resource may be M or (M+offset) (or (M−offset)) in an example. Furthermore, the start PRB index of the second PSFCH resource may be determined depending on the number of PRBs constituting the first PSFCH resource. For example, if it is assumed that the number of PRBs constituting the first PSFCH resource is [X1], the start PRB index of the second PSFCH resource may be (M+[X1]) or (M+offset+[X1]) (or (M−offset−[X1])). In this case, for [X1], a fixed value may be used or [X1] may be configured by the base station or the V2X transmission UE.

When the two PSFCH resources are not contiguous, the start PRB index of the first PSFCH resource may be derived from the start PRB index of PSSCH, and the start PRB index of the second PSFCH resource may be configured through a separate offset as described above. For example, the start PRB index of the first PSFCH resource may be M or (M+offset 1) (or (M−offset 1)) in an example. The start PRB index of the second PSFCH resource may be (M+offset 2) or (M+offset 1+offset 2) (or (M−offset 1−offset 2)). In this case, offset 1 may mean a difference between the start PRB index of the PSSCH and the start PRB index of the PSFCH, and offset 2 may mean a difference between the start PRB index of the first PSFCH resource and the start PRB index of the second PSFCH resource.

As another example, the start PRB index of the second PSFCH resource may be (M+[X1]+offset 2) or (M+offset 1+[X1]+offset 2) (or (M−offset1−[X1]−offset 2)). In this case, [X1] means the number of PRBs constituting the first PSFCH resource, and for [X1], a fixed value may be used or [X1] may be configured by the base station or the V2X transmission UE. In addition, in the example, offset 1 may mean a difference between the start PRB index of the PSSCH and the start PRB index of the PSFCH. Furthermore, offset 2 may mean a difference between the start PRB index of the first PSFCH resource and the start PRB index of the second PSFCH resource.

FIG. 11 is a diagram illustrating another example of frequency resource allocation of an SL feedback channel, according to an embodiment.

FIG. 11 illustrates a case in which the start PRB indices of the PSSCH transmitted by different V2X transmission UEs are the same. In other words, it is a case where the start PRB index of the PSSCH transmitted to V2X reception UE 1 by V2X transmission UE 1 in slot n−K is identical to the start PRB index of the PSSCH transmitted to V2X reception UE 2 by V2X transmission UE 2 in slot n−K+1. Since the PSSCHs transmitted in different slots use the same start PRB index, if the methods described with reference to FIG. 10 are applied, the start PRB indices of the PSFCH are identical, and thus collision may occur between the PSFCHs. Such a problem may be caused not only when different V2X transmission UEs transmit a PSSCH to different V2X reception UEs but also when different V2X transmission UEs transmit a PSSCH to the same V2X reception UE as in the example shown in FIG. 11 (i.e., when the PSCCH/PSSCH transmitted by V2X transmission UE 1 and the PSCCH/PSSCH transmitted by V2X transmission UE 2 are transmitted to V2X transmission UE 1). One of the following methods may be used to solve such a PSFCH collision problem.

### Method 1) the Start PRB Index of the PSSCH and a V2X UE ID Indicate the Start PRB Index of the PSFCH.

The V2X UE ID may mean a destination ID or a source ID or may mean both the destination ID and the source ID. [X1] bits of the destination ID including [X] bits may be transmitted through the PSCCH, and the remaining [X2] bits may be included in the MAC PDU transmitted through the PSSCH ([X]=[X1]+[X2]). The [Y1] bits of the source ID including [Y] bits may be transmitted through the PSCCH, and the remaining [Y2] bits may be included in the MAC PDU transmitted through the PSSCH ([Y]=[Y1]+[Y2]). In the example, [X2] and [Y2] may be 0 bits. This may mean that the destination ID and source ID are transmitted only through the PSCCH. Furthermore, in the example, [X1] and [Y1] may be 0 bits. This may mean that the destination ID and the source ID are transmitted only through the PSSCH.

The V2X reception UE may decode the PSCCHs transmitted from different V2X transmission UEs in different slots and obtain a part (when the bits of the destination ID and the source ID are split and transmitted in the MAC PDUs of the PSCCH and the PSSCH) or all (when the bits of the destination ID or source ID are transmitted only through the PSCCH) of V2X UE ID information. Furthermore, the V2X reception UE having successfully performed decoding of the PSCCH may obtain information on the frequency resources of the PSSCH and obtain a part (when the bits of the destination ID or the source ID are split and transmitted in the MAC PDUs of the PSCCH and the PSSCH) or all (when the bits of the destination ID or the source ID are transmitted only through the PSSCH) of the V2X UE ID information.

The destination ID is an ID for identifying the reception UE of the PSSCH transmitted by the V2X transmission UE. The source ID is an ID for identifying the transmission UE of the PSSCH transmitted by the V2X transmission UE. The method may be subdivided into the following methods depending on whether the source ID is used or the destination ID is used to identify the start PRB index of the PSFCH.

### Method 1-1) Case of Using Source ID

Since different V2X transmission UEs may transmit different PSSCHs to the same V2X reception UE, if an offset is given to the start PRB indices of PSSCHs transmitted in different slots through the destination ID, the PSFCH collision problem still remains because the same destination ID is used. Accordingly, an offset may be given to the start PRB index of the PSFCH by using the source ID.

More specifically, as shown in FIG. 11, PSCCH-1 or PSSCH-1 transmitted by V2X transmission UE 1 in slot n−K has source ID 1. PSCCH-2 or PSSCH-2 transmitted by transmission UE 2 in slot n−K+1 has source ID 2. Even when PSCCH-1 and PSSCH-2 have the same start PRB index, the start PRB index of the PSFCH transmitted in slot n may vary since different source IDs are used. In other words, the different source IDs may give different offsets to the start PRB indices of the PSFCHs.

In this case, the relationship between the source ID and the offset of the start PRB index of the PSFCH may be preconfigured or may be configured by the base station or the UE's higher layer. As another example, the source ID may be converted into a decimal number and may be interpreted as an offset. More specifically, it may be assumed that the source ID includes 4 bits and source ID 1=0011 and source ID 2=1011. In this case, when source ID 1 is converted into a decimal number, it may be expressed as source ID 1=3 and source ID 2=11. Therefore, the PSFCH corresponding to PSSCH-1 transmitted by V2X transmission UE 1 may have offset 3, and the PSFCH corresponding to PSSCH-2 transmitted by V2X transmission UE 2 may have offset 11. For convenience of description, it is exemplified that the source ID includes 4 bits, but the number of bits of the source ID may be greater (e.g., 24 bits). In this case, since the offset value becomes very large, it may deviate from the index range of frequency resources in the corresponding resource pool. In this case, a modulo operation may be performed. Furthermore, in the example, all the bits constituting the source ID are converted into a decimal number to express the offset value, but some bits of the source ID (e.g., most significant bit (MSB) [K1] bits or least significant bit (LSB) [K1] bits) may be converted to a decimal number and interpreted as an offset.

### Method 1-2) Case of Using Destination ID

One V2X transmission UE may transmit the PSSCH to different V2X reception UEs in different slots. In this case, since the source IDs are the same but the destination IDs may be different, the PSFCH collision problem may still occur when the start PRB index of the PSFCH is determined using the source ID. Therefore, an offset may be given to the start PRB index of the PSFCH according to the destination ID. The methods exemplified in the case of using the source ID may be used.

Method 2) the Start PRB Index of PSSCH and the Index of the Slot where the PSSCH is Transmitted Indicate the Start PRB Index of the PSFCH.

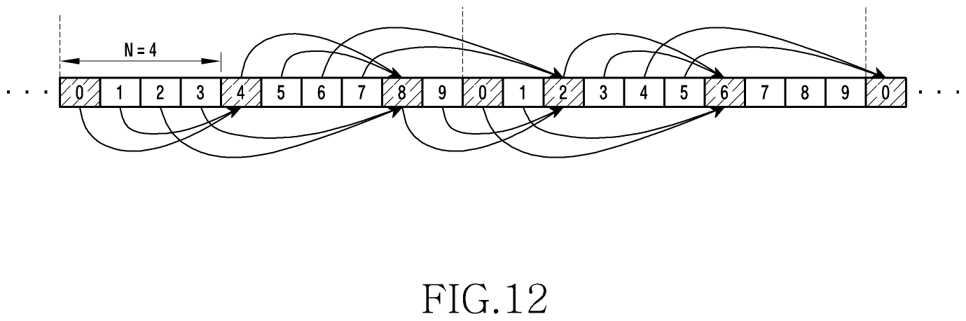

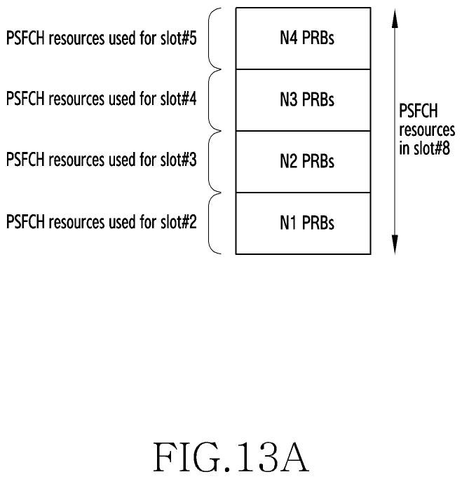

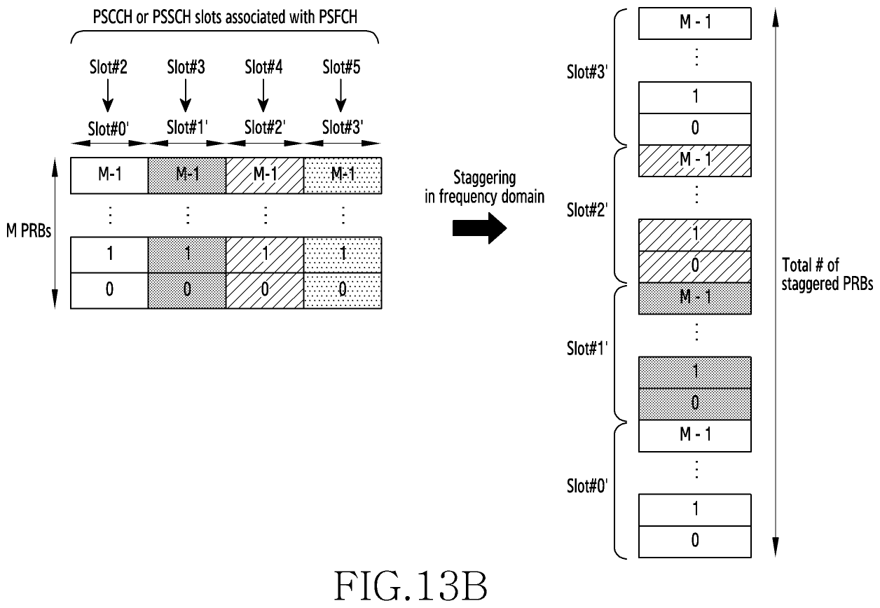

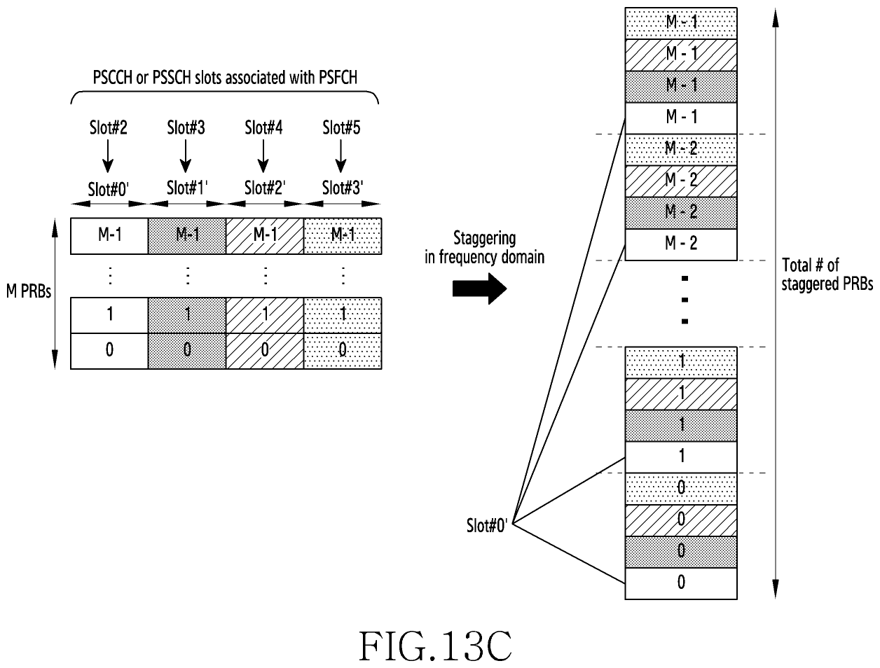

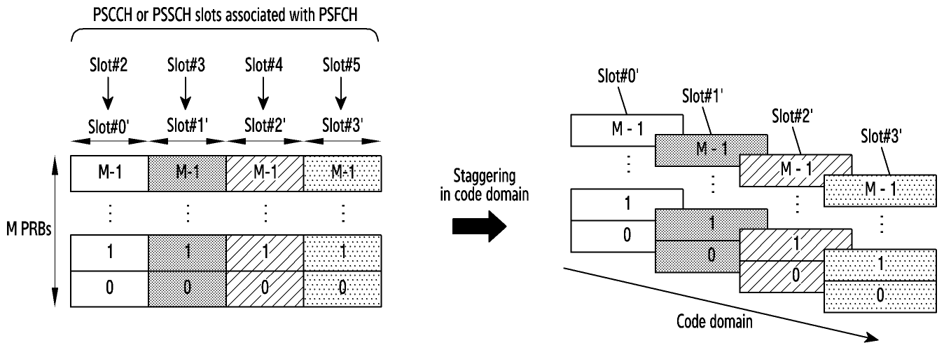

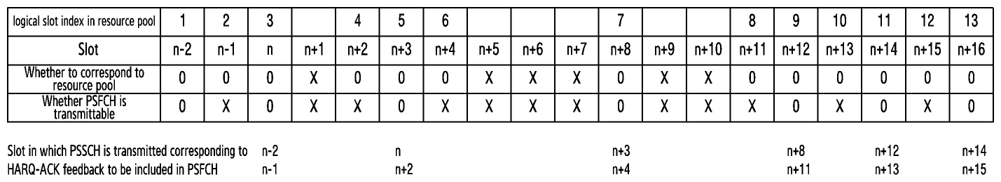

As shown in FIG. 13A, the frequency resources of the PSFCH may be grouped into frequency resources which can be used in each slot. In other words, a case where HARQ-ACK/NACK information may be transmitted in slot 8 in FIG. 12 is a case where the V2X reception UE receives the PSSCH in slot 2, slot 3, slot 4, and slot 5. Accordingly, the number of groups into which the frequency resources need to be divided in the slot where PSFCH may be transmitted may be determined depending on K and N or one of the two values (in FIG. 12, it is assumed that K=3 and N=4, and in FIG. 13A, the PSFCH frequency resources are divided into four groups). As shown in FIG. 13A, the PSFCH frequency resources (i.e., the number of PRBs constituting the PSFCH) that each group may use may be the same or different. The start PRB index of the PSFCH may be determined through such grouping and the correlation with the start PRB index of the PSSCH exemplified in FIG. 8. Accordingly, even when different PSSCHs are transmitted using the same start PRB index in different slots, the PSFCH collision problem may be solved because the start PRB index of the PSFCH may be configured to vary.

FIG. 12 is a diagram illustrating another example of time axis resource allocation of an SL feedback channel, according to an embodiment.

In the example of FIG. 12, the time axis resource of the PSFCH starts from slot 0 and has a period of 4 slots (N=4). Accordingly, time axis resources of the PSFCH may exist in slot 0, slot 4, slot 8, slot 2, and slot 6. Furthermore, in FIG. 12, it is assumed that the time relationship K between the PSSCH transmitted by the V2X transmission UE (i.e., the PSSCH received by the V2X reception UE) and the PSFCH to be transmitted by the V2X reception UE is 3 slots. In other words, the V2X reception UE may not decode the PSSCH transmitted from the V2X transmission UE within a shorter time than three slots and prepare for HARQ-ACK information and HARQ-NACK information to transmit the PSFCH. Accordingly, the HARQ-ACK/NACK information corresponding to the PSSCH received by the V2X reception UE in slot 0 and slot 1 may be transmitted in slot 4 as shown in FIG. 12. The HARQ-ACK/NACK information corresponding to the PSSCH received by the V2X reception UE in slot 2, slot 3, slot 4 and slot 5 may be transmitted in slot 8. Furthermore, the HARQ-ACK/NACK information corresponding to the PSSCH received by the V2X reception UE in slot 6, slot 7, slot 8 and slot 9 may be transmitted in slot 2.

FIG. 13A is a diagram illustrating another example of frequency resource allocation of an SL feedback channel, according to an embodiment.

FIG. 13A illustrates grouping frequency resources of a PSFCH to solve the PSFCH collision problem described in FIG. 11. As shown in FIG. 13A, the frequency resources of the PSFCH may be grouped into frequency resources usable in each slot. In other words, a case where HARQ-ACK/NACK information may be transmitted in slot 8 in FIG. 12 is a case where the V2X reception UE receives a PSSCH in slot 2, slot 3, slot 4, and slot 5. Accordingly, the number of groups into which the frequency resources need to be divided in the slot where the PSFCH can be transmitted may be determined depending on one of or both value K and value N (in FIG. 12, it is assumed that K=3, and N=4, and in FIG. 13A, the PSFCH frequency resources are divided into four groups). As shown in FIG. 13A, the PSFCH frequency resources (i.e., the number of PRBs constituting the PSFCH) that each group can use may be the same or different. The start PRB index of the PSFCH may be determined through such grouping and a correlation with the start PRB index of the PSSCH exemplified in FIG. 8. Accordingly, even when different PSSCHs are transmitted using the same start PRB index in different slots, the PSFCH collision problem may be solved because the start PRB index of the PSFCH may be configured to vary.

FIG. 13B is a diagram illustrating a specific example of frequency resource allocation of an SL feedback channel, according to an embodiment.

FIG. 13B is a specific embodiment of FIG. 13A and illustrates an example of a case where the PSFCH resources associated with the PSCCH or the PSSCH received by the reception UE in slots 2, 3, 4, and 5 are present in slot index 8 as shown in FIG. 12. A total number of PSCCH or PSSCH reception slots associated with PSFCH transmission resources is defined as L (L=4 in FIGS. 12 to 13A). Furthermore, the number of PRBs constituting each PSCCH or PSSCH reception slot associated with PSFCH transmission resources may be defined as M. In this case, M may be defined as a total number of PRBs constituting one SL resource pool, and the total number of PRBs in the frequency axis within the SL resource pool are the same in all slots constituting the SL resource pool. In the above-described examples, a set of PSCCH or PSSCH reception slots associated with PSFCH transmission resources (i.e., slots 2, 3, 4, and 5 shown in FIGS. 12, 13A, and 13B) may be physically contiguous or logically contiguous (if logically contiguous, physically non-contiguous). Furthermore, M PRBs constituting each reception slot of the PSCCH or the PSSCH may also be physically contiguous or logically contiguous.

In FIG. 13B, PSCCH or PSSCH reception slot indices 2, 3, 4, and 5 associated with PSFCH transmission resources may be interpreted as slot indices 0′, 1′, 2′, and 3′, respectively. More generally, assuming that there are L physically contiguous or non-contiguous PSCCH or PSSCH reception slots associated with PSFCH transmission resources, the respective PSCCH or PSSCH reception slots may be interpreted as slot indices 0′, 1′, . . . , and (L−1)′ in a chronological order. Since FIG. 13B illustrates the case of L=4, the respective PSCCH or PSSCH reception slot may be interpreted as slot indices 0′, 1′, 2′, and 3′ in a chronological order.

As illustrated in FIGS. 10 and 11, when the transmission frequency resource of the PSFCH is associated with the reception frequency resource of the PSCCH or the PSSCH, the position of the reception frequency resource of the PSCCH or PSSCH received by each reception UE may be mapped to the position of the frequency resource for transmitting the PSFCH. Therefore, as many PSFCH transmission resources as the total number of resources of PSCCH or PSSCH that may be received may be required. For example, when it is assumed that a minimum transmission resource unit that one transmission UE may transmit is 1 PRB, up to M PSCCHs or PSSCHs may be received in slot index 0′ of FIG. 13B. Therefore, a total number of frequency resources of the PSCCH or the PSSCH associated with frequency resources of the PSFCH may be (4×M) PRBs. Generally, a total number of frequency resources of the PSCCH or the PSSCH associated with PSFCH transmission may be (L×M) PRBs. In this case, L may mean a total number of PSCCH or PSSCH reception slots associated with PSFCH transmission resources, as described above.

(L×M) PRB indices, which indicate the start positions of frequency resources where the above-described PSCCH or PSSCH can be received, may be mapped to the start points of frequency resources for PSFCH transmission as shown in FIG. 13B. In other words, PRB indices 0, 1, . . . , and (M−1) of slot index 0′, PRB indices 0, 1, . . . , and (M−1) of slot index 1′, PRB indices 0, 1, . . . , and (M−1) of slot index 2′, and PRB indices 0, 1, . . . , and (M−1) of slot index 3′ may be mapped in order. Based on the mapping rule, the reception UE having received the PSCCH or the PSSCH using PRB index 0 of slot index 2′ as the start point and the reception UE having received the PSCCH or the PSSCH using PRB index 0 of slot index 3′ as the start point may regard the PSFCH frequency resources mapped to the PRB index and the corresponding slot index as the start points of the frequency resource for PSFCH transmission.

Generally, when the indices of PSCCH or PSSCH reception slots associated with frequency resources for PSFCH transmission (i.e., slot 2 (or slot 0′), 3 (or slot 1′), 4 (or slot 2′), and 5 (or slot 3′) in FIG. 13B) may be defined as “1”, and the index of the PRB in each slot is defined as “m”, the start index of the PSFCH frequency resource in the slot in which the PSFCH is transmitted may be determined by “(1+m+offset)”. In this case, an offset value is a parameter for reducing inter-cell interference, and is assumed to be offset=0 in FIG. 13B, but may have different values for each cell. The offset value may be configured the base station for the UE through system information or RRC configuration, or may be derived through a cell ID (or a virtual cell ID configured by the base station) detected by the UE from a synchronization signal of the base station. For example, the UE having obtained “0” from 0, 1, or 2 obtained through cell ID mod 3 operation may apply offset=0, the UE having obtained “1” may apply offset=z, and the UE having obtained “2” may apply offset=2z. In this case, it may be assumed that z is a fixed value and is known to both the base station and the UE.

The reception UE needs to know the number of PRBs necessary for PSFCH transmission in addition to the start point (i.e., the start PRB index) of the frequency resource for PSFCH transmission. In this case, it may be assumed that the reception UE knows the number of PRBs required for PSFCH transmission before PSFCH transmission. For example, a fixed value is used for the number of PRBs required for PSFCH transmission (i.e., 2 PRBs), or the number of PRBs required for PSFCH transmission may be configured through system information or RRC, or PC-5 RRC of the base station.

As in the above-described example, when the minimum resource unit that one UE may use for PSCCH or PSSCH transmission is assumed to be 1 PRB, (L×M) start indices of the PSFCH frequency resource may be required. In this case, if the number of PRBs required for PSFCH transmission is assumed to be 1, (L×M) PSFCH frequency resources may be required. However, when the number of PRBs required for PSFCH transmission is assumed to be “R” which is greater than 1, (L×M×R) PRBs may be required for PSFCH frequency resources. This may cause a shortage of PSFCH frequency resources in the slot in which the PSFCH is transmitted. For example, when an SL BWP is set to 20 MHz and one SL resource pool is configured in the SL BWP, 100 PRBs may exist in the SL resource pool. When a minimum transmission resource of the PSCCH or the PSSCH is assumed to be 1 PRB and the number of PRBs required for PSFCH transmission is assumed to be 1, 400 (=4×100) PSFCH frequency resources may be required in FIG. 13B. Since one resource pool includes 100 PRBs, 300 UEs in the above-described example may fail to perform PSFCH transmission. In the above-described example, when the number of PRBs required for PSFCH transmission is increased to 2, 800 (=4×100×2) PSFCH frequency resources may be required so that the PSFCH frequency resource shortage issue may become more serious.

FIG. 13C is a diagram illustrating another example of frequency resource allocation of an SL feedback channel, according to an embodiment.

FIG. 13C illustrates another example of mapping between a start index of a frequency resource for PSFCH transmission and a start index of a frequency resource where a PSCCH or a PSSCH can be received.

In FIG. 13B, frequency resource indices of the first slot in which the PSCCH or the PSSCH is received are sequentially mapped to the start index of the PSFCH frequency resource, and then the frequency resource indices of the next slot are sequentially mapped to the start index of the PSFCH frequency resource. Unlike this, FIG. 13C illustrates that the indices of the first frequency resources of the slots where the PSCCH or the PSSCH is received are mapped to the start index of the PSFCH frequency resource, and then the next frequency resources are sequentially mapped. The mapping structure of FIG. 13C is different from that of FIG. 13B but may experience the PSFCH frequency resource shortage problem like in FIG. 13B.

The PSFCH frequency resource shortage problem described in FIGS. 13B and 13C may worsen as the minimum resource unit of the PSCCH or the PSSCH transmitted by the transmission UE increases (e.g., one PRB) and/or the minimum resource unit of the PSFCH transmitted by the reception UE increases (e.g., 2 PRBs or more). This problem may be solved by increasing the minimum resource unit of the PSCCH or the PSSCH and reducing the minimum resource unit of the PSFCH transmitted by the reception UE. For example, two or more physically contiguous or logically contiguous PRBs may be grouped into a PRB group (PRBG). In this case, the PRBG may be referred to as a subchannel and one subchannel may be defined as a minimum resource unit for PSCCH, PSSCH or PSFCH transmission. Furthermore, the PSCCH subchannel meaning the minimum resource unit of the PSCCH, the PSSCH subchannel meaning the minimum resource unit of the PSSCH, and the PSFCH subchannel meaning the minimum resource unit of the PSFCH may include the same or different numbers of PRBs. For example, the PSCCH subchannel may include two PRBs, the PSSCH subchannel may include four PRBs, and the PSFCH subchannel may include one PRB. However, this is merely provided as an example, and the number of PRBs constituting the PSCCH, PSSCH, and PSFCH subchannels may be defined as α, β, and γ, respectively. In this case, for values α, β, and γ, fixed values may be used or configured by the base station for the PSCCH, the PSSCH and the PSFCH, respectively. Alternatively, the values may be configured through PC-5 RRC or configured in advance. As described above, to solve the PSFCH resource shortage problem, α>β (when the PSFCH resource is associated with the PSCCH resource) or β>γ (when the PSFCH resource is associated with the PSSCH resource) needs to be met.

For example, the PSCCH subchannel or the PSSCH subchannel may include a-PRBs (for convenience of description, it is assumed that the numbers of PRBs constituting the PSCCH subchannel and the PSSCH subchannel are the same), and the PSFCH subchannel includes γ PRBs. Furthermore, as shown in FIGS. 13B and 13C, assuming that each of the slots constituting the SL resource pool includes a total of M PRBs, the slots in which the PSCCH or the PSSCH can be received (e.g., slot 2 (or slot 0′), 3 (or slot 1′), 4 (or slot 2′), and 5 (or slot 3′) in FIGS. 13B and 13C) may be regarded as including M/α PSCCH or PSSCH subchannels. In this case, when M/α is not an integer, it may be rounded down or up (i.e., └M/α┘ or ┌M/α┐). Therefore, since there may be a total of (L×M/α) frequency resources capable of receiving PSCCH or PSSCH subchannels, (L×M/α×γ) PSFCH frequency resources are required in the slot where the PSFCH resource is present. To solve the PSFCH frequency resource shortage problem described above, the L×M/α×γ<M condition needs to be met. More specifically, when it is assumed that L=4, M=100, α=4, and γ=1, the left side is 100, the right side is 100 in the above-described equation, and thus the condition is met. Therefore, the PSFCH resource shortage problem may not be caused. However, when it is assumed that L=4, M=100, α=4, and γ=2, the left term is 200, the right term is 100 in the above-described equation, and thus the condition fails to be met. Therefore, the PSFCH resource shortage problem may still occur.

FIG. 13D is a diagram illustrating another example of frequency resource allocation of an SL feedback channel, according to an embodiment.

FIG. 13D illustrates another example of mapping between a start index of a frequency resource for PSFCH transmission and a start index of a frequency resource where a PSCCH or a PSSCH can be received.

Unlike FIGS. 13B to 13C, FIG. 13D illustrates a case where the start index of the frequency resource where the PSCCH or the PSSCH can be received in one slot is mapped to the start index of the PSFCH frequency resource, and the slot index where the PSCCH or the PSSCH can be received is mapped to the index of the PSFCH code resource. In other words, according to the scheme shown in FIG. 13D, resource indices mapped to a total of (L×M) PRBs may be expressed using M PRBs on the frequency axis and L codes on the code axis. More specifically, when the index of the PSCCH or PSSCH reception slot associated with the frequency resource for PSFCH transmission is defined as “1” and the index of the PRB in each slot is defined as “m”, the start index of the PSFCH frequency resource in the slot in which the PSFCH is transmitted may be determined by “m+offset”. Furthermore, the start index of the PSFCH frequency resource may be determined by “m+offset” regardless of the index of each PSCCH or PSSCH reception slot, and the index of each PSCCH or PSSCH reception slot may be mapped to the code resource. In this case, the offset value is a parameter for reducing inter-cell interference, and is assumed to be offset=0 in FIG. 13B, but may have different values for each cell. The offset value may be configured by the base station for the UE through system information or RRC configuration, or may be derived through a cell ID (or a virtual cell ID configured by the base station) detected from the synchronization signal of the base station by the UE. For example, the UE having obtained “0” from 0, 1, or 2 obtained through cell ID mod 3 operation may apply offset=0, the UE having obtained “1” may apply offset=z, and the UE having obtained “2” may apply offset=2z. In this case, it may be assumed that z is a fixed value and is known to both the base station and the UE.

The reception UE needs to know the number of PRBs necessary for PSFCH transmission, in addition to the start point (i.e., the start PRB index) of the frequency resource for PSFCH transmission. It may be assumed that the reception UE knows the number of PRBs required for PSFCH transmission before PSFCH transmission. For example, for the number of PRBs required for PSFCH transmission, a fixed value (i.e., two PRBs) may be used, or the number of PRBs required for PSFCH transmission may be configured through the system information of the base station, RRC, or PC-5 RRC.

The above-described example may be applied to the above-described PSCCH, PSSCH, and PSFCH subchannel concepts. For example, a total of (L×M/a) PSFCH resource indices may be expressed using M/α subchannels on the frequency axis of each slot where the PSCCH or the PSSCH can be received and L codes on the code axis. As described above, when the number of PRBs constituting the PSFCH subchannel is assumed as γ, there may be (M/α×γ) PSFCH frequency resources on the frequency axis in the slot where PSFCH resources are present. Since the slots constituting the SL resource pool may have a total of M PRBs in the frequency axis, if the M/α×γ≤M condition is met, the PSFCH resource shortage problem does not occur. In other words, if α≥γ, the PSFCH resource shortage problem does not occur. Since the bit size of SFCI transmitted through the PSFCH is very small, compared to the size of bits transmitted through the PSCCH or the PSSCH (e.g., the bit size of SFCI transmitted through the PSFCH is 1 or 2 and the size of bits transmitted through the PSCCH or the PSSCH is tens to thousands of bits), a may always be equal to or greater than γ. Therefore, since the above-described condition may always be met, the PSFCH resource shortage problem may not occur.

The examples described in FIGS. 13A, 13B, 13C, and 13D may apply when the frequency resource of a PSCCH or PSSCH transmitted by one transmission UE is associated with the transmission frequency resource of the PSFCH transmitted by one reception UE. Unlike the case described above, in groupcast communication, the frequency resource of the PSCCH or the PSSCH transmitted by one transmission UE may be associated with the transmission frequency resources of the PSFCHs transmitted by two or more reception UEs. For example, groupcast communication including three UEs may be assumed (UE-A, UE-B, and UE-C). In this case, it may be assumed that UE-A is a transmission UE that transmits a PSCCH or a PSSCH, and UE-B and UE-C are reception UEs that receive the same. The PSCCH or the PSSCH transmitted by UE-A may be received by UE-B and UE-C, and UE-B and UE-C that have received the same need to transmit the PSFCH to UE-A. In this case, UE-B and UE-C may transmit HARQ feedback information by using one of the following two methods.
Option 1: NACK information may be transmitted only when decoding of the received PSSCH fails. In other words, UE-B and UE-C may not transmit ACK information when decoding of the PSSCH received from UE-A is successfully performed, and may transmit NACK information only when decoding of the PSSCH fails. In this case, UEs for transmitting NACK information may transmit NACK information only when a specific condition is met. More specifically, upon failing to decode the PSSCH, UE-B and UE-C do not always transmit NACK information but may determine an additional condition. This condition may be a distance from UE-A or RSRP. For example, UE-B fails to decode the PSSCH and thus need to transmit NACK information to UE-A, but unless the above-described distance condition or RSRP condition is met, UE-B may not transmit NACK information to UE-A. When the distance condition is used, UE-A corresponding to a transmission UE may transmit its location information to the reception UEs (i.e., UE-B and UE-C), and UE-B and UE-C having received the same may measure the distance from UE-B or UE-C and UE-A by using the location information received from UE-A and the location information measured by UE-B and UE-C. Each reception UE may perform a comparison operation with the distance measured by the reception UE, by using a threshold for the distance received from the higher layer. When the distance measured by the reception UE is greater than the distance threshold, each reception UE does not transmit NACK information to UE-A. Only when the distance measured by the reception UE is smaller than the distance threshold, each reception UE may transmit NACK information to UE-A. When the RSRP condition is used, the reception UEs (i.e., UE-B and UE-C) in the group may measure the RSRP by using the reference signal (e.g., the DMRS or the SL CSI-RS) transmitted by the transmission UE. Each reception UE may perform a comparison operation with the RSRP measured by the reception UE, by using a threshold for the RSRP received from the higher layer. When the RSRP measured by the reception UE is greater than the RSRP threshold, NACK information is not transmitted to UE-A. Only when the RSRP measured by the reception UE is smaller than the RSRP threshold, each reception UE may transmit NACK information to UE-A.

In Option 1, all the reception UEs in the group may transmit the PSFCH using the same time/frequency resource. Therefore, when the PSFCH frequency resource is associated with the frequency resource of the PSCCH or the PSSCH, reception UEs for transmitting the PSFCH may transmit the PSFCH by using one of the methods exemplified in FIGS. 13A, 13B, 13C, and 13D.
Option 2: Unlike option 1 described above, each of the reception UEs (UE-B and UE-C) in the same group performing groupcast communication may transmit ACK information and NACK information to UE-A. In other words, the reception UE having successfully performed decoding the PSSCH may transmit ACK information through the PSFCH, and the reception UE having failed to decode the PSSCH may transmit NACK information through the PSFCH. In option 2, the information transmitted by the reception UEs to the transmission UE (UE-A) may differ from each other (i.e., UE-B transmits NACK information, and UE-C transmits ACK information). Accordingly, for UE-A having received different feedback information to accurately decode, the reception UEs in the group need to use different PSFCH transmission resources. In addition, when UE-B and UE-C transmit the same information by using the same PSFCH transmission resource (i.e., when both the UEs transmit ACK or NACK), UE-A having received the same may not determine a reception UE from which the corresponding feedback information has been received. Accordingly, the reception frequency resources of the PSCCH or the PSSCH need to be associated with the two or more PSFCH frequency resources. Meanwhile, the distance condition or RSRP condition described in option 1 may be further applied to option 2. In other words, the reception UEs in the group may feed back ACK or NACK information to the transmission UE only when the distance condition or RSRP condition is met.

The methods described in FIGS. 13A, 13B, 13C, and 13D are examples for a case where the reception frequency resource of the PSCCH or the PSSCH is associated with one PSFCH frequency resource, and thus may not be applied to option 2. Therefore, a new method for applying the methods described in FIGS. 13A, 13B, 13C, and 13B to option 2 is required.

More specifically, it has been described in FIGS. 13B and 13C that the L×M/α×γ<M condition needs to be met to solve the PSFCH resource shortage problem. However, this condition may be applied only when the PSCCH or the PSSCH frequency resource and one PSFCH resource are associated (e.g., option 1 above). As described above, in option 2, since the PSCCH or PSSCH frequency resource needs to be associated with two or more PSFCH resources (i.e., the number of reception UEs in the group need to use different PSFCH resources), the number of reception UEs in the group needs to be considered. Therefore, when the number of reception UEs in one group is defined as G, the G×L×M/α×γ<M condition needs to be met to solve the PSFCH resource shortage problem. In a case where the example for L=4, M=100, α=4, γ=2 described in FIGS. 13B and 13C is applied, if the number of reception UEs in the group is assumed to be G=5, the left side is 5×4×100/4×2=1000, the right side is 100 in the above-described equation, and thus the condition is not met.

To solve this problem, when using the method of FIGS. 13B and 13C, the reception UEs in the group share the same PSFCH frequency resource, and the respective reception UEs may transmit PSFCHs by using different codes. For example, when groupcast communication including UE-1, UE-2, UE-3, UE-4, and UE-5 is assumed and it is assumed that UE-1 is a transmission UE and the remaining UEs are reception UEs in the group, in FIG. 13B, UE-1 transmits the PSCCH or the PSSCH including start frequency index 0 in slot index 0′, and the reception UEs (UE-2, UE-3, UE-4, and UE-5) receive the same. UE-2, UE-3, UE-4, and UE-5 may know that the PSFCH frequency resource having slot index 0′ and the start frequency index 0 is the start frequency index capable of transmitting the PSFCH. In this case, UE-2, UE-3, UE-4, and UE-5 may use the same PSFCH frequency resource but apply different codes. More specifically, UE-2, UE-3, UE-4, and UE-5 may have their own UE IDs. In this case, the UE ID may be a source ID of each reception UE or a higher layer ID capable of identifying each UE included in the same group in groupcast communication. Each reception UE knows its own UE ID and may select a code according to the ID. In this case, the code may mean a root index for determining a sequence or a cyclic shift. As another example, the code may mean the orthogonal cover code (OCC) on the time axis or the OCC on the frequency axis. Each reception UE may select a code resource that can be use each reception UE, through a modulo operation of its own ID and a specific number “C”. For example, UE-2 may obtain “0” through the modulo operation of its own ID and “C”, and UE-3 may obtain “1” through the modulo operation of its own ID and ‘C’. UE-2 having obtained “0” may select the code corresponding to “0” and UE-3 having obtained “1” may select the code corresponding to “1”. UE-2 and UE-3 may multiply the PSFCH to be transmitted and the selected code on the time axis or frequency axis and transmit the same. Therefore, UE-1 may receive PSFCHs transmitted from UE-2, UE-3, UE-4, and UE-5 through different codes in the same PSFCH frequency resource.

In the above-described example, “C” may be a fixed value or a variable value according to the method for forming the group in groupcast communication. More specifically, the UEs in the group may know their mutual group destination IDs by exchanging information about the group members before performing groupcast communication. For example, when UE-1 is a transmission UE and UE-2, UE-3, UE-4, and UE-5 are reception UEs in the above-described example, UE-1 is aware of the group destination ID for the reception UEs to receive before groupcast transmission. In this case, “C” may vary depending on the number of group members constituting the group and may be configured while exchanging information about the group members before performing groupcast communication. For example, “C” may be configured through PC-5 RRC or may be configured in the resource pool information performing groupcast communication. Meanwhile, there may be the case where information about the group members is not known before performing groupcast communication. In this case, since the information about the group members is absent, the number of the group members may not be known. In this case, a fixed value may be used as “C”. As another example, in the coverage of the base station, the base station may configure the above-described “C” value through system information or RRC. The information may be included in the resource pool configuration information for groupcast communication.

To solve the PSFCH resource shortage problem caused in FIGS. 13B and 13C, in FIG. 13D, the PSFCH resources associated with the slots where the PSCCH or the PSSCH is received are distinguished using different codes. In the above-described example, the method for selecting the PSFCH resource to be transmitted by each UE through modulo operation of the UE ID and “C” may be also applied to FIG. 13D. For example, groupcast communication including UE-1, UE-2, UE-3, UE-4, and UE-5 is assumed, and it may be assumed that UE-1 is a transmission UE and the remaining UEs are reception UEs in the group. In FIG. 13D, UE-1 transmits a PSCCH or a PSSCH including start frequency index 0 in slot index 0′, and the reception UEs (UE-2, UE-3, UE-4, and UE-5) receive the same. UE-2, UE-3, UE-4, and UE-5 may determine that the PSFCH frequency resource having start frequency index 0 is the start frequency index capable of transmitting the PSFCH and know that code 0 needs to be used to transmit the PSFCH since the PSCCH or the PSSCH is received in slot index 0′. In this case, UE-2, UE-3, UE-4, and UE-5 may use the same PSFCH frequency resource and the same code corresponding to slot index 0′ and may apply different codes for distinguishing the UEs. More specifically, UE-2, UE-3, UE-4, and UE-5 may have their own UE IDs. In this case, the UE ID may be a source ID of each reception UE or a higher layer ID capable of identifying each UE included in the same group in groupcast communication. Each reception UE knows its own UE ID and may select a code according to the ID. In this case, the code may mean a root index for determining a sequence or a cyclic shift. As another example, the code may mean the orthogonal cover code (OCC) on the time axis or the OCC on the frequency axis. Each reception UE may select a code resource which can be used by each reception UE, through a modulo operation of its own ID and a specific number “C”. For example, UE-2 may obtain “0” through the modulo operation of its own ID and “C”, and UE-3 may obtain “1” through the modulo operation of its own ID and “C”. UE-2 having obtained “0” may select the code corresponding to “0” and UE-3 having obtained “1” may select the code corresponding to “1”. UE-2 and UE-3 may multiply the PSFCH to be transmitted and the selected code on the time axis or frequency axis and transmit the same. Therefore, UE-1 may receive PSFCHs transmitted from UE-2, UE-3, UE-4, and UE-5 through different codes in the same PSFCH frequency resource.

In the examples of FIGS. 12, 13A, 13B, 13C, and 13D, to correctly transmit and receive the PSFCH, the SL transmission/reception UE needs to know the number of bits of HARQ-ACK/NACK information included in the PSFCH, which may be determined based on a combination of one or more of the following parameters.
A period of a slot in which a PSFCH resource is present (i.e., a period of a PSFCH time axis resource, N in FIG. 12)
Whether to bundle HARQ-ACK/NACK information: In FIG. 12, the HARQ-ACK/NACK information corresponding to the PSSCH received by the V2X reception UE in slot 2, slot 3, slot 4, and slot 5 may be transmitted in slot 8, and the HARQ-ACK/NACK bits transmitted in slot 8 may be values determined through an AND operation of the respective HARQ-ACK/NACK bits of the PSSCHs received in slot 2, slot 3, slot 4, and slot 5 (i.e., if any one is NACK, it is determined to be NACK).
Whether to use and configure retransmission in units of CBGs: When retransmission in units of CBGs is used, one TB may be split into two or more CBGs and HARQ-ACK/NACK feedback may be possible in units of CBGs. In this case, two-bit or more HARQ-ACK/NACK feedback information for one TB may be transmitted through the PSFCH.
The number of TBs included in a PSSCH: When one PSSCH transmits two TBs, the number of bits of the HARQ-ACK/NACK information may be two (when the above-described retransmission in units of CBGs is not used).
The number of PSSCHs actually transmitted/received: FIG. 12 illustrates transmission, in slot 8, of HARQ-ACK/NACK feedback of the PSSCHs received in slot 2, slot 3, slot 4, and slot 5. When the SL channel quality is poor, the reception UE may fail to receive one or more of the PSSCHs in some cases. In such a case, the reception UE may generate HARQ-ACK/NACK information based on the number of PSSCHs actually received.
A timing relationship between a PSSCH reception time point and a PSFCH transmission time point or a minimum signal processing time K of the UE for PSSCH processing and PSFCH transmission preparation: In FIG. 12, it is assumed that K=3. It may be assumed that the reception UE receiving the PSSCH has received the PSSCH in slot “n” and a PSFCH resource is present in slot “n+x”. In this case, the reception UE transmitting the PSFCH may transmit the above-described HARQ-ACK/NACK information of the PSSCH through the PSFCH present in slot “n+x” by using the smallest “x” value among the integers equal to or greater than K. In other words, the reception UE having received the PSSCH in slot 2 (n=2) in FIG. 12 may be considered. Since PSFCH resources are present in slot 4 (n+x=4) and slot 8 (n+x=8), in the example above, x=2 (when n+x=4) or x=6 (when n+x=8). When it is assumed that K=3, the reception UE needs to use the smallest “x” value among the integers equal to or greater than K=3, the reception UE may select x=6 and transmit the PSFCH in slot 8 in the above-described example. As another example, the reception UE having received the PSSCH in slot 1 (n=1) in FIG. 12 may be considered. Since PSFCH resources are present in slot 4 (n+x=4) and slot 8 (n+x=8), in the example above, x=3 (when n+x=4) or x=7 (when n+x=8). When it is assumed that K=3, the reception UE needs to use the smallest “x” value among the integers equal to or greater than K=3, the reception UE may select x=3 and transmit PSFCH in slot 4 in the above-described example.

The above-described K value may be determined by the SL UE through a combination of one or more of the following methods or may be configured through system information and RRC of the base station or configured through PC-5 RRC.
Method 1) K may be fixed (e.g., K=2) regardless of the size of the subcarrier. This is why a minimum processing time exceeding 28 symbols in all subcarrier spacings may not be defined in consideration of a UE processing time capability.
Method 2) K may be determined depending on the size of the used subcarrier. For example, K=2 for 15 kHz and 30 kHz, and K=3 for 60 kHz and 120 kHz.
Method 3) K may be configured according to an SL resource pool or pre-configured according to the SL resource pool. As another example, it may be configured to differ depending on unicast or groupcast communication schemes in the SL resource pool.
Method 4) A method for determining by a combination of one or more of a) to d) below, such as a UE processing capability and a time interval of the PSSCH and the PSFCH Time point at which PSSCH transmission ends, i.e., last symbol time point
   Time point at which PSFCH transmission starts, i.e., first symbol time point
   UE processing capability
   Slot boundary point

The above-described methods may be modified and applied as follows. When receiving PSSCH in slot n, the reception UE may transmit HARQ-ACK feedback information for the PSSCH through the PSFCH positioned earliest among the PSFCHs where the PSSCH and PSFCH time axis interval is equal to or greater than y symbols. y may be a value preconfigured by the transmission UE or a value configured in the SL resource pool where the corresponding PSSCH or PSFCH is transmitted. For this configuration, the SL reception UE may be required to exchange its processing capability with the SL transmission UE, and furthermore, the configuration may differ depending on the subcarrier spacing.

As another example, the UE processing capability may be divided into two stages, e.g., normal processing capability (capability type 1) and enhanced processing capability (capability type 2), and different K values may be applied depending on subcarriers. More specifically, information about the UE processing capability of the SL transmission/reception UE may be exchanged in the process of the RRC configuration between the SL UE and the base station or PC-5 RRC connection setup process between SL UEs. As specified in Table 1, the UE having the normal processing capability (capability type 1) may apply K=2 when the subcarrier spacing (SCS) used for SL transmission/reception is 15 kHz or 30 kHz, and the UE having the enhanced processing capability (capability type 2) may apply K=1 when the subcarrier spacing (SCS) used for SL transmission/reception is 15 kHz or 30 kHz.

TABLE 1

| | K for Processing | K for Processing |
|---|---|---|
| SCS | Capability Type 1 | Capability Type 2 |
| 15 kHz | 2 | 1 |
| 30 kHz | 2 | 1 |
| 60 kHz | 3 | 2 |
| 120 kHz | 3 | 2 |

To describe an example of the bit size of HARQ-ACK/NACK information constituting the PSFCH, it may be assumed that N=2 and K=1. In other words, it is a case where the PSFCH resource is configured on the time axis every N=2 slots in the SL resource pool, and the reception UE has the capability of transmitting HARQ-ACK/NACK feedback information for the PSSCH received in slot “n” in “n+1” slot (K=1). In this case, the slot where HARQ-ACK feedback may actually be transmitted may be determined as shown in FIG. 13E.

In FIG. 13E, the first row means logical indices corresponding to indices of slots constituting an SL resource pool. In this case, the logical slot indices are allocated only to slots included in the SL resource pool, and the logical slot indices are not allocated to slots not included in the SL resource pool. In other words, since the 4^{th}, 8^{th}, 9^{th}, 10^{th}, 12^{th}, and 13^{th} slots are not included in the SL resource pool, the logical slot indices are not allocated. Meanwhile, the second row of FIG. 13E illustrates the physical slot indices, and the slot indices may be allocated according to the order of the slots regardless of whether the corresponding slot is included in the SL resource pool. The third row of FIG. 13E indicates whether the corresponding slot is included in the SL resource pool, O means that the corresponding slot is included in the SL resource pool, X means that the corresponding slot is not included in the SL resource pool. The fourth row of FIG. 13E indicates whether PSFCH transmission is possible, O means a slot in which PSFCH transmission is possible, and X means a slot in which PSFCH transmission is impossible. In this case, the slot where PSFCH transmission is possible needs to be included in the SL resource pool and may be determined according to N calculated based on the logical slot index, and N=2 is assumed (i.e., PSFCH resources may be present every two slots based on the logical slot indices). The fifth row of FIG. 13E may mean the slot in which the PSSCH corresponding to HARQ-ACK/NACK information transmitted through the PSFCH is received. For example, the PSFCH transmitted in physical slot index n may include HARQ feedback information about the PSSCH received in slot n−1 and slot n−2.

As shown in the fifth row of FIG. 13E, the number of bits of HARQ-ACK/NACK information transmitted on the PSFCH by each reception UE in the slot capable of performing PSFCH transmission may be 2 bits. In other words, each reception UE may determine the number of HARQ-ACK/NACK feedback bits that need to be included in the PSFCH when transmitting the PSFCH in a specific slot in consideration of K which is configured or determined depending on the UE processing capability, the period N when PSFCH resources are configured, slots where PSFCH resources are present, and slots included in the SL resource pool. More specifically, the determined number of HARQ-ACK/NACK feedback information bits may be determined by Equation (1) below.

The number of HARQ-ACK bits to be included in a PSFCH transmitted in physical slot n=The number of slots included in an SL resource pool among slots from physical slot (k−K+1) to physical slot (n−K) (1)

In Equation (1), physical slot index k may be the index of the slot where the PSFCH resource configured immediately before the PSFCH which may be transmitted in physical slot n is included.

As another example, when N and K are given, the maximum number of HARQ-ACK feedback bits transmitted on one PSFCH by the reception UE may be fixed (i.e., all the reception UEs transmit HARQ-ACK feedback including the same number of bits). Such fixed size of the number of feedback bits may be defined as the maximum number of HARQ-ACK feedback bits transmitted in one PSFCH by one reception UE and may be determined by Equation (2) below.

The maximum number of HARQ-ACK/NACK feedback bits that the reception UE can transmit on one PSFCH=N+K−1 (2)

As another example, when feedback is transmitted in SL unicast or groupcast communication, the number of bits of the feedback may be calculated using the number of slots included in the SL resource pool, N, K, and the number of slots where the PSSCH associated with the HARQ-ACK feedback transmitted on the PSFCH in the slot for PSFCH transmission can be transmitted. In the above-described examples, the number of HARQ-ACK feedback bits transmitted by the reception UE may be increased to a predetermined value or more depending on a combination of N and K. In this case, since the PSFCH needs to transmit many bits, the reception error rate of the PSFCH may increase. Accordingly, the reception UE may transmit only the last K bits among the feedback bits that need to be transmitted by the reception UE (i.e., transmits only HARQ-ACK/NACK feedback information about the recently received PSSCH) while not transmitting the remaining bits.

Meanwhile, PSFCH resources may be present in a specific slot, but there may be no SL slot where the PSSCH associated with HARQ-ACK/NACK feedback is to be transmitted. In other words, there may be a case where feedback information bits to be transmitted are not present in the PSFCH resources of a specific slot depending on N and K and the SL resource pool configuration. In this case, even though the reception UE is configured with the PSFCH resources in the corresponding slot, the reception UE may consider that there is no PSFCH resource. In other words, although it is configured so that PSFCH resources are present, the reception UE may disregard the corresponding PSFCH resources and may not perform PSFCH transmission. In this case, the reception UE may perform transmission/reception of control information and/or PSSCH in the corresponding slot.

Herein, when HARQ-ACK/NACK is described, the corresponding PSSCH may be a PSSCH for unicast or groupcast, which is configured or indicated to transmit HARQ-ACK/NACK. In other words, the proposed scheme may not apply to the PSSCH not required to transmit HARQ-ACK/NACK (i.e., PSSCH where no HARQ-ACK/NACK is configured). Furthermore, the control information scheduling a PSSCH may mean a PSCCH, but the disclosure is not limited thereto. In other words, the control information may be not transmitted only through the PSSCH (e.g., transmitted through the PSSCH). Furthermore, the control information may be one piece of control information, but multiple pieces of control information may schedule one PSSCH.

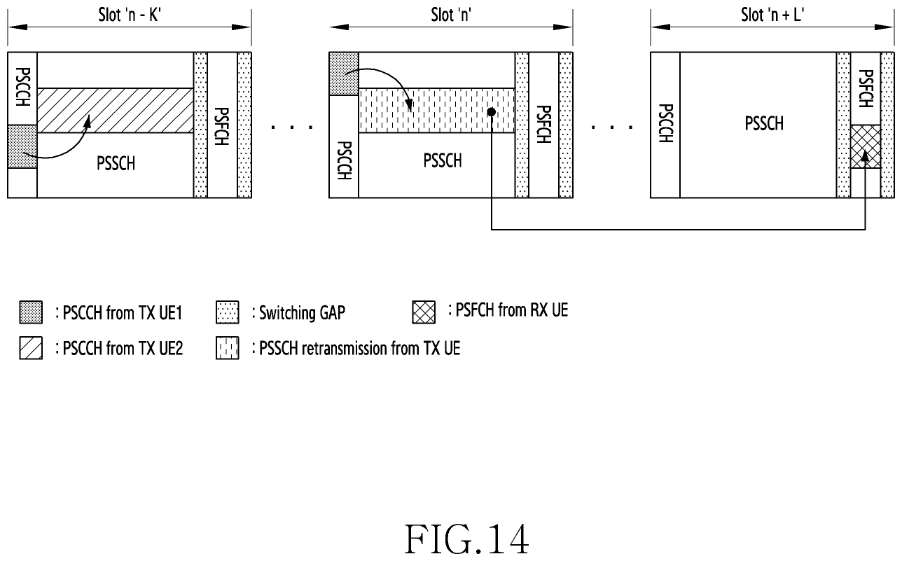

FIG. 14 is a diagram illustrating another example of frequency resource allocation of an SL feedback channel, according to an embodiment.

FIG. 14 illustrates a case where the same TB is repeatedly transmitted through two or more slots through slot aggregation or blind retransmission, unlike FIG. 10. As described with reference to FIG. 10, FIG. 14 illustrates that a start PRB index of a last PSSCH transmitted by the V2X transmission UE (or a last PRB index of a last PSSCH) can be associated with a start PRB index of a PSFCH transmitted by the V2X reception UE.

More specifically, in FIG. 14, the V2X transmission UE may transmit the PSCCH and the PSSCH in n−K slot and repeatedly transmit the same in slot n. The V2X reception UE may decode the PSCCH to obtain SL control information and obtain information about time/frequency/code resources of the PSSCH therefrom. Furthermore, the V2X reception UE may obtain information about the RV and new data indicator (NDI) from the SL control information. The V2X reception UE may be aware whether the TB transmitted in slot n is a new TB or a repeated transmission of the TB transmitted in slot n−K from the information.

Furthermore, the V2X transmission/reception UE may be configured with information about the number of aggregated slots (when slot aggregation is configured) or the maximum number of repeated transmissions (when blind retransmission is reconfigured). Through the information, the V2X transmission UE and the V2X reception UE may identify whether the slot where the last PSSCH of a specific TB is transmitted or the PSSCH in the corresponding slot is the last slot.

Accordingly, as shown in FIG. 14, when the start PRB index of the PSSCH in slot n is M, the start PRB index of the PSFCH in slot (n+L) may be the same M. As another example, when the start PRB index of the PSSCH in slot n is M, the PSFCH in slot (n+L) may start at (M+offset) (or (M−offset)). In this case, the unit of the offset may be the PRB and be a fixed value identically used by all the V2X UEs or a value configured to vary for each resource pool. For example, in resource pool 1, 10 may be used as the offset value and, in resource pool 2, 20 may be used as the offset value.

Similar to the above-described example, the last PRB index of the PSSCH transmitted in slot n by the V2X transmission UE may have a correlation with the start PRB index of the PSFCH transmitted in slot (n+L) by the V2X reception UE.

Meanwhile, FIG. 14 illustrates that the PSCCH and the PSSCH are transmitted in the same slot, but the disclosure is not limited thereto. For the information about the number of resource blocks constituting the PSFCH, at least one of the methods described in FIG. 10 may be used.

FIG. 14 illustrates a PSSCH repeatedly transmitted through two or more slots (repeated transmission through blind retransmission or repeated transmission through slot aggregation). In this case, the PSCCH including control information about the corresponding PSSCH may be together transmitted in the slot where the PSSCH is transmitted. In FIG. 14, since the start PRB index of the last PSSCH transmitted is associated with the start PRB index of the PSFCH, if the V2X reception UE fails to decode the last PSSCH transmitted in slot n, the V2X reception UE may not obtain the information about the start PRB index of the PSFCH. To solve such problem, the V2X reception UE may determine the start PRB index of the PSFCH by using the start PRB index of the last PSSCH received by the V2X reception UE (or successfully decoded by the V2X reception UE).

Meanwhile, the PSSCH may be transmitted always in the same frequency position regardless of the number of slots used for slot aggregation or the number of repeated transmissions of PSSCH. In such a case, the V2X reception UE may determine the start PRB index of the PSFCH from the start PRB index of the PSSCH with reference to any PSSCH among the PSSCHs received by the V2X reception UE (or successfully decoded by the V2X reception UE).

The HARQ-ACK/NACK information transmitted by one V2X reception UE in groupcast or unicast communication may be transmitted through one PSFCH resource or through two PSFCH resources. When the HARQ-ACK/NACK information is transmitted through one PSFCH, the methods described in FIG. 14 may be applied. However, when the HARQ-ACK/NACK information is transmitted through two PSFCH resources (i.e., one PSFCH resource is used for HARQ-ACK transmission, and the other PSFCH resource is used for HARQ-NACK transmission), a method for indicating the start points of the two PSFCH resources may be required.

When two PSFCH resources are contiguously present, as described in FIG. 14, the start PRB index of the first PSFCH resource may be derived from the start PRB index of the last PSSCH (or derived from the start PRB index of the last PSSCH successfully received by the V2X UE). In other words, the start PRB index of the first PSFCH resource may be M or (M+offset) (or (M−offset)) in an example. Furthermore, the start PRB index of the second PSFCH resource may be determined depending on the number of PRBs constituting the first PSFCH resource. For example, if it is assumed that the number of PRBs constituting the first PSFCH resource is [X1], the start PRB index of the second PSFCH resource may be M+[X1] or (M+offset+[X1]) (or (M−offset−[X1])). In this case, [X1] may use a fixed value or be configured by the base station or V2X transmission UE.

When two PSFCH resources are not contiguous, as described in FIG. 14, the start PRB index of the first PSFCH resource may be derived from the start PRB index of the last PSSCH (or derived from the start PRB index of the last PSSCH successfully received by the V2X UE). The start PRB index of the second PSFCH resource may be configured through a separate offset. For example, the start PRB index of the first PSFCH resource may be M or (M+offset 1) (or (M−offset 1)) in an example. The start PRB index of the second PSFCH resource may be (M+offset 2) or (M+offset 1+offset 2) (or (M−offset 1−offset 2)). In this case, offset 1 may mean a difference between the start PRB index of the PSSCH and the start PRB index of the PSFCH, and offset 2 may mean a difference between the start PRB index of the first PSFCH resource and the start PRB index of the second PSFCH resource.

As another example, the start PRB index of the second PSFCH resource may be (M+[X1]+offset 2) or (M+offset 1+[X1]+offset 2) (or (M−offset 1−[X1]−offset 2)). In this case, [X1] means the number of PRBs constituting the first PSFCH resource, and [X1] may use a fixed value or be configured by the base station or the V2X transmission UE. In addition, in the example, offset 1 may mean a difference between the start PRB index of the PSSCH and the start PRB index of the PSFCH. Furthermore, offset 2 may mean a difference between the start PRB index of the first PSFCH resource and the start PRB index of the second PSFCH resource.

Although not described in FIG. 14, one of the methods described in FIGS. 13B, 13C, and 13D may be applied to FIG. 14.

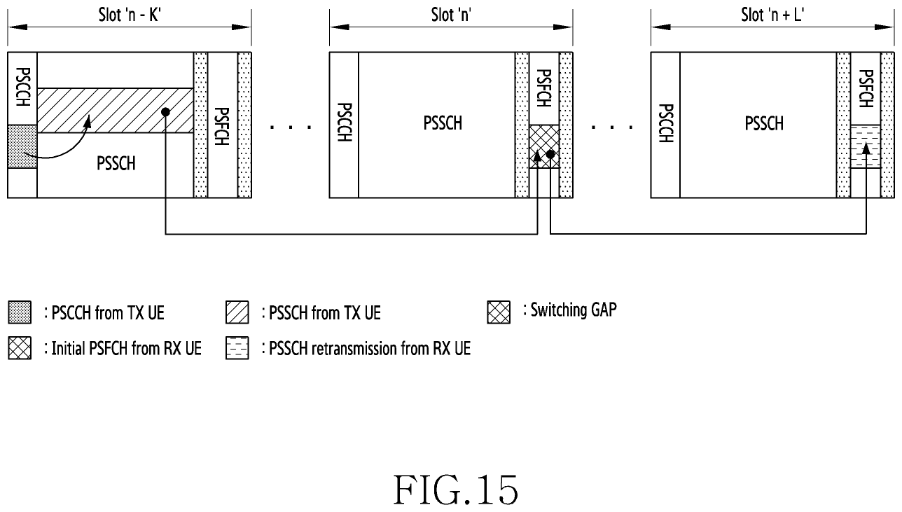

FIG. 15 is a diagram illustrating another example of frequency resource allocation of an SL feedback channel, according to an embodiment.

Unlike FIGS. 10 and 11 to 14, FIG. 15 illustrates a case where the PSFCH is repeatedly transmitted. This case may be the same in that the start PRB index (or last PRB index) of the PSSCH may denote the start PRB index of the PSFCH initially transmitted through one of the methods described with reference to FIGS. 10 to 14.

In FIG. 15, it may be assumed that the number of PSFCH repeated transmissions is previously known to the V2X transmission UE for receiving the PSFCH and the V2X reception UE for transmitting the PSFCH. For example, the number of repeated transmissions of the PSFCH may be included in the resource pool configuration information and may be configured by the base station or, may be preconfigured when the base station is absent.

Therefore, as a method for configuring the start PRB index of the X^{th} transmitted PSFCH (where X is an integer greater than 1), one of the following methods may be used.

For example, the same PRB index as the start PRB index of the initially transmitted PSFCH may be used. As another example, if an offset has been applied to determining the start PRB index of the initially transmitted PSFCH, the same corresponding offset may be applied. More specifically, when the start PRB index of the initially transmitted PSFCH is (M+offset) (or (M−offset)), the start PRB index of the second transmitted PSFCH may be (M+offset+offset) (or (M−offset−offset)). In the above-described example, M means the start PRB index or the last PRB index of the PSSCH.

As another example, different offset values may be used for each PSFCH transmission. In other words, when the start PRB index of the initially transmitted PSFCH is (M+offset 1) (or (M−offset 1)), the start PRB index of the second transmitted PSFCH may be (M+offset 1+offset 2) (or (M−offset 1−offset 2)). In this case, offset 1 and offset 2 may be configured by the base station or, may be pre-configured when the base station is absent.

As the number of PRBs constituting the PSFCH, the same value may be used for initial transmission and retransmission of the PSFCH. As another example, the number of PRBs used for PSFCH initial transmission and the number of PRBs used for PSFCH retransmission may differ from each other. For example, when the number of PRBs used for initial transmission is Y1, the number of PRBs of the second transmitted PSFCH may be (Y1+Z1). In this case, Z1 may be a fixed value or configured by the base station or pre-configured. The number of PRBs of the third transmitted PSFCH may be (Y1+Z1+Z2). In this case, Z2 may be the same value as Z1 or may be a different value from Z1. Likewise, Z2 may be a fixed value or configured by the base station or pre-configured. The above-described methods may also be applied to the number of PRBs of the fourth transmitted PSFCH.

Although not described in FIG. 15, one of the methods described in FIGS. 13B, 13C, and 13D may be applied to FIG. 15.

FIG. 16 is a diagram illustrating another example of frequency resource allocation of an SL feedback channel, according to an embodiment.

FIG. 10 illustrates that the PSSCH frequency resources are associated with the PSFCH frequency resources. However, FIG. 16 illustrates that the PSCCH frequency resources are associated with the PSFCH frequency resources, unlike FIG. 10.

As shown in FIG. 16, the V2X transmission UE may transmit the PSCCH and the PSSCH in slot n−K. The V2X reception UE may decode the PSCCH to obtain SL control information and information about time/frequency/code resources of the PSSCH therefrom. FIG. 16 illustrates that PSCCH and PSSCH are transmitted in the same slot, but the disclosure is not limited thereto. In other words, the PSCCH is transmitted in slot n−K, but the PSSCH may be transmitted in a subsequent slot. In such a case, the time relationship between the PSCCH and the PSSCH may be fixed (e.g., the PSSCH is transmitted 4 ms after PSCCH reception), or may be configured by the base station. As another example, the V2X transmission UE may indicate the time relationship between the PSCCH and the PSSCH in the SL control information transmitted by the V2X transmission UE. The V2X reception UE having obtained the SL control information may decode the PSSCH through information about frequency/code resources of the PSSCH and the time relationship between the PSCCH and the PSSCH.

The start PRB index of the PSCCH transmitted in slot (n−K) by the V2X transmission UE may have a correlation with the start PRB index of the PSFCH transmitted in slot n by the V2X reception UE. For example, when the start PRB index of the PSCCH in slot (n−K) is M, the start PRB index of the PSFCH in slot n may be the same M. As another example, when the start PRB index of the PSCCH in slot (n−K) is M, the PSFCH in slot n may start at (M+offset) (or (M−offset)). In this case, the unit of the offset may be the PRB and be a fixed value identically used by all the V2X UEs or a value configured to vary for each resource pool. For example, in resource pool 1, 10 may be used as the offset value and, in resource pool 2, 20 may be used as the offset value.

Similar to the above-described example, the last PRB index of the PSCCH transmitted in slot (n−K) by the V2X transmission UE may have a correlation with the start PRB index of the PSFCH transmitted in slot n by the V2X reception UE.

For the information about the number of resource blocks constituting the PSFCH, at least one of the methods described in FIGS. 8, 9, and 10 may be used.

FIG. 16 illustrates a case where one piece of SL control information is transmitted in one slot, but there may be a case where two pieces of SL control information are transmitted in one slot. For example, when SL control information is split into two groups, the first SL control information may include essential information (e.g., information related to sensing operation and destination ID) and may further include time/frequency/code resource allocation information where the second SL control information for decoding the second SL control information is transmitted. The second SL control information may include time/frequency/code resource allocation information about the SL data channel for decoding the SL data channel. In such a case, the start PRB index of the PSFCH may be associated with the start PRB index (or the last PRB index) of the PSCCH where the first SL control information is transmitted. As another example, the start PRB index of the PSFCH may be associated with the start PRB index (or the last PRB index) of the PSCCH where the second SL control information is transmitted.

The HARQ-ACK/NACK information transmitted by one V2X reception UE in groupcast or unicast communication may be transmitted through one PSFCH resource or through two PSFCH resources. When transmitted through one PSFCH resource, the above-described methods may be applied. However, when transmitted through two PSFCH resources (i.e., one PSFCH resource is used for HARQ-ACK transmission, and the other PSFCH resource is used for HARQ-NACK transmission), a method for indicating the start points of the two PSFCH resources may be required.

When the two PSFCH resources are contiguously present, the start PRB index of the first PSFCH resource may be derived from the start PRB index of the PSCCH as described above. In other words, the start PRB index of the first PSFCH resource may be M or (M+offset) (or (M−offset)) in an example. Furthermore, the start PRB index of the second PSFCH resource may be determined depending on the number of PRBs constituting the first PSFCH resource. For example, if it is assumed that the number of PRBs constituting the first PSFCH resource is [X1], the start PRB index of the second PSFCH resource may be (M+[X1]) or (M+offset+[X1]) (or (M−offset−[X1])). In this case, [X1] may use a fixed value or may be configured by the base station or the V2X transmission UE.

When the two PSFCH resources are not contiguous, the start PRB index of the first PSFCH resource may be derived from the start PRB index of the PSCCH, and the start PRB index of the second PSFCH resource may be configured through a separate offset as described above. For example, the start PRB index of the first PSFCH resource may be M or (M+offset 1) (or (M−offset 1)) in the example. The start PRB index of the second PSFCH resource may be (M+offset 2) or (M+offset 1+offset 2) (or (M−offset 1−offset 2)). In this case, offset 1 may mean a difference between the start PRB index of the PSCCH and the start PRB index of the PSFCH, and offset 2 may mean a difference between the start PRB index of the first PSFCH resource and the start PRB index of the second PSFCH resource.

As another example, the start PRB index of the second PSFCH resource may be (M+[X1]+offset 2) or (M+offset 1+[X1]+offset 2) (or (M−offset 1−[X1]−offset 2)). In this case, [X1] means the number of PRBs constituting the first PSFCH resource, and [X1] may use a fixed value or may be configured by the base station or the V2X transmission UE. In addition, in the example, offset 1 may mean a difference between the start PRB index of the PSCCH and the start PRB index of the PSFCH. Furthermore offset 2 may mean a difference between the start PRB index of the first PSFCH resource and the start PRB index of the second PSFCH resource.

Although not described in FIG. 16, one of the methods described in FIGS. 13B, 13C, and 13D may be applied to FIG. 16.

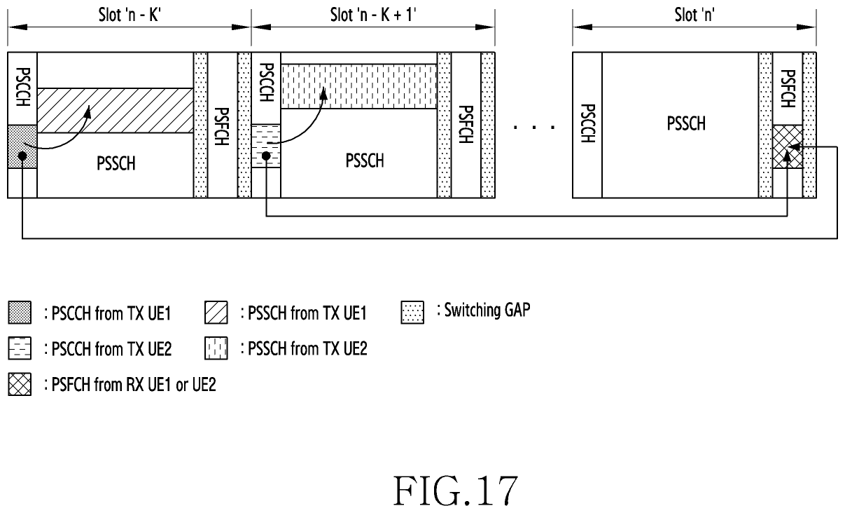

FIG. 17 is a diagram illustrating another example of frequency resource allocation of an SL feedback channel, according to an embodiment.

FIG. 17 illustrates a case in which the start PRB indices of the PSCCH transmitted by different V2X transmission UEs are the same. In other words, it is the case where the start PRB index of the PSCCH transmitted by V2X transmission UE 1 to V2X reception UE 1 in slot (n-K) is the same as the start PRB index of the PSCCH transmitted by V2X transmission UE 2 to V2X reception UE 2 in slot (n−K+1). Since the PSCCHs transmitted in different slots use the same start PRB index, if the methods described with reference to FIG. 16 are applied, the start PRB indexes of the PSFCH are identical, and thus collision may occur between the PSFCHs. This problem may be caused not only when different V2X transmission UEs transmit PSCCHs to different V2X reception UEs but also when different V2X transmission UEs transmit PSCCHs to the same V2X reception UE as shown in FIG. 17 (i.e., when the PSCCH/PSSCH transmitted by V2X transmission UE 1 and the PSCCH/PSSCH transmitted by V2X transmission UE 2 are transmitted to V2X transmission UE 1). One of the following methods may be used to solve such a PSFCH collision problem.

Method 1) A start PRB index of a PSCCH and a V2X UE ID indicate a start PRB index of a PSFCH
Method 1-1) A case of using a source ID
Method 1-2) A case of using a destination ID
Method 2) A start PRB index of a PSCCH and an index of a slot where a PSSCH is transmitted indicate a start PRB index of a PSFCH

Specific operations of the above-described methods are identical to the operations described in FIG. 11.

Although not described in FIG. 17, one of the methods described in FIGS. 13B, 13C, and 13D may be applied to FIG. 17.

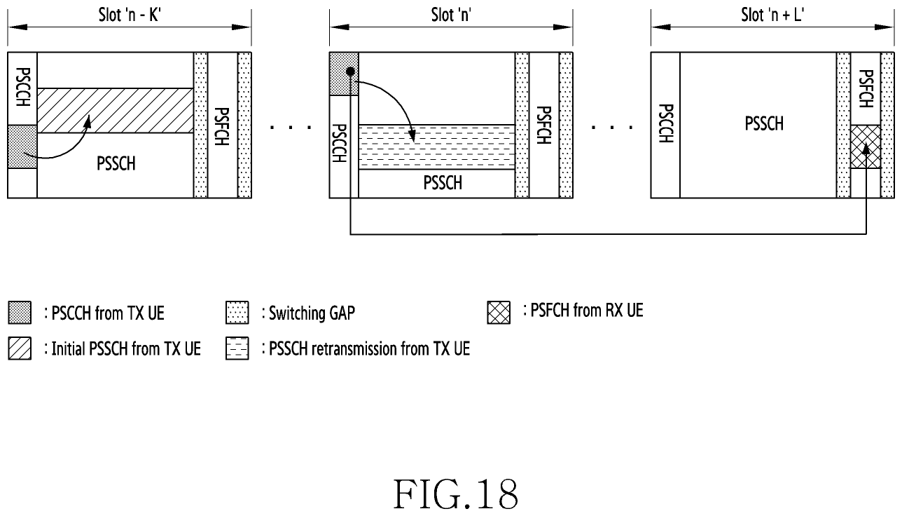

FIG. 18 is a diagram illustrating another example of frequency resource allocation of an SL feedback channel, according to an embodiment.

FIG. 18 illustrates a case where the same TB is repeatedly transmitted through two or more slots through slot aggregation or blind retransmission, unlike FIGS. 16 and 17. As described in connection with FIG. 16, FIG. 18 illustrates that the start PRB index of the last PSCCH transmitted by the V2X transmission UE (or the last PRB index of the last PSCCH) may be associated with the start PRB index of the PSFCH transmitted by the V2X reception UE.

More specifically, in FIG. 18, the V2X transmission UE may transmit a PSCCH and a PSSCH in slot (n−K) and repeatedly transmit the same in slot n. The V2X reception UE may decode the PSCCH to obtain SL control information and information about time/frequency/code resources of the PSSCH therefrom. Furthermore, the V2X reception UE may obtain information about the RV and NDI from the SL control information. The V2X reception UE may identify whether the TB transmitted in slot n is a new TB or a repeated transmission of the TB transmitted in slot (n−K) from the information.

In addition, the V2X transmission/reception UE may be configured with information about the number of aggregated slots (when slot aggregation is configured) or the maximum number of repeated transmissions (when blind retransmission is reconfigured). Through the information, the V2X transmission UE and the V2X reception UE may identify whether the slot where the last PSSCH of a specific TB is transmitted or the PSSCH in the corresponding slot is the last slot.

Accordingly, as shown in FIG. 18, when the start PRB index of the PSCCH in slot n is M, the start PRB index of the PSFCH in slot (n+L) may be the same M. As another example, when the start PRB index of the PSCCH in slot n is M, the PSFCH in slot (n+L) may start at (M+offset) (or (M−offset)). In this case, the unit of the offset may be the PRB and be a fixed value identically used by all the V2X UEs or a value configured to vary for each resource pool. For example, in resource pool 1, 10 may be used as the offset value and, in resource pool 2, 20 may be used as the offset value.

Similar to the above-described example, the last PRB index of the PSCCH transmitted in slot n by the V2X transmission UE may have a correlation with the start PRB index of the PSFCH transmitted in slot (n+L) by the V2X reception UE.

Meanwhile, FIG. 18 illustrates that the PSCCH and the PSSCH are transmitted in the same slot, but the disclosure is not limited thereto. For the information about the number of resource blocks constituting the PSFCH, at least one of the methods described in FIGS. 10, 11, 14, and 15 may be used.

FIG. 18 illustrates a PSSCH repeatedly transmitted through two or more slots (repeated transmission through blind retransmission or repeated transmission through slot aggregation). In this case, the PSCCH including control information about the corresponding PSSCH may be together transmitted in the slot where the PSSCH is transmitted. In FIG. 12, since the start PRB index of the last PSCCH transmitted is associated with the start PRB index of the PSFCH, if the V2X reception UE fails to decode the last PSCCH transmitted in slot n, the V2X reception UE may not obtain the information about the start PRB index of the PSFCH. To solve such a problem, the V2X reception UE may determine the start PRB index of the PSFCH by using the start PRB index of the last PSCCH received (or successfully decoded) by the V2X reception UE.

Meanwhile, the PSCCH may be transmitted always in the same frequency position regardless of the number of slots used for slot aggregation or the number of repeated transmissions of the PSSCH. In such a case, the V2X reception UE may determine the start PRB index of the PSFCH from the start PRB index of the PSCCH with reference to any PSCCH among the PSCCHs received (or has successfully decoded) by the V2X reception UE.

The HARQ-ACK/NACK information transmitted by one V2X reception UE in groupcast or unicast communication may be transmitted through one PSFCH resource or through two PSFCH resources. When the HARQ-ACK/NACK information is transmitted through one PSFCH resource, the above-described methods may be applied. However, when the HARQ-ACK/NACK information is transmitted through two PSFCH resources (i.e., one PSFCH resource is used for HARQ-ACK transmission, and the other PSFCH resource is used for HARQ-NACK transmission), a method for indicating the start points of the two PSFCH resources may be required.

When the two PSFCH resources are contiguously present, the start PRB index of the first PSFCH resource may be derived from the start PRB index of the PSSCH as described above. In other words, the start PRB index of the first PSFCH resource may be M or (M+offset) (or (M−offset)) in an example. Furthermore, the start PRB index of the second PSFCH resource may be determined depending on the number of PRBs constituting the first PSFCH resource. For example, if it is assumed that the number of PRBs constituting the first PSFCH resource is [X1], the start PRB index of the second PSFCH resource may be (M+[X1]) or (M+offset+[X1]) (or (M−offset−[X1])). In this case, [X1] may use a fixed value or be configured by the base station or V2X transmission UE.

When the two PSFCH resources are not contiguous, the start PRB index of the first PSFCH resource may be derived from the start PRB index of the PSCCH, and the start PRB index of the second PSFCH resource may be configured through a separate offset as described above. For example, the start PRB index of the first PSFCH resource may be M or (M+offset 1) (or (M−offset 1)) in the example. The start PRB index of the second PSFCH resource may be (M+offset 2) or (M+offset 1+offset 2) (or (M−offset 1−offset 2). In this case, offset 1 may mean a difference between the start PRB index of the PSCCH and the start PRB index of the PSFCH, and offset 2 may mean a difference between the start PRB index of the first PSFCH resource and the start PRB index of the second PSFCH resource.

As another example, the start PRB index of the second PSFCH resource may be (M+[X1]+offset 2) or (M+offset 1+[X1]+offset 2) (or (M−offset 1−[X1]−offset 2)). In this case, [X1] means the number of PRBs constituting the first PSFCH resource, and [X1] may use a fixed value or be configured by the base station or V2X transmission UE. Furthermore, in the example, offset 1 may mean a difference between the start PRB index of the PSCCH and the start PRB index of the PSFCH. Furthermore, offset 2 may mean a difference between the start PRB index of the first PSFCH resource and the start PRB index of the second PSFCH resource.

Although not described in FIG. 18, one of the methods described in FIGS. 13B, 13C, and 13D may be applied to FIG. 18.

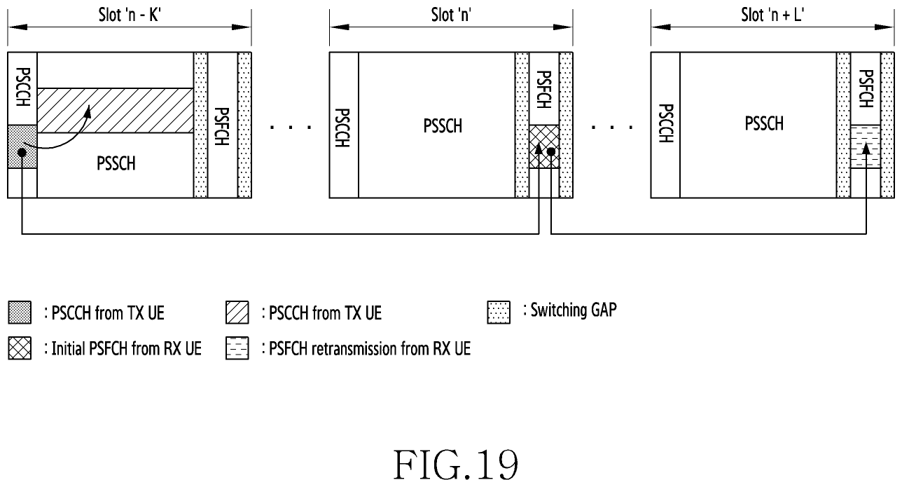

FIG. 19 is a diagram illustrating another example of frequency resource allocation of an SL feedback channel, according to an embodiment.

Unlike FIGS. 16, 17, and 18, FIG. 19 illustrates a case where the PSFCH is repeatedly transmitted. This case may be the same in that the start PRB index (or last PRB index) of the PSCCH may denote the start PRB index of the PSFCH initially transmitted through one of the methods described with reference to FIGS. 16, 17, and 18.

In FIG. 19, it may be assumed that the number of PSFCH repeated transmissions is previously known to the V2X transmission UE for receiving the PSFCH and the V2X reception UE for transmitting the PSFCH. For example, the number of repeated transmissions of the PSFCH may be included in the resource pool configuration information and may be configured by the base station or, may be preconfigured when the base station is absent.

Therefore, as a method for configuring the start PRB index of the X^{th} transmitted PSFCH (where X is an integer greater than 1), one of the following methods may be used.

For example, the same PRB index as the start PRB index of the initially transmitted PSFCH may be used. As another example, if an offset has been applied to determining the start PRB index of the initially transmitted PSFCH, the same corresponding offset may be applied. More specifically, when the start PRB index of the initially transmitted PSFCH is (M+offset) (or (M−offset)), the start PRB index of the second transmitted PSFCH may be (M+offset+offset) (or (M−offset−offset)). In the above-described example, M means the start PRB index or the last PRB index of the PSCCH.

As another example, different offset values may be used for each PSFCH transmission. In other words, when the start PRB index of the initially transmitted PSFCH is (M+offset 1) (or (M−offset 1)), the start PRB index of the second transmitted PSFCH may be (M+offset 1+offset 2) (or (M−offset 1−offset 2)). In this case, offset 1 and offset 2 may be configured by the base station or, may be pre-configured when the base station is absent.

As the number of PRBs constituting the PSFCH, the same value may be used for initial transmission and retransmission of the PSFCH. As another example, the number of PRBs used for PSFCH initial transmission and the number of PRBs used for PSFCH retransmission may differ from each other. For example, when the number of PRBs used for initial transmission is Y1, the number of PRBs of the second transmitted PSFCH may be (Y1+Z1). In this case, Z1 may be a fixed value or may be a value configured by the base station or configured in advance. The number of PRBs of the third transmitted PSFCH may be (Y1+Z1+Z2). In this case, Z2 may be the same value as Z1 or may be a different value from Z1. Likewise, Z2 may be a fixed value or may be a value configured by the base station or configured in advance. The above-described methods may also be applied to the number of PRBs of the fourth transmitted PSFCH.

The index of the start PRB described in FIGS. 10, 11, 14, 15, 16, 17, 18, and 19 may mean the start index of the subchannel or the lowest CCE index. In this case, the subchannel means a set of contiguous PRBs or a set of non-contiguous PRBs and may be interpreted as a resource block group (RBG). Furthermore, a CCE means control channel elements constituting a control channel, and one CCE may include N PRBs. In this case, N may be an integer greater than 1.

In FIGS. 10, 11, 14, 15, 16, 17, 18, and 19, the methods for allocating frequency resources of the PSFCH through the start PRB index of the PSFCH and the number of PRBs constituting the PSFCH are described. However, when the number of PRBs constituting the PSFCH is always fixed, frequency resources of the PSFCH may be allocated through the start PRB index of the PSFCH or the last PRB index of the PSFCH. In this case, the start index of the PRB may be interpreted as the start index of the subchannel or the lowest CCE index.

Although not described in FIG. 19, one of the methods described in FIGS. 13B, 13C, and 13D may be applied to FIG. 19.

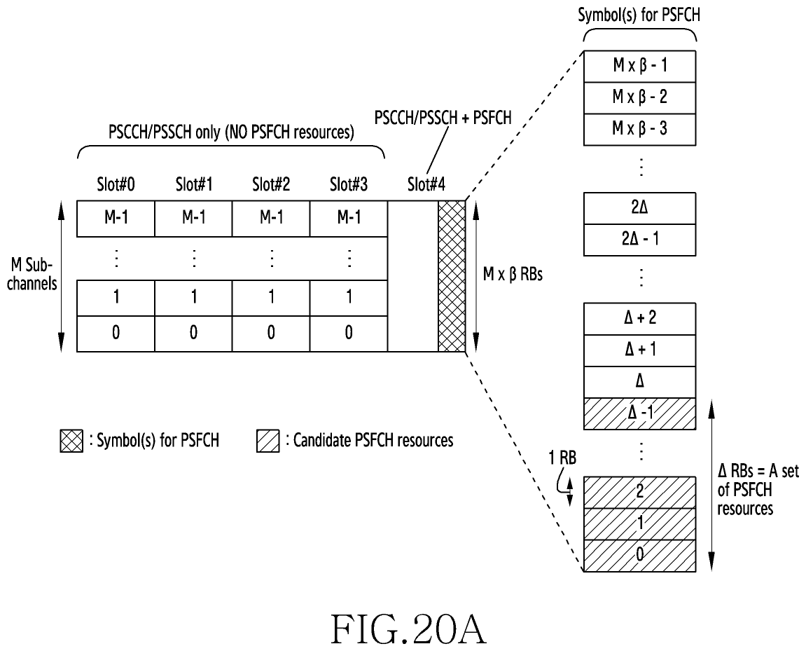

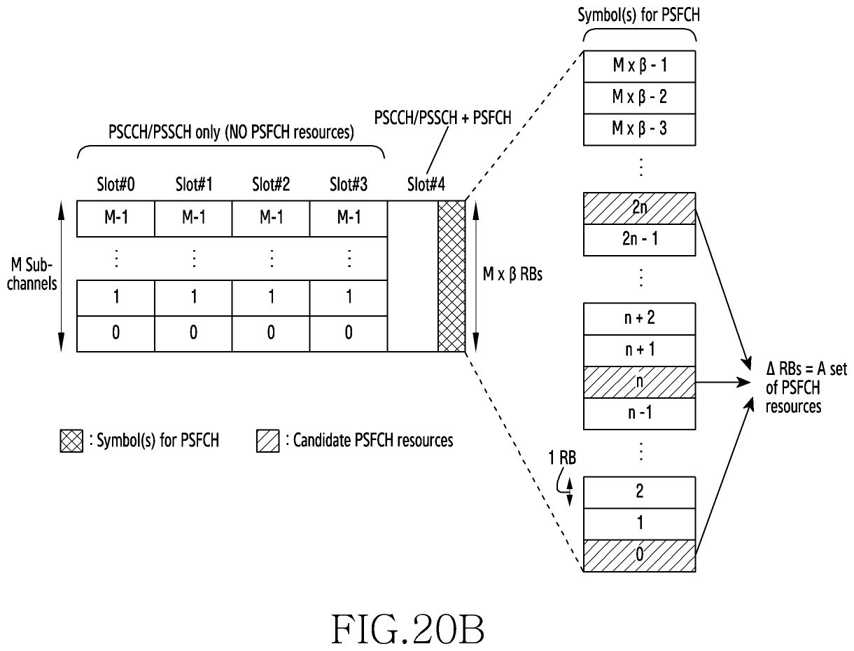

FIG. 20A is a diagram illustrating another example of frequency resource allocation of an SL feedback channel, according to an embodiment. FIG. 20B is a diagram illustrating another example of frequency resource allocation of an SL feedback channel, according to an embodiment.

FIGS. 20A and 20B illustrate FIGS. 13B, 13C, and 13D in more detail, and in FIGS. 20A and 20B, M means the number of subchannels of the PSSCH constituting one sidelink BWP present in the SL bandwidth or the SL bandwidth. In this case, one PSSCH subchannel may include one or more frequency blocks (RBs), and as defined in FIGS. 13B and 13C, the number of the RBs constituting one PSSCH subchannel may be defined as β. In this case, β may have one value among 10, 15, 20, 50, 75, and 100, and may be obtained by receiving, by the SL UE, resource pool information (in other words, information about the number of RBs constituting the PSSCH subchannel may be included in the resource pool configuration information), as described in FIGS. 6 to 7. In addition, as defined in FIGS. 13B and 13C, the number of RBs constituting the PSFCH transmitted by one reception UE may be defined as γ. γ may be 1 or one among integers greater than 1 (e.g., 2, 4, etc.), and may be configured in the SL resource pool information, such as R or, a fixed value may be always used in all resource pools without separate configuration (e.g., in all resource pools, the value is fixed to be γ=1), unlike β.

In addition, as described with reference to FIGS. 12, 13B, 13C, and 13D, the PSFCH transmission resource (or the PSFCH reception resource, hereinafter, which is referred to as a PSFCH resource) may be present every N slots, where N may be one of 1, 2, and 4. For example, N=1 may mean that PSFCH resources are present every SL slot, and N=2 and N=4 may mean that PSFCH resources are present every two SL slots (N=2) and that PSFCH resources are present every four SL slots (N=4), respectively. Furthermore, as described with reference to FIG. 12, a minimum difference between a time point at which the reception UE receives a PSCCH/PSSCH from the transmission UE and a time point at which the reception UE transmits the PSFCH to the transmission UE may be defined as K slots, which may mean a minimum time interval required for the reception UE to receive SL control information (PSCCH) from the transmission UE, decode SL data (PSSCH), and prepare to transmit SL feedback channel. In other words, K may be required to be determined with a sufficient margin in consideration of the UE signal processing capability. For example, K may be one of 1, 2, and 3, and K=1 may be supported by UEs having fast signal processing capability (i.e., having high signal processing capability), and K=3 may be supported by UEs having slow signal processing capability (i.e., having low signal processing capability). K=1 may mean that, when the reception UE receives the PSCCH/PSSCH in SL slot index n, the reception UE needs to transmit the PSFCH in slots after SL slot index (n+1). Furthermore, K=2 and K=3 may mean that, when the reception UE receives the PSCCH/PSSCH in SL slot index n, the reception UE needs to transmit the PSFCH in slots after slot index (n+2) (K=2) and slots after SL slot index (n+3) (K=3).

N and K described above may be configured by one value for each SL resource pool, and N and K may be configured by different values for each resource pool. For example, in resource pool 1, N=N1 and K=K1, and in resource pool 2, values of N=N2 and K=K2. In this case, N1 and N2 may be the same or different, and K1 and K2 may be the same or different. When the SL UE is in the in the coverage of the base station, the SL UE may be configured with the corresponding information from the base station through system information and RRC. In the case of out-of-coverage where no base station is present, N and K included in preconfigured resource pool information may be used. When N and K are not included in the resource pool configuration information, the transmission UE and reception UE which are to perform SL transmission or reception in the corresponding resource pool may not operate SL HARQ in the corresponding resource pool.

Meanwhile, two UEs performing unicast communication may perform negotiation on the UE signal processing capability and use K corresponding to the negotiation result during the PC5-RRC connection setup process described in FIG. 3. For example, it may be assumed that UE-A and UE-B which are to perform unicast communication have fast signal processing capability (capability A or signal processing AI) and slow signal processing capability (capability B or signal processing time B1). When one resource pool capable of performing unicast communication may be configured and two or more K values are configured in the corresponding resource pool, UE-A and UE-B may negotiate to perform unicast communication using a K value greater than the slowest signal processing capability (capability B or signal processing time B1). As another example, when two or more resource pools capable of performing unicast communication are configured and one K value is configured in each resource pool, UE-A and UE-B may negotiate to perform unicast communication in the resource pool configured with a K value greater than the slowest signal processing capability (capability B or signal processing time B1). In the above-described examples, there may be multiple K values that can meet the slowest signal processing capability (capability B or signal processing time B1) of UE-A and UE-B. In such a case, the UEs may negotiate to perform unicast communication using the smallest K value among the multiple K values. As another example, when two or more resource pools capable of performing unicast communication are configured and two or more K values are configured in each resource pool, the UEs may negotiate to perform unicast communication using a K value that can meet the slowest signal processing capability (capability B or signal processing time B1) of UE-A and UE-B. In this case, when there are multiple K values meeting the slowest signal processing capability (capability B or signal processing time B1) of UE-A and UE-B, the UEs may negotiate to perform unicast communication using the smallest K value among the multiple K values.

FIGS. 20A and 20B illustrate examples of the case where N=4 and K=1 are configured in the SL resource pool information, and reception UE-A having received the PSCCH/PSSCH in SL slot index 0 may transmit the PSFCH in a slot after SL slot index 1 (K=1). In this case, since PSFCH resources are present only in slot index 4 (N=4), reception UE-A may transmit PSFCH in slot index 4. As another example, reception UE-B having received the PSCCH/PSSCH in SL slot index 1 may transmit PSFCH in a slot after SL slot index 2 (K=1). In this case, since PSFCH resources are present only in slot index 4 (N=4), reception UE-B may transmit the PSFCH in slot index 4 like reception UE-A. As another example, reception UE-C having received the PSCCH/PSSCH in slot index 2 may transmit the PSFCH in a slot after SL slot index 3 (K=1). In this case, since PSFCH resources are present only in slot index 4 (N=4), reception UE-C may transmit PSFCH in slot index 4 like reception UE-A and reception UE-B. As another example, reception UE-D having received the PSCCH/PSSCH in slot index 3 may transmit PSFCH in a slot after SL slot index 4 (K=1). In this case, since PSFCH resources are present only in slot index 4 (N=4), reception UE-D may transmit the PSFCH in slot index 4 like reception UE-A, reception UE-B, and reception UE-C.

As described above, no PSFCH resource is present in slot indexes 0, 1, 2, and 3, and PSFCH resources may be present only in slot index 4. FIGS. 20A and 20B illustrate that a PSFCH symbol present in slot index 4 (when the PSFCH includes one symbol) or PSFCH symbols (when the PSFCH includes two or more symbols) are positioned in the SL bandwidth or an entire SL BWP in the SL bandwidth. Therefore, the PSFCH symbol(s) on the frequency axis may include (M×β) RBs. The number of symbol(s) constituting the PSFCH on the time axis may be included in resource pool information as described in FIGS. 9A and 9B and may be explicitly or implicitly configured. When the number of symbol(s) constituting the PSFCH is explicitly configured in the resource pool information, such as 1, 2 or 3, the structure of the PSFCH transmitted by one reception UE may be as shown in FIGS. 9A and 9B. The number of symbol(s) constituting the PSFCH may be implicitly configured in the resource pool information through whether the PSFCH is repeatedly transmitted or the number of repeated transmissions. For example, in a case where the default number of PSFCH symbols on the time axis is defined as 1, if repeated transmission is configured in the resource pool information, it may mean that the number of PSFCH symbols transmitted by the reception UE in the corresponding resource pool is 2. If repeated transmission is not configured in the resource pool information, it may mean that the number of PSFCH symbols transmitted by the reception UE in the corresponding resource pool is 1. Similarly, in a case where the number of PSFCH symbols on the time axis is defined as 2, if repeated transmission is configured in the resource pool information, it may mean that the number of PSFCH symbols transmitted by the reception UE in the corresponding resource pool is 4. If repeated transmission is not configured in the resource pool information, it may mean that the number of PSFCH symbols transmitted by the reception UE in the corresponding resource pool is 2. As another example, in a case where the default number of PSFCH symbols on the time axis is defined as 1, if the number of repeated transmissions=2 is configured in the resource pool information, it may mean that the number of PSFCH symbols transmitted by the reception UE in the corresponding resource pool is 2. In addition, if the number of repeated transmissions=4 is configured in the resource pool information, it may mean that the number of PSFCH symbols transmitted by the reception UE in the corresponding resource pool is 4. If repeated transmission is not configured in the resource pool information or the number of repeated transmissions=0 is configured, it may mean that the number of PSFCH symbols transmitted by the reception UE in the corresponding resource pool is 1.

A case where PSFCH symbol(s) are positioned in the SL bandwidth or a portion of SL BWP on the frequency axis may also be considered. Furthermore, slot 4 may include a GAP as described with reference to FIG. 7

As described above, the reception UE having received the PSCCH and the PSSCH in at least one slot among slot indices 0, 1, 2, and 3 of FIGS. 20A and 20B may transmit SL HARQ feedback to the transmission UE by using at least one of the PSFCH resources configured in slot 4. In this case, the mapping relationship between the PSSCH resource and the PSFCH resource (or the mapping relationship between the PSCCH resource and the PSFCH resource) shown in FIGS. 13B, 13C, and 13D may be applied. In other words, the reception UE may obtain the position of a PSFCH frequency resource which is to be transmitted by the reception UE (or a start point of the PSFCH frequency resource) through a combination of the index of the slot where the PSSCH is received and the start index of the subchannel where the PSSCH is received. In addition, the transmission UE may obtain information about the position of the PSFCH frequency resource which is to be received by the transmission UE (or a start point of the PSFCH frequency resource) through a combination of the index of the slot where the PSSCH is transmitted and the start index of the subchannel where the PSSCH is transmitted (or the index of the start subchannel).

In the above-described mapping relationship between the PSSCH resource and the PSFCH resource or the mapping relationship between the PSSCH resource and the PSFCH resource described with reference to FIGS. 13B, 13C, and 13D, it has been described that the slot index of the PSSCH and the index of the start subchannel may be associated with the position of the PSFCH frequency resource that is to be actually transmitted (or to be actually received). More generally, as shown in FIGS. 20A and 20B, the slot index of the PSSCH and the index of the start subchannel may be associated with start points of candidate PSFCH resources including one or more PSFCH frequency resources, rather than the position of the PSFCH frequency resource to be actually transmitted (or to be actually received) (or the start point of the PSFCH frequency resource). In this case, if the number of PSFCH candidates is one, the above-described mapping relationship between the PSSCH resource and the PSFCH frequency resource or the mapping relationship between the PSSCH resource and the PSFCH frequency or code (or frequency and code) resource described with reference to FIGS. 13B, 13C, and 13D may be the same. In contrast, if the number of PSFCH candidates is two or more, the time and frequency resource of one PSSCH may be associated with frequency or code (or frequency and code) resources of multiple PSFCH candidates.

More specifically, as shown in FIG. 20A, a set of candidate PSFCH frequency resources including Δ PSFCH resources may be considered. For convenience of description, the candidate PSFCH frequency resources including PSFCH frequency resource indices 0 to (Δ−1) may be defined as candidate PSFCH frequency resource set index 0. The candidate PSFCH frequency resources including PSFCH frequency resource indices Δ to (2Δ−1) may be defined as candidate PSFCH frequency resource set index 1. Generally, a total of ((M×β)/Δ) candidate PSFCH frequency resource sets including Δ PSFCH resources may be present, and may be present from index 0 to index ((M×β)/Δ−1) with reference to the slowest frequency (or highest frequency). However, such indexing is an example, and as described with reference to FIGS. 13B, 13C, and 13D, the start index of the candidate PSFCH frequency resource set may not be 0 depending on the configured (or preconfigured or fixed) offset value. For example, when the offset is 3, the set of the candidate PSFCH frequency resources constituting indices 3Δ to (3Δ−1) may correspond to candidate PSFCH frequency resource set index 0.

The start index of the above-described candidate PSFCH frequency resource set (or indices of candidate start PSFCH frequency resources), the PSSCH slot index, and the start subchannel index (or start index of subchannel) may have the following correlation. The PSSCH received in start subchannel index m (or start index m of subchannel) of slot index 1 may denote the start point of the candidate PSFCH frequency resource set including Δ PSFCH candidates. For example, according to the mapping relationship between the PSSCH resource and the PSFCH frequency resource described with reference to FIG. 13B, the PSSCH transmitted in start subchannel index 0 (or start index 0 of subchannel) of slot index 0 in FIG. 20A may denote candidate PSFCH frequency resource set index 0 including PSFCH frequency resource indices 0 to (Δ−1) in slot index 4. The PSSCH transmitted in start subchannel index 1 (or start index 1 of subchannel) of slot index 0 may denote candidate PSFCH frequency resource set index 1 including PSFCH frequency resource indices Δ and (2Δ−1) in slot index 4.

In the above examples, it has been described that slot index 0 of the PSSCH and start subchannel index 0 (or start index 0 of subchannel) are associated with candidate PSFCH frequency resource set index 0. However, as described above, PSSCH slot index 0 and start subchannel index 0 (or start index 0 of subchannel) may be associated with candidate PSFCH frequency resource set index Q depending on a configured (or preconfigured or fixed) offset value. Generally, it may mean that PSSCH slot index 1 and start subchannel index m (or start index m of subchannel) may be associated with candidate PSFCH frequency resource set index δ. In this case, as described above, Δ candidate PSFCH frequency resources may be present in the candidate PSFCH frequency resource set having index δ. The Δ value may be included in the resource pool information configured through RRC or system information by the base station. In the case of out-of-coverage where no base station is present, the Δ value may be included in preconfigured resource pool information.

Meanwhile, for the Δ value which means PSFCH frequency resources constituting one candidate PSFCH frequency resource set described above, a fixed value may be always used, instead of being included in the resource pool configuration information. For example, the Δ value may be defined as a function of β (the number of RBs constituting the PSSCH subchannel) described above and γ (the number of RBs constituting the PSFCH used by one UE for transmission or reception of one PSFCH) described above. For example, Δ=floor(β/γ) may be defined, and in this case, floor( ) may be a function that means rounding down to the decimal point. As another example, Δ=ceil(β/γ) may be defined, and in this case, ceil( ) may be a function that means rounding up to the decimal point. In this case, separate signaling for configuring the Δ value in the resource pool information may be omitted.

FIG. 20A illustrates that the PSFCH frequency resources constituting one candidate PSFCH frequency resource set are contiguously positioned in one candidate PSFCH frequency resource set. In contrast, FIG. 20B illustrates that the PSFCH frequency resources constituting one candidate PSFCH frequency resource set are non-contiguously positioned in one candidate PSFCH frequency resource set. For example, in FIG. 20B, Δ PSFCH frequency resources having PSFCH frequency resource indices 0, n, 2n, . . . , and (Δ−n) may constitute one candidate PSFCH frequency resource set. In this case, each PSFCH frequency resource may have offset “n” which may be configured in the resource pool information. When offset n=1, FIG. 20B may be the same as FIG. 20A. Accordingly, various embodiments described in FIG. 20A may also be applied to FIG. 20B.

In FIGS. 20A and 20B, the reception UE having determined the index of one candidate PSFCH frequency resource set including Δ PSFCH frequency resources through the slot index of the PSSCH and the index of the start subchannel (or start index of subchannel) may transmit PSFCH to the transmission UE by using at least one PSFCH frequency resource among Δ PSFCH frequency resources. In this case, there may be various methods for the reception UE to select PSFCH frequency resources, and one or a combination of two or more of at least one methods below may be used.

For example, as described in FIG. 13D, the reception UE may select one PSFCH frequency resource to be actually transmitted by the reception UE among Δ PSFCH frequency resources through the source ID. More specifically, one PSFCH frequency resource may be selected through modulo operation of the source ID and A. In this case, as described with reference to FIG. 11, the source ID may include [Y] bits, and may be included in the MAC PDU where [Y1] bits of the source ID are transmitted through the PSCCH and the remaining [Y2] bits are transmitted through the PSSCH. The source ID used in the above-described modulo operation may the [Y] bits or [Y1] bits transmitted through the PSCCH.

As another example, the reception UE may randomly select one PSFCH frequency resource to be actually transmitted by the reception UE among Δ PSFCH frequency resources.

As another example, the reception UE may select one PSFCH frequency resource having the lowest (or highest) index, as the PSFCH frequency resource to be actually transmitted by the reception UE, from among the Δ PSFCH frequency resources.

In the above examples, a case where the reception UE selects one PSFCH frequency resource from among the Δ PSFCH frequency resources is described, but the disclosure is not limited thereto. For example, the reception UE may select two or more PSFCH frequency resources from among the Δ PSFCH frequency resources. In this case, the examples of selecting one PSFCH frequency resource described above may be extended.

For example, upon selecting multiple PSFCH frequency resources based on the source ID, the reception UE may select one PSFCH frequency resource through the above-described modulo operation and select contiguous PSFCH frequency resources based thereon. In other words, upon selecting PSFCH frequency resource index 6 through modulo operation based on the source ID, the reception UE mays elect multiple PSFCH frequency resources in the order of indices 6, 7, 8, . . . (in ascending order). Alternatively, the reception UE may select multiple PSFCH frequency resources in the order of indices 6, 5, 4, . . . (in descending order).

Upon randomly selecting multiple PSFCH frequency resources, the reception UE may randomly select one PSFCH frequency resource and select contiguous PSFCH frequency resources based thereon. In other words, upon selecting PSFCH frequency resource index 6 by random selection, the reception UE may select multiple PSFCH frequency resources in the order of indices 6, 7, 8, . . . (in ascending order), or the reception UE may select multiple PSFCH frequency resources in the order of indices 6, 5, 4, . . . (in descending order). As another example of randomly selecting multiple PSFCH frequency resources, the reception UE may randomly select multiple PSFCH frequency resources from among the Δ PSFCH frequency resources.

Upon selecting multiple PSFCH frequency resources with reference to the lowest (or highest) index among the A, the reception UE may select multiple PSFCH frequency resources in ascending order or descending order of the index with reference to the selected lowest (or highest) index.

Meanwhile, it may be required to determine whether to transmit one PSFCH through one PSFCH frequency resource among the Δ PSFCH frequency resources or to transmit two or more PSFCHs through two or more PSFCH frequency resources. As an example, in the slot where PSFCH resources are configured (i.e., slot index 4 in FIGS. 20A and 20B), it may be associated with the number of HARQ-ACK and/or HARQ-NACK bits to be transmitted by the reception UE. More specifically, when the number of HARQ-ACK and/or HARQ-NACK bits to be transmitted by the reception UE is 1, one PSFCH may be transmitted through one PSFCH frequency resource. When the number of HARQ-ACK and/or HARQ-NACK bits to be transmitted by the reception UE is 2, two PSFCHs may be transmitted through two PSFCH frequency resources.

As another example, the number of PSFCHs to be transmitted by one reception UE may be configured in the resource pool information. The reception UE may select as many PSFCH frequency resources as the number of the configured PSFCHs through the above-described source ID, random selection, or lowest (or highest) frequency index and transmit HARQ feedback.

In the above-described examples, a method for determining the index of a candidate PSFCH frequency resource set including ΔPSFCH frequency resources for the PSSCH slot index and the start subchannel index (or the start index of a subchannel) has been primarily described. However, this may be extended to a method for determining the index of a candidate PSFCH code resource set including Δ PSCCH code resources for the PSSCH slot index and the start subchannel index (or the start index of a subchannel).

Meanwhile, the above-described PSFCH frequency resource selection method may be used in HARQ operation option 1 of unicast communication and groupcast communication described with reference to FIG. 13D. This is why, as described in FIG. 13D, HARQ operation option 2 of groupcast communication requires that each of the reception UEs participating in groupcast communication transmits HARQ feedback to the transmission UE, and thus as many PSFCH frequency and/or code resources as the number of the reception UEs may be required. In other words, the transmission UE may be required to determine a reception UE from which the HARQ feedback received from different reception UEs in the group has been transmitted, and one of the following methods may be considered.

For example, as described in FIG. 13D, the higher layer in groupcast communication may provide group information for groupcast communication. In this case, as described in FIG. 13D, the group information may include at least one of the number of group members participating in the groupcast communication and the group IDs. More specifically, when selecting one PSFCH frequency resource based on group information, as exemplified in FIG. 13D, the reception UE may select one PSFCH frequency resource through modulo operation of the group ID and the number of group members and transmit HARQ feedback in the corresponding PSFCH frequency resource. When selecting multiple PSFCH frequency resources, the reception UE may select one PSFCH frequency resource through the above-described modulo operation and select contiguous PSFCH frequency resources based thereon. In other words, when selecting PSFCH frequency resource index 6 through modulo operation of the group ID and the number of group members, the reception UE may select multiple PSFCH frequency resources in the order of indices 6, 7, 8, . . . (in ascending order). Alternatively, the reception UE may select multiple PSFCH frequency resources in the order of indices 6, 5, 4, . . . (in descending order). The above-described example may be extended to the case of selecting one PSFCH code resource or multiple PSFCH code resources.

Meanwhile, the above-described group information-based PSFCH frequency (or code) resource selection method, along with the method for selecting one PSFCH or multiple PSFCHs based on the source ID, random selection, or lowest (or highest) frequency index, may be operated as follows. For example, the reception UE may select one PSFCH frequency resource through modulo operation of the group ID and the number of group members and select one PSFCH code resource based on the source ID, random selection, or lowest (or highest) code index. The reception UE may transmit the selected PSFCH frequency resource by using the code selected by the reception UE.

For example, the reception UE may select one PSFCH frequency resource based on the source ID, random selection, or lowest (or highest) frequency index and select one PSFCH code resource through modulo operation of the group ID and the number of group members. The reception UE may transmit the selected PSFCH frequency resource by using the code selected by the reception UE.

In the above-described examples, the code resources (or code) may mean resources distinguished using codes, such as scrambling codes or orthogonal cover codes and different sequences (and cyclic shift applied to sequence) as described with reference to FIG. 9.

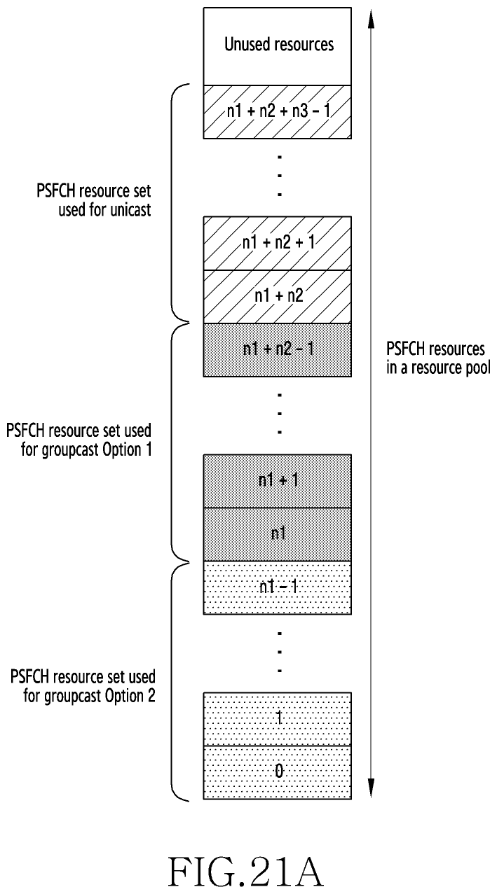

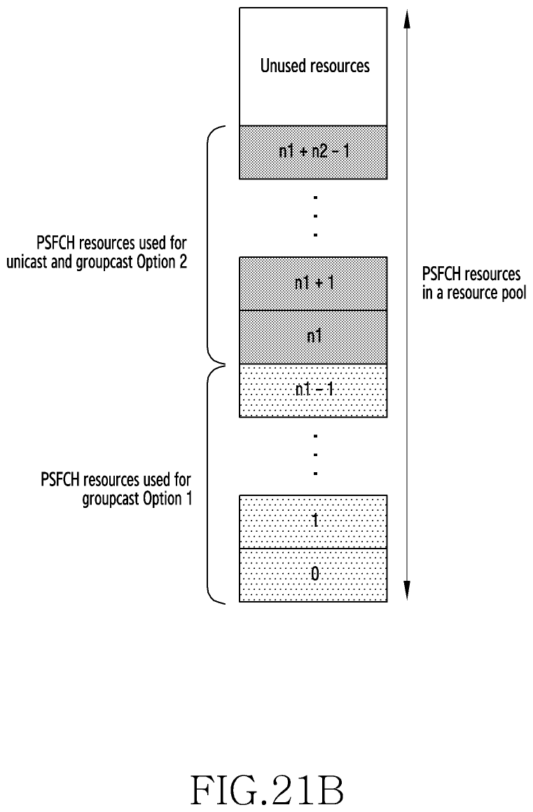

FIG. 21A is a diagram illustrating another example of frequency resource allocation of an SL feedback channel, according to an embodiment. FIG. 21B is a diagram illustrating another example of frequency resource allocation of an SL feedback channel, according to an embodiment.

As described in FIGS. 9A, 9B to 13D, groupcast communication may have two options depending on SL HARQ operation (option 1 and option 2). Meanwhile, as described in FIG. 4, unicast, groupcast, and broadcast communication may be performed in one resource pool. For example, in resource pool A, UE 1 and UE 2 may perform unicast communication after performing a PC-5 RRC connection setup procedure as exemplified in FIG. 4. In the same resource pool A, UE 3 may perform groupcast communication with the other UEs, and UE 4 may perform broadcast communication with the other UEs. As another example, one UE may perform two or more of unicast, groupcast, and broadcast communication with the same UE or different UEs in resource pool A.

In various scenarios described above, different interferences may be caused with the transmission UE for receiving the PSFCH depending on PSFCH transmission methods by reception UEs for transmitting PSFCH. More specifically, in the case of groupcast HARQ option 1 as described with reference to FIGS. 9A and 9B to 13D, the reception UEs for transmitting PSFCHs in the same group may transmit NACK by using the same time/frequency or the same time/frequency/code resources. In other words, each reception UE in the same group may transmit one sequence which means HARQ NACK, and the receiver of the transmission UE for receiving the same may receive overlapping sequences from two or more reception UEs. Accordingly, the reception power strength of the PSFCH received in the corresponding time/frequency resource may increase, which may cause interference with the reception of another PSFCH received at an adjacent frequency at the same time. This may be referred to as in-band emission (IBE), which may cause serious deterioration in reception performance of the PSFCH. As another example, in the case of groupcast HARQ option 2, the reception UEs for transmitting the PSFCH at the same time in the same group may technically transmit HARQ-ACK or HARQ-NACK by using frequency resources independent from each other. However, if the number of reception UEs for transmitting PSFCHs in the group increases, frequency division multiplexing (FDM) may not be performed between different PSFCHs due to the PSFCH frequency resource shortage problem as described in FIG. 13D. Accordingly, it may be required to perform code division multiplexing (CDM) on some PSFCH resources. In this case, as in groupcast option 1 described above, PSFCH reception performance may seriously deteriorated due to the IBE problem.

As a method for solving the IBE problem, the method shown in FIGS. 21A and 21B may be used. More specifically, FIG. 21A illustrates that the PSFCH frequency resource sets available for unicast, groupcast option 1, and groupcast option 2 HARQ feedback transmission in a resource pool where PSFCH resources are configured are divided. Unlike FIG. 21A, FIG. 21B illustrates that the PSFCH frequency resource sets available for unicast communication and groupcast option 1 HARQ feedback transmission are separated from PSFCH frequency resource sets available for groupcast option 2 HARQ feedback transmission.

For example, in FIG. 21A, the PSFCH frequency resource set used for groupcast option 2 HARQ feedback transmission may include n1 frequency blocks (RBs) or n1 PSFCH subchannels (indices 0 to (n1−1)). In addition, the PSFCH frequency resource set used for groupcast option 1 HARQ feedback transmission may include n2 RBs or n2 PSFCH subchannels (indices n1 to (n1+n2−1)). The PSFCH frequency resource set used for unicast communication HARQ feedback transmission may include n3 RBs or n3 PSFCH subchannels (indices (n1+n2) to (n1+n2+n3−1)). Similarly, FIG. 21B illustrates that the PSFCH frequency resource set used for groupcast option 1 HARQ feedback transmission may include n1 RBs or n1 PSFCH subchannels (indices 0 to (n1−1)), and the PSFCH frequency resource set used for unicast or groupcast option 2 HARQ feedback transmission may include n2 RBs or n2 PSFCH subchannels (indices n1 to (n1+n2−1)).

FIGS. 21A and 21B illustrate that the PSFCH frequency resource sets for unicast, groupcast option 1, and groupcast option 2 HARQ feedback transmission are contiguous on the frequency axis, but this is an example, and the PSFCH frequency resource sets for HARQ feedback transmission may be non-contiguous on the frequency axis.

Meanwhile, it may be assumed that the PSFCH frequency resource in the resource pool includes M RBs as shown in FIG. 7 or the resource pool includes M frequency resources as shown in FIG. 6 (i.e., when the symbols used for PSFCH transmission/reception in the PSFCH-configured resource pool use all of the M RBs). In this case, FIG. 21A illustrates that n1+n2+n3<M, and FIG. 21B illustrates that n1+n2<M. In other words, in FIG. 21A, among the M PSFCH frequency resources, (M−(n1+n2+n3)) frequency resources may not be used for PSFCH transmission/reception. Furthermore, in FIG. 21B, among the M PSFCH frequency resources, (M−(n1+n2)) frequency resources may not be used for PSFCH transmission/reception. In such a single resource pool, the unused PSFCH frequency resources may be used for another UE to transmit SL control information or data information in the corresponding resource pool or may be used for frequency division multiplexing of different PSFCH formats.

In other words, in FIG. 21A, the (n1+n2+n3) PSFCH frequency resources may be used as PSFCH frequency resources for transmission/reception of the PSFCH format transmitted based on sequence described with reference to FIG. 9A or 9B, and the remaining (M−(n1+n2+n3)) PSFCH frequency resources may be used as PSFCH frequency resources for transmission/reception of another PSFCH format transmitted based on channel coding described with reference to FIG. 9A or 9B. Similarly, in FIG. 21B, the (n1+n2) frequency resources may be used as PSFCH frequency resources for transmission/reception of the PSFCH format transmitted based on sequence described with reference to FIG. 9A or 9B, and the remaining (M−(n1+n2)) PSFCH frequency resources may be used as PSFCH frequency resources for transmission/reception of another PSFCH format transmitted based on channel coding described with reference to FIG. 9A or 9B. n1+n2+n3=M, and in FIG. 21B, n1+n2=M. This may mean that all of the M PSFCH frequency resources are allocated (i.e., in the PSFCH symbol, the PSFCH frequency resources may not be frequency-divided with SL control information and data information) or the same PSFCH format is used in the M PSFCH frequency resources.

In addition, in FIGS. 21A and 21B, n1, n2, and n3 may mean the same value or different values. Furthermore, the order of mapping PSFCH frequency resources for groupcast option 2, groupcast option 1, unicast communication HARQ feedback as shown in FIG. 21A is an example, and the disclosure is not limited thereto. Likewise, the order of mapping PSFCH frequency resources for groupcast option 1, groupcast option 2, and unicast communication HARQ feedback as shown in FIG. 21B is an example, and the disclosure is not limited thereto.

As described in the examples of FIGS. 10, 11, 13B, 13C, 13D, 14, 15, 16, 17, 18, 19, 20A, and 20B, the start point of the PSFCH frequency resource to be transmitted by each reception UE (i.e., the start RB index of the PSFCH or the start subchannel index of the PSFCH) may be associated with the start RB index (or start subchannel index) of the PSCCH or the PSSCH transmitted by each transmission UE and/or the slot index of the PSCCH or the PSSCH transmitted by each transmission UE. Accordingly, in the examples of FIGS. 21A and 21B, information about the start point and the end point of the frequency resource set used by the PSFCH (or the start point of the PSFCH frequency resource set) may be needed for unicast, groupcast option 1 and groupcast option 2 HARQ feedback transmission.

For example, the PSFCH transmission frequency resource used for unicast HARQ feedback transmission may be determined by the start subchannel index (or the start RB index) of the PSCCH or the PSSCH or the slot index of the PSCCH or the PSSCH received by the reception UE as described with reference to FIGS. 13A and 13C. In this case, configuration of an offset value may be required for the UE having received unicast to transmit the PSFCH in the PSFCH frequency resource set (i.e., from index (n1+n2) to index (n1+n2+n3−1)) for unicast communication shown in FIG. 21A. In other words, FIGS. 13B and 13C illustrate that the UE having received the PSCCH or the PSSCH in slot index “0” and start subchannel index (or start RB index) “0” transmits a PSFCH having index 0. If the mapping principle of FIG. 13B is applied to FIG. 21A, the UE having received the PSCCH or the PSSCH through unicast communication in slot index “0” and start subchannel index (or start RB index) “0” may transmit the PSFCH having index (n1+n2) (i.e., offset of n1+n2). The UE having received the PSCCH or the PSSCH through unicast communication in slot index “0” and start subchannel index (or start RB index) “1” may transmit a PSFCH having index (n1+n2+1). Similarly, if the mapping principle of FIG. 13C is applied to FIG. 21A, the UE having received the PSCCH or the PSSCH through unicast communication in slot index “0” and start subchannel index (or start RB index) “0” may transmit a PSFCH having index n1+n2 (i.e., offset of n1+n2). This may be the same as the case where the above-described mapping principle of FIG. 13B is applied. However, if the mapping of FIG. 13C is applied, the UE having received the PSCCH or the PSSCH through unicast communication in slot index “1” and start subchannel index (or start RB index) “0” may transmit a PSFCH having index (n1+n2+1).

In addition, the mapping principles of FIGS. 13B and 13C may be applied to FIG. 21B as follows. If the mapping principle of FIG. 13B is applied to FIG. 21B, the UE having received the PSCCH or the PSSCH through unicast communication in slot index “0” and start subchannel index (or start RB index) ‘0” may transmit a PSFCH having index n1 (i.e., offset of n1). Furthermore, the UE having received the PSCCH or the PSSCH through unicast communication in slot index “0” and start subchannel index (or start RB index) “1” may transmit a PSFCH having index (n1+1). Similarly, if the mapping principle of FIG. 13C is applied to FIG. 21B, the UE having received the PSCCH or the PSSCH through unicast communication in slot index “0” and start subchannel index (or start RB index) “0” may transmit a PSFCH having index n1 (i.e., offset of n1). This may be the same as the case where the above-described mapping principle of FIG. 13B is applied. However, if the mapping of FIG. 13C is applied, the UE having received the PSCCH or the PSSCH through unicast communication in slot index “1” and start subchannel index (or start RB index) “0” may transmit a PSFCH having index(n1+1).

The above-described offset value may be included in SL resource pool configuration information.

The configuration of the PSFCH transmission frequency resource used for groupcast communication HARQ feedback transmission option 1 may be the same as the configuration of PSFCH transmission frequency resource used for the above-described unicast communication HARQ feedback transmission. In other words, the configuration of PSFCH transmission frequency resource used for groupcast communication HARQ feedback transmission option 1 may be determined by the slot index of the PSCCH or the PSSCH received by two or more reception UEs and the start subchannel index (or start RB index) of the PSCCH or the PSSCH. More specifically, if the mapping principle of FIG. 13B is applied to FIG. 21A, the UE having received the PSCCH or the PSSCH through groupcast communication option 1 in slot index “0” and start subchannel index (or start RB index) “0” may transmit a PSFCH having index n1 (i.e., offset of n1). The UE having received the PSCCH or the PSSCH through groupcast communication option 1 in slot index “0” and start subchannel index (or start RB index) “1” may transmit a PSFCH having index (n1+1). Similarly, if the mapping principle of FIG. 13C is applied to FIG. 21A, the UE having received the PSCCH or the PSSCH through groupcast communication option 1 in slot index “0” and start subchannel index (or start RB index) “0” may transmit a PSFCH having index n1 (i.e., offset of n1). This may be the same as the case where the above-described mapping principle of FIG. 13B is applied. However, if the mapping of FIG. 13C is applied, the UE having received the PSCCH or the PSSCH through groupcast communication option 1 in slot index “1” and start subchannel index (or start RB index) “0” may transmit a PSFCH having index (n1+1).

In addition, the mapping principles of FIGS. 13B and 13C may be applied to FIG. 21B as follows. If the mapping principle of FIG. 13B is applied to FIG. 21B, the UE having received the PSCCH or the PSSCH through groupcast communication option 1 in slot index “0” and start subchannel index (or start RB index) “0” may transmit a PSFCH having index 0 (i.e., offset of 0). The UE having received the PSCCH or the PSSCH through groupcast communication option 1 in slot index “0” and start subchannel index (or start RB index) “1” may transmit a PSFCH having index 1. Similarly, if the mapping principle of FIG. 13C is applied to FIG. 21B, the UE having received the PSCCH or the PSSCH through groupcast communication option 1 in slot index “0” and start subchannel index (or start RB index) “0” may transmit a PSFCH having index 0 (i.e., offset of 0). This may be the same as the case where the above-described mapping principle of FIG. 13B is applied. However, if the mapping of FIG. 13C is applied, the UE having received the PSCCH or the PSSCH through groupcast communication option 1 in slot index “1” and start subchannel index (or start RB index) “0” may transmit a PSFCH having index 1.

Meanwhile, the configuration of the PSFCH transmission frequency resource used for groupcast communication HARQ feedback transmission option 2 may be different from the configuration of PSFCH transmission frequency resource used for the above-described unicast communication HARQ feedback transmission or groupcast communication HARQ feedback transmission option 1. This is why in groupcast communication HARQ feedback transmission option 2, the reception UEs in the group having received the PSCCH and the PSSCH from the transmission UE need to independently transmit the PSFCH to the transmission UE by using different time/frequency/code resources. Accordingly, the number of PSFCH resources needs to be increased in proportion to the number of the reception UEs (i.e., PSFCH transmission UE) in the group. To this end, a method for transmitting different PSFCH time/frequency/code resources between different reception UEs in the group performing groupcast communication may be needed. As the method, one of the methods described in FIGS. 13A and 13D may be used.

For example, in FIG. 21A, the UEs having received the PSCCH or the PSSCH through groupcast communication option 2 in slot index “0” and start subchannel index (or start RB index) “0” may transmit a PSFCH starting from index 0 (i.e., starts the PSFCH from the offset of 0). In this case, the number of reception UEs in the group performing the groupcast communication may be assumed to be G0. As described with reference to FIG. 13D, each reception UE may receive, from the higher layer, the number of group members participating in the groupcast communication (G0 reception UEs+one transmission UE=G0+1) and its own group ID. Accordingly, each reception UE may identify that G0 independent PSFCH frequency resources are needed in the PSFCH frequency resource set starting from index 0. Each reception UE may identify the PSFCH resource which can be used by the reception UE from the PSFCH starting from index 0 through its group ID (e.g., the modulo operation described in FIG. 13D). If the mapping principle of FIG. 13B is applied to FIG. 21A, the UEs having received the PSCCH or the PSSCH through groupcast communication option 2 in slot index “0” and start subchannel index (or start RB index) “1” may transmit a PSFCH starting from PSFCH index 1. Each reception UE may receive, from the higher layer, the number of group members participating in the groupcast communication (G1 reception UEs+one transmission UE=G1+1) and its own group ID. Accordingly, each reception UE may identify that G1 independent PSFCH frequency resources are needed in the PSFCH frequency resource set starting from index 1. Each reception UE may identify the PSFCH resource which can be used by the reception UE from the PSFCH starting from index 0 through its group ID (e.g., the modulo operation described in FIGS. 13D, 20A, and 20B).

In addition, if the mapping principle of FIG. 13C is applied to FIG. 21A, the UEs having received the PSCCH or the PSSCH through groupcast communication option 2 in slot index “1” and start subchannel index (or start RB index) “0” may transmit the PSFCH starting from PSFCH index 1. Each reception UE may receive, from the higher layer, the number of group members participating in the groupcast communication (G1 reception UEs+one transmission UE=G1+1) and its own group ID. Accordingly, each reception UE may identify that G1 independent PSFCH frequency resources are needed in the PSFCH frequency resource set starting from index 1. Each reception UE may identify the PSFCH resource which can be used by the reception UE from the PSFCH starting from index 0 through its group ID (e.g., the modulo operation described in FIGS. 13D, 20A, and 20B).

Similarly, in FIG. 21B, the UEs having received the PSCCH or the PSSCH through groupcast communication option 2 in slot index “0” and start subchannel index (or start RB index) “0” may transmit PSFCH starting from index n1 (i.e., starts the PSFCH from the offset of n1). In this case, the number of reception UEs in the group performing the groupcast communication may be assumed to be G0. As described with reference to FIG. 13D, each reception UE may receive, from the higher layer, the number of group members participating in the groupcast communication (G0 reception UEs+one transmission UE=G0+1) and its own group ID. Accordingly, each reception UE may identify that G0 independent PSFCH frequency resources are needed in the PSFCH frequency resource set starting from index n1. Each reception UE may identify the PSFCH resource which can be used by the reception UE from the PSFCH starting from index n1 through its group ID (e.g., the modulo operation described in FIGS. 13D, 20A, and 20B). If the mapping principle of FIG. 13B is applied to FIG. 21B, the UEs having received the PSCCH or the PSSCH through groupcast communication option 2 in slot index “0” and start subchannel index (or start RB index) “1” may transmit a PSFCH starting from PSFCH index n1+1. Each reception UE may receive, from the higher layer, the number of group members participating in the groupcast communication (G1 reception UEs+one transmission UE=G1+1) and its own group ID. Accordingly, each reception UE may identify that G1 independent PSFCH frequency resources are needed in the PSFCH frequency resource set starting from index n1+1. Each reception UE may identify the PSFCH resource which can be used by the reception UE from the PSFCH starting from index 0 through its group ID (e.g., the modulo operation described in FIGS. 13D, 20A, and 20B). Meanwhile, if the mapping principle of FIG. 13C is applied to FIG. 21A, the UEs having received the PSCCH or the PSSCH through groupcast communication option 2 in slot index “1” and start subchannel index (or start RB index) “0” may transmit a PSFCH starting from PSFCH index n1+1. Each reception UE may receive, from the higher layer, the number of group members participating in the groupcast communication (G1 reception UEs+one transmission UE=G1+1) and its own group ID. Accordingly, each reception UE may identify that G1 independent PSFCH frequency resources are needed in the PSFCH frequency resource set starting from index n1+1. Each reception UE may identify the PSFCH resource which can be used the reception UE from the PSFCH starting from index n1+1 through its group ID (e.g., the modulo operation described in FIGS. 13D, 20A, and 20B).

Meanwhile, it has been mainly exemplified that the above-described method for determining the start index of PSFCH for unicast, groupcast HARQ option 1, and groupcast HARQ option 2 operation is associated with the slot index where the PSSCH is received and/or the subchannel index (or RB index) where PSSCH is received (or associated with the slot index where PSCCH is received and/or the subchannel index (or RB index) where the PSCCH is received). However, in addition to this, as described in FIG. 13D, the source ID and the destination ID may be utilized. For example, the start point of the PSFCH frequency resource set shown in FIGS. 21A and 21B may be found through the source ID, and the index of the PSFCH frequency resource used for PSFCH transmission by each reception UE may be determined in the corresponding PSFCH frequency resource set through the correlation between the PSSCH and the PSFCH in each PSFCH frequency resource set.

The above-described embodiments of FIGS. 21A and 21B may be used simultaneously with the embodiments of FIGS. 20A and 20B. For example, it has been described in FIGS. 20A and 20B that the slot index of the PSSCH and the start index of the subchannel (or the index of the start subchannel) and the start index of the frequency and/or code resource of the PSFCH are associated, or the slot index of the PSSCH and the start index of the subchannel (or the index of the start subchannel) and the start index of the candidate frequency and/or code resource set of the PSFCH are associated. In this case, when the above-described correlation between the PSSCH resource and the PSFCH resource is defined, the mapping relationship may be defined so that the PSFCH resource (or the resource of the candidate PSFCH set) is mapped to the part remaining after excluding the unused resource shown in FIGS. 21A and 21B.

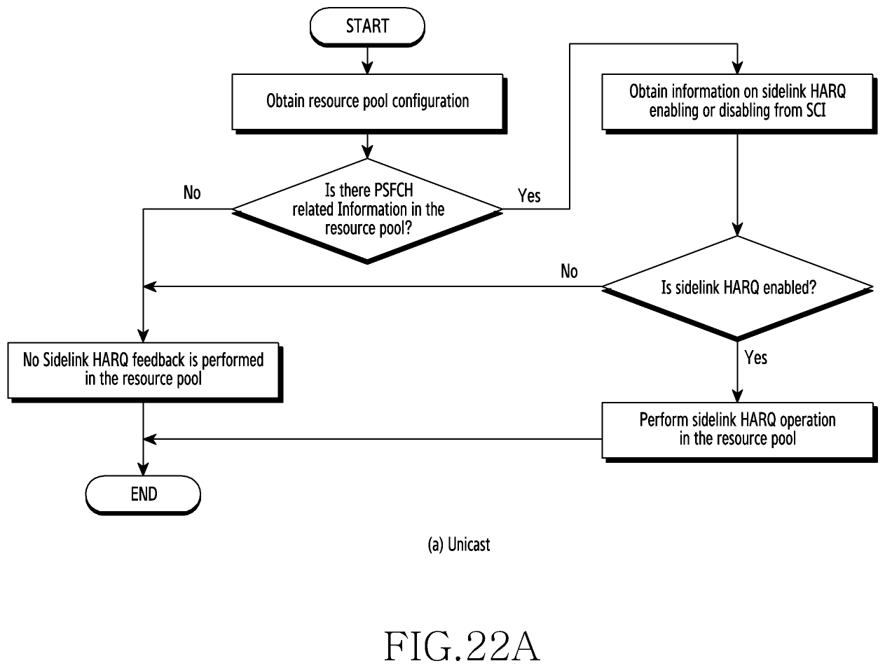

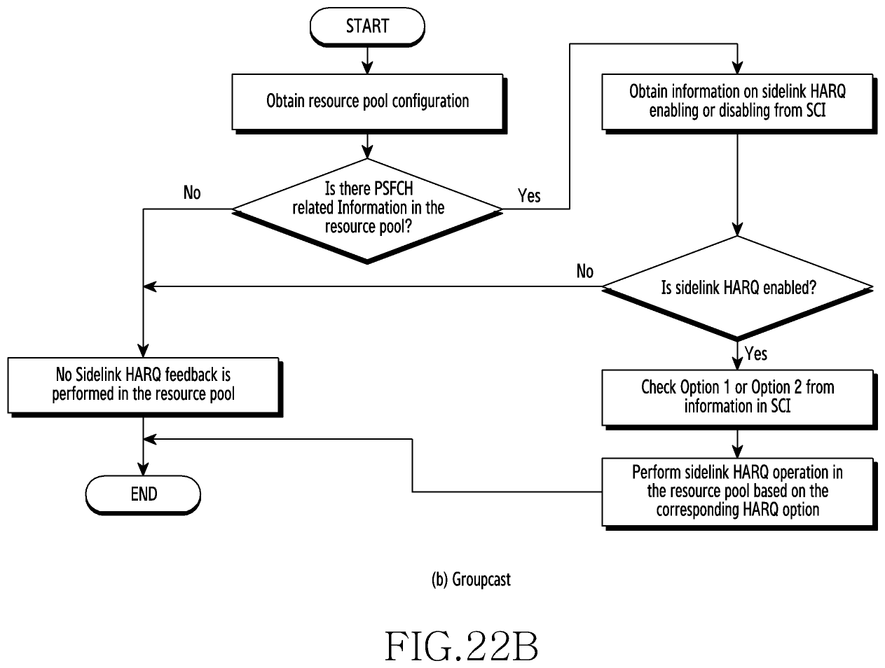

FIG. 22A is a flowchart illustrating an operation of a reception UE for SL HARQ feedback transmission, according to an embodiment. FIG. 22B is a flowchart illustrating an operation of a reception UE for SL HARQ feedback transmission, according to an embodiment.

As described in FIGS. 21A and 21B, UEs may coexist which use unicast, groupcast (including option 1 and option 2), and broadcast communication in the same resource pool. In this case, HARQ feedback may not be operated in broadcast communication. As described in FIG. 4, whether to operate HARQ feedback may be activated or inactivated in unicast and groupcast communication. In other words, as described above, whether to operate HARQ feedback may be determined depending on the cast scheme (unicast, groupcast, or broadcast), and in a specific cast scheme (groupcast), various HARQ feedback operation methods (option 1 and option 2) may exist. In addition, in some cast schemes (unicast or groupcast), whether to operate HARQ feedback may be activated/inactivated. Therefore, when unicast, groupcast, and broadcast communication share the same resource pool (i.e., when UEs for performing unicast, groupcast, and broadcast coexist in one resource pool), a design may be needed for a signaling scheme to support activation/inactivation as to whether to operate HARQ and the above-described HARQ feedback operation method. To this end, at least one of the following may be considered.

1) Whether to activate/inactivate SL HARQ operation may be explicitly or implicitly included in the resource pool information configured through RRC information or system information by the base station. In the out-of-coverage environment where no base station is present, whether to activate/inactivate SL HARQ operation may be explicitly or implicitly included in the resource pool information configured in advance. Explicitly configuring or pre-configuring whether to activate/inactivate SL HARQ operation may mean one of a case where whether to activate/inactivate SL HARQ operation is explicitly included in the resource pool information configuration information through one bit, a case where it is explicitly included through “Enable/Disable”, or a case where it is explicitly included through “ON/OFF”. In contrast, implicitly configuring or pre-configuring whether to activate/inactivate SL HARQ operation may mean activating SL HARQ operation if the resource pool configuration information includes parameters regarding SL HARQ operation and inactivating SL HARQ operation unless the resource pool configuration information includes parameters regarding HARQ operation. Accordingly, the V2X transmission UE and reception UEs having received resource pool configuration information may determine whether to activate/inactivate SL HARQ operation in the corresponding resource pool.

Meanwhile, as described in FIG. 2, broadcast communication may mean that the V2X transmission UE broadcasts SL control information and data information to multiple unspecified UEs present around the V2X transmission UE. Accordingly, since the V2X transmission UE and V2X reception UEs performing broadcast communication are unaware of their mutual presence, it may be impossible to operate SL HARQ feedback. In this case, in a case where the V2X UEs for performing broadcast communication share a resource pool with V2X UEs for performing unicast or groupcast communication, if 1) described above is used, understanding of whether to operate SL HARQ operation may differ between the transmission UE and the reception UE.

For example, although the transmission UE transmits SL data through broadcast communication, the reception UE may transmit HARQ feedback to the transmission UE based on the activation configuration information of HARQ operation included in the resource pool configuration information. The transmission UE does not expect feedback from the reception UE because the transmission UE has used broadcast communication, the transmission UE may not receive HARQ feedback transmitted by the reception UE. Due to the different understandings between the transmission UE and the reception UE, the reception UE may unnecessarily transmit the PSFCH, which may increase power consumption and cause the half-duplexing problems. In this case, for UEs which are incapable of simultaneously performing SL transmission and reception (e.g., UEs in which SL transmission RF chain and SL reception RF chain are not separated), the half-duplexing problems may cause the reception UE to fail to receive the PSFCH from another UE in the corresponding resource pool due to unnecessary PSFCH transmission as described above.

The above-described problem is described below in detail. The cast type (unicast, groupcast, or broadcast) may be determined by the application layer, and HARQ operation may be performed by the physical layer and MAC layer. Accordingly, when the data generated by the application layer of the transmission UE is broadcast communication, the physical layer and the MAC layer of the transmission UE may determine not to perform HARQ operation. Therefore, as in 1), although HARQ operation activation information is explicitly or implicitly included in the resource pool information received by the transmission UE, the transmission UE may disregard the same. However, the UE having received broadcast data from the transmission UE is unaware of the cast type before receiving the corresponding broadcast data by the application layer of the reception UE, and thus the physical layer and the MAC layer may not identify whether the corresponding data is broadcast-type data. Accordingly, the reception UE using 1) may transmit HARQ feedback to the transmission UE based on the HARQ operation activation information configured in the resource pool.

Therefore, to address the above-described problems, the following method for the physical layer and the MAC layer of the reception UE to recognize whether HARQ operation is activated may be needed.

2) As shown in FIG. 22A, the transmission UE and the reception UE which are to perform unicast communication may obtain activation information of SL HARQ operation through resource pool configuration information. In this case, when the SL HARQ operation activation information is explicitly or implicitly configured in the resource pool information for SL transmission, the transmission UE may transmit a 1-bit indicator indicating whether HARQ operation is activated in the SCI to the reception UE. For example, “0” may mean deactivating SL HARQ operation, and “1” may mean activating SL HARQ operation. The reception UE may transmit HARQ feedback to the transmission UE only when activation of SL HARQ operation is explicitly or implicitly configured in the resource pool information for SL reception while the 1-bit indicator in the SCI transmitted by the transmission UE simultaneously indicates activation of SL HARQ operation. Although activation of SL HARQ operation is explicitly or implicitly configured in the resource pool information for SL reception, if the one-bit indicator of the SCI transmitted by the transmission UE indicates inactivation of HARQ operation, the HARQ feedback may not be transmitted to the transmission UE.

In 2) described above, such a case may occur where inactivation of HARQ operation may be configured in the resource pool configuration information and the transmission UE indicates activation of HARQ operation through the 1-bit indicator of the SCI. This may mean that the resource pool does not have PSFCH resources for HARQ operation, and thus the reception UE prioritizes resource pool configuration information and may not transmit HARQ feedback to the transmission UE. In other words, the reception UE may disregard activation of HARQ operation indicated by the 1-bit indicator of the SCI transmitted by the transmission UE.

Meanwhile, in groupcast communication, the transmission UE and the reception UEs may need a common agreement on whether to use option 1 or option 2. To this end, the following may be considered.

3) The resource pool configuration information provided through system and RRC signaling by the base station or pre-configured resource pool configuration information may include HARQ operation information (option 1 or option 2). The UEs for performing transmission and reception in groupcast communication in the corresponding resource pool may operate either option 1 or option 2 based on the HARQ operation information configured in the resource pool.

However, a method for the reception UE to identify whether to use option 1 or option 2 in groupcast communication may need to be considered. More specifically, whether to use option 1 and option 2 may be determined by the application layer (or a V2X layer between the application layer and the AS layer, and hereinafter, the application layer is interchangeably used with the V2X layer), and the physical layer and the MAC layer of the transmission UE may receive whether to use option 1 or option 2 from its application layer. For example, the application layer may transfer the number of group members of the groupcast communication involved by the transmission UE and group ID information that can be used by the transmission UE to the physical layer through the MAC layer. Upon failing to receive the above-described information from the application layer, the MAC layer and the physical layer of the transmission UE are unaware of information about the group (i.e., the number of group members and the group ID) and may thus be required to operate option 1. Meanwhile, the MAC layer and the physical layer of the transmission UE having received the above-described group-related information may operate option 2. In this case, although the above-described information is provided from the application layer, the MAC layer and the physical layer of the transmission UE may operate option 1 according to a condition. For example, when the number of group members is equal to or greater than a specific value configured (or pre-configured) via RRC or system information by the base station, the MAC layer and the physical layer of the transmission UE may operate option 1. Alternatively, when the number of PSFCH resources is smaller than the number of group members, the MAC layer and the physical layer of the transmission UE may operate option 1.

Based on the above-described examples, whether to use option 1 or option 2 is determined by the application layer, and thus the physical layer and the MAC layer of the UE having received SL data from the transmission UE may be unable to know whether to use option 1 or option 2. Accordingly, similar to whether to activate or inactivate HARQ operation described above, 3) may not be proper. A method for solving the problems may be needed, and 4) below may be considered.

4) As shown in FIG. 22B, the transmission UE and the reception UE which are to perform groupcast communication may obtain activation information of SL HARQ operation through resource pool configuration information. In this case, like operations in the above-described unicast communication, the transmission UE may transmit SL HARQ feedback activation information to the reception UE through the SCI. Furthermore, the transmission UE may transmit a 1-bit indicator for SL HARQ operation information to the reception UE as follows. For example, “0” may mean use of option 1, and “1” may mean use of option 2. The reception UE may transmit HARQ feedback to the transmission UE through the PSFCH by using the method of option 1 or option 2 according to the 1-bit indicator in the SCI transmitted from the transmission UE. In other words, according to the above-described example, when SL HARQ operation is explicitly or implicitly activated in the resource pool configuration information, 1-bit information meaning activation or inactivation of HARQ operation through the SCI may be transmitted, and when HARQ operation is activated through the SCI, a 1-bit indicator for HARQ operation information may further be transmitted to the reception UE (i.e., whether HARQ is activated and use of HARQ feedback option 1 or use of option 2 may be indicated through two bits). For example, HARQ activation may be explicitly or implicitly configured in the resource pool configuration information, and the transmission UE which is to perform groupcast communication in the corresponding resource pool may indicate the following to the reception UE by using the 2 bits of the indicator of the SCI. For example, “00” may mean that the reception UE is not to transmit HARQ feedback. “01” may mean that the reception UE is to transmit HARQ feedback through the method of groupcast option 1, and “10” may mean that the reception UE is to transmit HARQ feedback through the method of groupcast option 2.

As described above, the physical layer and MAC layer may not identify unicast, groupcast, and broadcast communication. Accordingly, the number of bits constituting the SCI needs to be maintained the same to reduce UE SCI decoding complexity regardless of unicast, groupcast, and broadcast communication. Accordingly, the transmission UE for transmitting SL control information and data information by using the above-described broadcast communication may configure “00” in the SCI to prevent the reception UE from transmitting HARQ feedback through the PSFCH in the resource pool where HARQ operation is activated. The physical layer and the MAC layer of the UE having received the same may not transmit PSFCH according to “00” indicator of the SCI even without identifying the cast type. Similarly, the transmission UE for transmitting SL control information and data information using unicast or groupcast communication may configure “00” in the SCI to prevent the reception UE from transmitting HARQ feedback through the PSFCH in the resource pool where HARQ operation is activated. The physical layer and the MAC layer of the UE having received the same may not transmit the PSFCH according to “00” indicator of the SCI even without identifying the cast type.

Meanwhile, it is assumed in the above-described groupcast communication examples that each of the activation and inactivation information of SL HARQ operation and the SL HARQ operation information (option 1 or option 2) is transmitted through an independent 1-bit indicator to the SCI. In other words, a 2-bit indicator may be needed in the SCI to transmit the two pieces of information. In addition, as described above, since the physical layer and the MAC layer of the reception end cannot identify the cast type, the 2-bit information may be required to be included in the SCI regardless of the cast type to reduce the SCI decoding complexity at the reception end. This may increase the number of bits transmitted to the SCI, and thus increasing signaling overhead and channel coding rate, thereby deteriorating SCI coverage capability. Accordingly, a method for solving these problems is needed, and at least one of the following methods may be considered.

1) Since inactivation of HARQ operation in the resource pool configuration information means that no PSFCH resource is configured in the SL HARQ operation, it may mean that all of the HARQ operation in unicast communication, HARQ option 1 operation in groupcast communication, HARQ option 2 operation in groupcast communication, and HARQ operation in broadcast communication are impossible.

2) When HARQ operation is activated in the resource pool configuration information, it may mean that PSFCH resources for SL HARQ operation have been configured. Accordingly, the transmission UE may indicate whether to operate HARQ to the reception UE through one bit of the SCI. More specifically, although HARQ operation is activated in the resource pool configuration information, the transmission UEs for performing unicast, groupcast, and broadcast communication may set the one-bit indicator of the SCI to “0” and transmit the same to the reception UE to inactivate HARQ operation. The reception UEs having received the same may not transmit HARQ feedback to the transmission UE although HARQ operation is activated in the resource pool configuration information. Meanwhile, when SL HARQ operation is activated in the resource pool configuration information and the transmission UE is to operate HARQ in unicast communication or operate HARQ through option 1 or option 2 in groupcast communication, the transmission UE may set the 1-bit indicator of SCI to “1” and transmit the same to the reception UE. As described above, since the physical layer and the MAC layer of the reception UE cannot identify the cast type, if the 1-bit indicator of SCI is set to “1”, the physical layer and the MAC layer of the reception UE may not be able to determine whether it means HARQ feedback operation in unicast or HARQ feedback operation in groupcast.

This may be determined by the reception UE through the source ID and/or the destination ID included in the SCI. For example, when the source ID and/or the destination ID is separated into two sets, and the source ID and/or the destination ID corresponding to set 1 is detected, the physical layer and the MAC layer of the reception UE may identify that it means unicast communication from the corresponding ID. In addition, when the source ID and/or the destination ID corresponding to set 2 is detected, the physical layer and the MAC layer of the reception UE may identify that it means groupcast communication from the corresponding ID. There may be various methods for configuring set 1 and set 2 described above. For example, the transmission UE may set the indicator to “1” and transmit the source ID including eight bits and the destination ID including 16 bits to the reception UE through the SCI. In this case, when an even-numbered source ID and/or destination ID is detected, the physical layer of the reception UE may determine that it is unicast communication. When an odd-numbered source ID and/or destination ID is detected, the physical layer of the reception UE may determine that it is groupcast communication. As another example, the 8-bit source ID and the 16-bit destination ID are converted into decimal numbers, and when the source ID and/or the destination ID is equal to or greater than a specific threshold (or is greater than the threshold), the physical layer of the reception UE may determine that it is unicast communication.

The reception UE having identified groupcast communication by the above-described methods needs to further identify whether it means HARQ option 1 or HARQ option 2 in groupcast communication. This may be performed through the following method. For example, when the SCI includes information about the location of the transmission UE (e.g., including at least one of the zone ID or the latitude and the longitudes of the transmission UE) and range requirements, the physical layer of the reception UE may determine that it is to perform groupcast HARQ option 1. When the above-described information is not included in the SCI, the physical layer of the reception UE may determine to perform groupcast HARQ option 2.

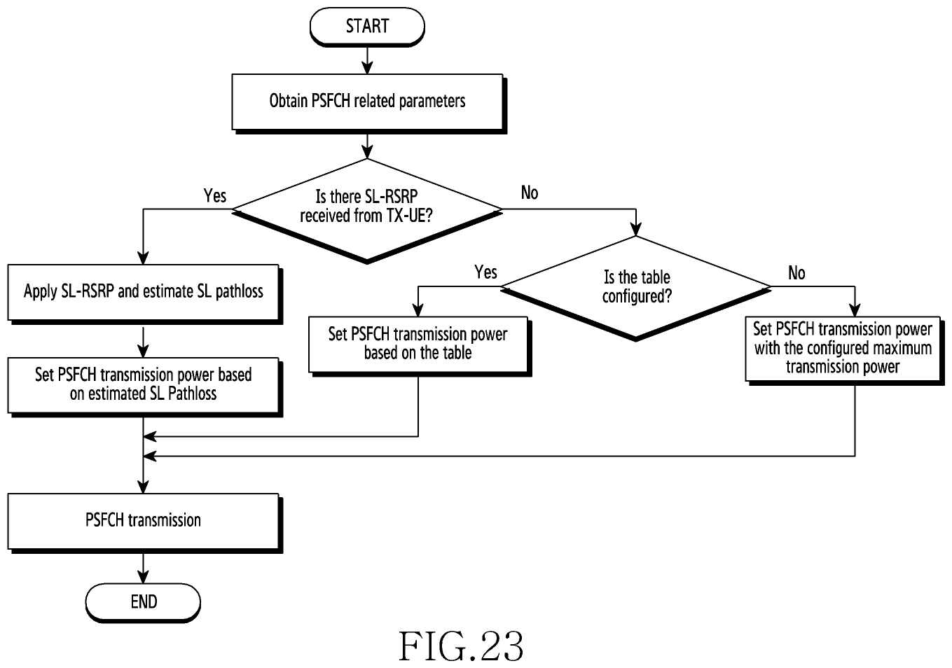

FIG. 23 is a diagram illustrating a transmission power control method of an SL feedback channel, according to an embodiment.

The V2X transmission UE may perform SL transmit power control for PSCCH and PSSCH transmission. For SL transmit power control, the V2X transmission UE may transmit an SL reference signal to the V2X reception UE, and the V2X reception UE having received the same may measure SL RSRP and report the same to the V2X transmission UE. In this case, the SL RSRP may be measured by the V2X reception UE through an SL CSI-RS or may be measured by the V2X reception UE by using a reference signal (e.g., a DMRS) transmitted through an SL control channel or data channel. The V2X transmission UE having received the SL RSRP from the V2X reception UE may estimate a pathloss value from the received SL RSRP and its transmission power and perform SL transmit power control by reflecting the same.

Similarly, when the V2X reception UE transmits the PSFCH to the V2X transmission UE, it may be required to perform SL transmit power control. The SL transmit power control for the PSFCH may be performed through at least one of the following methods.

Method 1) The V2X reception UE may transmit the PSFCH by using configured maximum transmission power. In this case, the configured maximum transmission power may be configured by the V2X reception UE based on the metric (e.g., distance information) configured from the higher layer or QoS received from the higher layer by the V2X reception UE.

Method 2) The V2X reception UE may configure the transmission power value of the PSFCH by using the DL pathloss value with the base station and the SL transmission power control parameters included in the PSFCH resource pool configuration information. In this case, the DL pathloss value with the base station may be estimated by the V2X reception UE through a secondary synchronization signal (SSS) transmitted by the base station through DL, or may be estimated by the V2X reception UE through a DMRS of a physical broadcast channel (PBCH) and an SSS. A signal through which the V2X reception UE needs to estimate DL pathloss may be included in the resource pool information transmitted to the V2X UE through RRC configuration or system information by the base station. When the V2X reception UE is out of the coverage of the base station and thus cannot use DL pathloss value for PSFCH transmission power control, the V2X reception UE may configure a PSFCH transmission power value by using only other transmission power control parameters without a DL pathloss value. As another example, PSFCH transmit power may be configured using method 2 when the V2X reception UE is in the coverage of the base station and using method 1 when the V2X reception UE is out of the coverage of the base station.

Method 3) The V2X transmission UE may notify the V2X reception UE of the transmission power value used for PSCCH or PSSCH transmission by the V2X transmission UE. In this case, the V2X transmission UE may transmit information about its transmission power value to the V2X reception UE through SL control information or a MAC CE. The V2X reception UE may measure the SL RSRP through the SL CSI-RS or SL DMRS transmitted from the V2X transmission UE through the PSCCH or the PSSCH and the transmission power value used for PSCCH or PSSCH transmission received from the V2X transmission UE and estimate the SL pathloss value by using the same. The V2X reception UE may configure the transmission power value of the PSFCH by using the SL pathloss value estimated by the V2X reception UE and the SL transmission power parameters included in the PSFCH resource pool configuration information.

Method 4) A mapping relationship may be configured between the SL RSRP value measured by the V2X reception UE and the PSFCH transmission power. The mapping relationship is exemplified in Table 2 below, and when the SL RSRP value measured by the V2X reception UE is −X1 dBm, the V2X reception UE may use Y1 dBm as the transmission power of the PSFCH. Table 2 below may be configured by the base station or may be configured in advance. There may be two or more mapping tables as in Table 2 below, by the power class or QoS (e.g., a minimum communication range) of the V2X UE. Table 2 below exemplifies that the SL RSRP and the PSFCH transmission power value have a one-to-one mapping relationship, but there may be a one-to-many mapping relationship. In other words, two or more SL RSRP values may be mapped to one PSFCH transmission power value. In Table 2 below, the SL RSRP values may have a difference of Z1 dB (i.e., the step size, granularity or resolution of the SL RSRP values is Z1 dB). Likewise, the PSFCH transmission power values may have a difference of Z2 dB (i.e., the step size, granularity or resolution of the PSFCH transmission power values is Z2 dB). In this case, Z1 and Z2 may be the same or different. <Table 2> below shows a mapping table between SL RSRP and PSFCH transmission power.

TABLE 2

| | |
|---|---|
| SL-RSRP | PSFCH transmission power value |

| | | | |
|---|---|---|---|
| −X₁ | dBm | Y₁ | dBm |

| | |
|---|---|
| . . . | . . . |

| | | | |
|---|---|---|---|
| −X_{N} | dBm | Y_{N} | dBm |

FIG. 23 illustrates an example of a PSFCH transmission power control method based on the above-described examples. More specifically, the V2X reception UE may obtain information about preconfigured PSFCH parameters from the base station or the V2X transmission UE. In this case, information about the PSFCH parameters may include at least one piece of the PSFCH-related information described in FIG. 4. Furthermore, the information about the PSFCH parameters may include information about the PSFCH transmission power as well as the above-described information. If the V2X reception UE has received SL RSRP from the V2X transmission UE (i.e., if the V2X reception UE possesses SL RSRP information measured by the V2X transmission UE), the V2X reception UE may estimate the SL pathloss. The V2X reception UE may configure PSFCH transmission power by using at least one piece of information about the obtained PSFCH parameters and the estimated pathloss value. The V2X reception UE may transmit the PSFCH to the V2X transmission UE by using the PSFCH transmission power value configured by the V2X reception UE.

If the V2X reception UE has not received SL RSRP from the V2X transmission UE (i.e., if the V2X reception UE does not possess SL RSRP information measured by the V2X transmission UE), the V2X reception UE may determine whether the mapping table of the SL RSRP value and the PSFCH transmission power value is configured as exemplified in Table 2. The V2X reception UE, configured with a table as shown in Table 2, may select the PSFCH transmission power value mapped to the SL RSRP value measured by the V2X reception UE, configure the PSFCH transmission power value, and transmit the PSFCH to the V2X transmission UE (method 4).

If the V2X reception UE fails to be configured with a table such as Table 2, the V2X reception UE may configure the PSFCH transmission power value through methods 1 and 2 described above and transmit the PSFCH to the V2X transmission UE.

As another example of FIG. 23, the V2X reception UE which has determined whether there is SL RSRP information may configure, if there is no SL RSRP information, the PSFCH transmit power value through methods 1 and 2 described above, without determining whether a table such as Table 2 is configured, and transmit the PSFCH to the V2X transmission UE.

As another example of FIG. 23, the V2X reception UE may determine whether a table as in Table 2 is configured immediately without determining whether there is SL RSRP information. When a table as shown in Table 2 is configured, the V2X reception UE may select the PSFCH transmission power value mapped to the SL RSRP value measured by the V2X reception UE, configure the PSFCH transmission power value, and transmit the PSFCH to the V2X transmission UE (method 4). If the V2X reception UE fails to be configured with a table such as Table 2, the V2X reception UE may configure the PSFCH transmission power value through methods 1 and 2 described above and transmit the PSFCH to the V2X transmission UE.

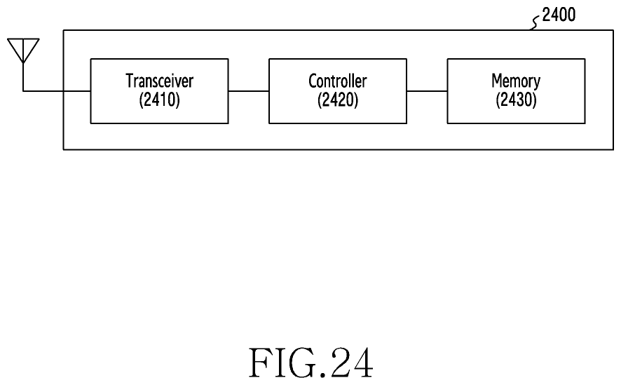

FIG. 24 is a block diagram illustrating an internal structure of a transmission UE, according to an embodiment.

Referring to FIG. 24, a transmission UE 2400 of the disclosure may include a transceiver 2410, a controller 2420, and a memory 2430. The memory 2430 may also be referred to as a storage unit 2430. However, the elements of the transmission UE 2400 are not limited thereto. For example, the transmission UE 2400 may include more or fewer elements than the above-described elements. In addition, the transceiver 2410, the controller 2420, and the memory 2430 may be implemented in the form of a single chip.

The transceiver 2410 may transmit or receive signals to and from a base station or another UE. The above-described signals may include a synchronization signal, a reference signal, control information, and data. To this end, the transceiver 2410 may include an RF transmitter for up-converting and amplifying the frequency of a transmitted signal, an RF receiver for low-noise amplifying a received signal and down-converting the frequency of the received signal., and the like. In addition, the transceiver 2410 may receive a signal via a radio channel, output the signal to the controller 2420, and transmit the signal output from the controller 2420 via a radio channel.

The memory 2430 may store a program and data necessary to operate the transmission UE 2400. In addition, the memory 2430 may store control information or data that is included in the signal transmitted or received by the transmission UE 2400. The memory 2430 may include a storage medium, such as ROM, RAM, hard disks, CD-ROMs, and DVDs, or a combination of storage media. Furthermore, the memory 2430 may include multiple memories.

The controller 2420 may control a series of operations to allow the transmission UE 2400 to operate as described above. The controller 2420 may include at least one processor. The controller 2420 may include multiple processors and execute the program stored in the memory 2430 to control the feedback channel resource allocation method described herein and transmission and reception of the SL feedback channel transmitted between UEs.

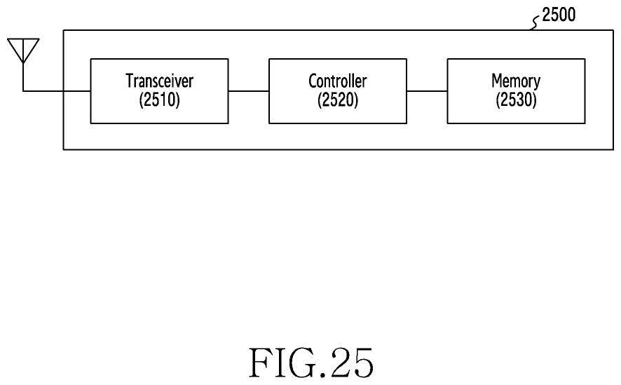

FIG. 25 is a block diagram illustrating an internal structure of a reception UE, according to an embodiment.

Referring to FIG. 25, a reception UE 2500 of the disclosure may include a transceiver 2510, a controller 2520, and a memory 2530. However, the elements of the reception UE 2500 are not limited thereto. For example, the reception UE 2520 may include more or fewer elements than the above-described elements. In addition, the transceiver 2510, the controller 2520, and the memory 2530 may be implemented in the form of a single chip.

The transceiver 2510 may transmit or receive signals to and from a base station or another UE. The above-described signals may include a synchronization signal, a reference signal, control information, and data. To this end, the transceiver 2510 may include an RF transmitter for up-converting the frequency and amplifying a transmitted signal, an RF receiver for low-noise amplifying a received signal and down-converting the frequency of the received signal, and the like. In addition, the transceiver 2510 may receive a signal via a radio channel, output the signal to the controller 2520, and transmit the signal output from the controller 2520 via a radio channel.

The memory 2530 may store a program and data necessary to operate the transmission UE 2500. In addition, the memory 2530 may store control information or data that is included in the signal transmitted or received by the reception UE 2500. The memory 2530 may include a storage medium, such as ROM, RAM, hard disks, CD-ROMs, and DVDs, or a combination of storage media. Furthermore, the storage 2530 may include multiple memories.

The controller 2520 may control a series of operations to allow the reception UE 2500 to operate as described above. The controller 2520 may include at least one processor. The controller 2520 may include multiple processors and execute the program stored in the memory 2530 to control the feedback channel resource allocation method and transmission and reception of the SL feedback channel transmitted between UEs.

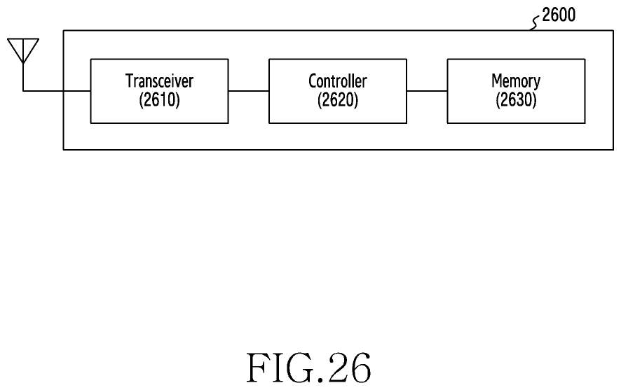

FIG. 26 is a block diagram illustrating an internal structure of a base station, according to an embodiment.

Referring to FIG. 26, a base station 2600 of the disclosure may include a transceiver 2610, a controller 2620, and a memory 2630. However, the elements of the base station 2600 are not limited thereto. For example, the base station 2600 may include more or fewer elements than the above-described elements. In addition, the transceiver 2610, the controller 2620, and the memory 2630 may be implemented in the form of a single chip.

The transceiver 2610 may transmit or receive signals to and from a base station or another UE. The above-described signals may include a synchronization signal, a reference signal, control information, and data. To this end, the transceiver 2610 may include an RF transmitter for up-converting and amplifying the frequency of a transmitted signal, an RF receiver for low-noise amplifying a received signal and down-converting the frequency of the received signal, and the like. In addition, the transceiver 2610 may receive a signal via a radio channel, output the signal to the controller 2620, and transmit the signal output from the controller 2620 via a radio channel.

The memory 2630 may store a program and data necessary to operate the base station 2600. In addition, the memory 2630 may store control information or data that is included in the signal transmitted or received by the base station 2600. The memory 2630 may include a storage medium, such as ROM, RAM, hard disks, CD-ROMs, and DVDs, or a combination of storage media. Furthermore, the storage 2630 may include multiple memories.

The controller 2620 may control a series of processes for enabling the UE to operate as described above. The controller 2620 may include at least one processor. The controller 2620 may include multiple processors and execute the program stored in the memory 2630 to control the feedback channel resource allocation method and transmission and reception of the SL feedback channel transmitted between UEs.

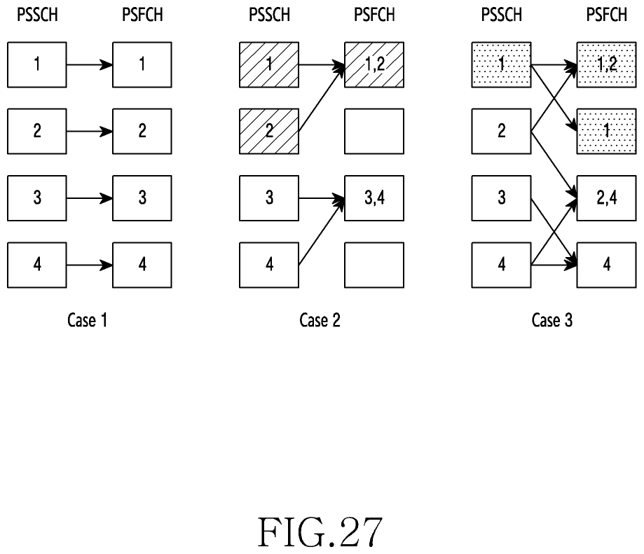

FIG. 27 is a diagram illustrating a V2X communication method, according to an embodiment.

FIG. 27 illustrates a situation in which a UE performs SL communication using one or more carriers (or BWPs). When the UE needs to receive PSSCHs and transmit PSFCHs including HARQ-ACK information of the corresponding PSSCHs in multiple carriers, one of or a combination of the methods illustrated with reference to FIG. 27 may be possible. In the description below, the carrier may be substituted by a BWP and applied. When the carrier is substituted by the BWP, there may be a case where UEs transmit or receive multiple BWPs in one carrier via SL. In addition, a situation wherein the multiple carriers or multiple BWPs for each carrier are present is also possible, and the disclosure does not limit the same.

Case 1 is a case where a PSSCH and a PSFCH is performed in the same carrier. That is, when the PSSCH is received in carrier 1, the PSFCH including HARQ-ACK information of the PSSCH is performed in carrier 1. When the PSSCH is received in carrier 2, the PSFCH including the HARQ-ACK information of the PSSCH is performed in carrier 2. When the PSSCH is received in carrier 3, the PSFCH including the HARQ-ACK information of the PSSCH is performed in carrier 3. When the PSSCH is received in carrier 4, the PSFCH including the HARQ-ACK information of the PSSCH is performed in carrier 4. Accordingly, when the PSSCHs are simultaneously received for each carrier in a case where four carriers are configured as in FIG. 27, a situation where the PSFCHs of the respective PSSCHs are simultaneously transmitted in specific slots may occur. According to a UE capability, all the scheduled PSFCHs can be transmitted, and only some of the PSFCHs can be transmitted. When some of the PSFCHs are transmitted, the UE may select some PSFCHs which can be transmitted by using the method of making selection in an ascending order of a carrier index or based on priority information of the PSFCHs, etc. A situation where only some of the PSFCHS are transmitted may be possible when a maximum number of transmitted PSFCHs are determined for each carrier or UE according to the UE capability. Alternatively, when a sum of transmission powers of the scheduled PSFCHs exceeds the maximum transmission power of the UE, transmitting only some of the PSFCHs may be possible because the UE cannot transmit all the scheduled PSFCHs.

Case 2 shows a situation where a carrier in which a PSSCH is transmitted or received is identical to or different from a case where a PSFCH including HARQ-ACK information of the PSSCH is transmitted or received. For example, a case where the HARQ-ACK information of the PSSCH transmitted or received in carrier 1 is transmitted or received in carrier 1 is shown. A case where the HARQ-ACK information of the PSSCH transmitted or received in carrier 2 is transmitted or received in carrier 1 is shown. A case where case where the HARQ-ACK information of the PSSCH transmitted or received in carrier 3 is transmitted or received in carrier 3 is shown. A case where the HARQ-ACK information of the PSSCH transmitted or received in carrier 4 is transmitted or received in carrier 3 is shown. Accordingly, the PSFCHs transmitted or received in a specific carrier may include HARQ-ACK information of the PSSCHs transmitted or received in multiple carriers. When the UE transmits the HARQ-ACK information for the multiple PSSCHs to the PSFCH, the UEs having transmitted the corresponding PSSCHs may be different from each other, and thus the PSFCHs may be separately transmitted through independent physical channel resources, respectively, without multiplexing the HARQ-ACK information. In this case, the PSFCHs include 1-bit HARQ-ACK information. When the UEs having transmitted the corresponding PSSCHs are identical to each other, the UEs may multiplex the HARQ-ACK information and transmit the same through one PSFCH. In this case, the PSFCH may include HARQ-ACK information having two or more bits. In Case 2, a carrier in which a PSSCH is transmitted or received and a carrier in which a PSFCH including HARQ-ACK information of the PSSCH are determined through a higher-layer signal in advance. Accordingly, transmission or reception of the PSFCH for the PSSCH transmitted or received in specific carrier i may be performed in specific carrier i or j, which is determined by higher-layer signal information in advance.

In case 3, a carrier in which a PSSCH is transmitted or received and a carrier in which a PSFCH including HARQ-ACK information of the PSSCH is transmitted or received may be identical to or different from each other. For example, for the PSSCH transmitted or received in carrier index 1, the UE may transmit or receive the PSFCH in carrier index 1 or 2. For the PSSCH transmitted or received in carrier index 2, the UE may transmit or receive the PSFCH in carrier index 1 or 3. For the PSSCH transmitted or received in carrier index 3, the UE may transmit or receive the PSFCH in carrier index 4. For the PSSCH transmitted or received in carrier index 4, the UE may transmit or receive the PSFCH in carrier index 3 or 4. To this end, a carrier index in which the PSFCH is transmitted or received may be dynamically identified through SCI (or DCI) for scheduling the PSSCH. Accordingly, the PSFCH including HARQ-ACK information of the PSSCH transmitted or received in specific carrier i may be transmitted or received in specific carrier i or j, which is determined through the SCI. To sum up, the operations of Case 2 and Case 3 are similar to each other, but Case 2 and Case 3 are different and are distinguished from each other according to whether signaling for determining a carrier in which the PSFCH is transmitted or received is a higher-layer signal (Case 2) or an L1 signal (Case 3).

The PSCCH for scheduling the PSSCH may be also transmitted or received in the same carrier or different carriers, and performing by at least one of or a combination of Case 1 to Case 3 may be possible. It may be possible to have a set of different PSSCH carriers for each UE. It may be possible to have a set of different PSFCH carriers for each UE. It may be possible to have a set of different PSCCH carriers for each UE. The above-described carrier may be substituted by information configured by a time, frequency, or code resource, a bandwidth part, or a cell, and used.

When the UE supports the multiple carriers, a set of carriers for SL transmission and a set of carriers for SL reception may be identical to or different from each other. As an example of a case where the sets are different from each other, there may be a case where the UE performs SL reception through multiple carriers but performs SL transmission through one carrier. The PSFCH may be configured for all carriers or only some of the carriers according to higher-layer signal configuration, and the offsets and transmission/reception periods of the PSFCHs configured for each carrier may be identical to or different from each other. The PSFCH-related higher-layer signal configurations may be UE-specifically, carrier-specifically, or carrier group-specifically determined.

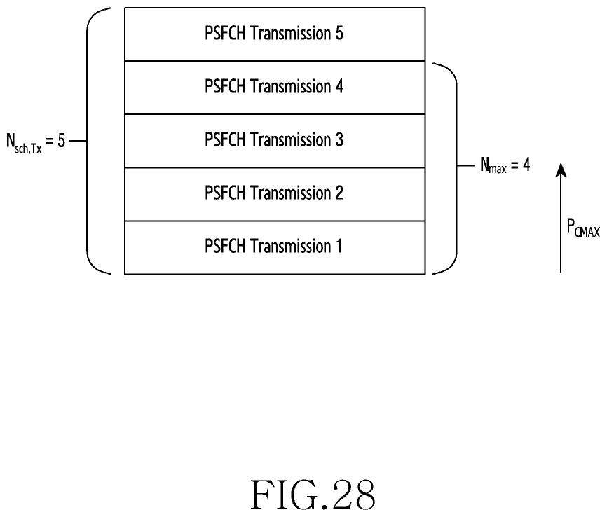

FIG. 28 is a diagram illustrating a method in which a UE allocates transmission power for multiple PSFCH transmissions, according to an embodiment.

Hereinafter, a method in which the UE allocates PSFCH transmission power is described. In a situation where N_{sch,Tx} PSFCHs are scheduled for the UE, when the UE reports, in a resource pool in which the PSFCH is transmitted, that a maximum Nₘₐₓ number of PSFCHs can be transmitted, the UE determines the number N_{Tx} of PSFCHS which can be simultaneously transmitted and power P_{PSFCH,k}(i) for the k^{th} PSFCH transmission. K has a value between 1 and N_{Tx}, and i means a PSFCH transmission location in active BWP b in carrier f. The UE may determine transmission power of the PSFCH through whether dl-P0-PSFCH can be configured, comparison with Nₘₐₓ, and comparison with P_{CMAX}. For example, the determine of the transmission power of the PSFCH may be possible as in the scheme below, such as pseudo code 1.

```
  [pseudo code 1 start]
  1) If dl-P0-PSFCH is provided to UE,
    P_{PSFCH,one} = P_{O,PSFCH} + 10·log₁₀(2^{u}) + α_{PSFCH}·PL [dBm]
  - P_{O,PSFCH} is dl-P0-PSFCH.
  - if dl-Alpha-PSFCH is provided,αPSFCH is a corresponding value, else 1.
  - PL is a path loss value and a value estimated from a reference signal.
    2) If N_{sch,Tx} ≤ Nₘₐₓ,
    3) P_{PSFCH,one} + 10·log₁₀ (N_{sch,Tx}) ≤ P_{CMAX},
      - N_{Tx} = N_{sch,Tx} and P_{PSFCH,k}(i) = P_{PSFCH,one} [dBm]
    3) If P_{PSFCH,one} + 10·log₁₀ (N_{sch,Tx}) > P_{CMAX},
      - UE determines N_{Tx} number of PSFCHs in consideration of conditions below.
      - N_{Tx} ≥ max(1,Σ^{K}ᵢ=₁Mᵢ), Mᵢ is the number of PSFCHs having priority value i,
and K is the largest value satisfying P_{PSFCH,one} + 10·log₁₀ (max(1,Σ^{K}ᵢ=₁Mᵢ)) ≤ P_{CMAX} in
consideration of transmission of all PSFCHs allocated while having priority values 1, 2, ....
  - else, 0
      - P_{PSFCH,k}(i) = min(P_{CMAX} − 10·log₁₀ (N_{Tx,PSFCH}), P_{PSFCH,one}) [dBm]
    2) If N_{sch,Tx} > Nₘₐₓ,
    - UE autonomously selects Nₘₐₓ PSFCH transmissions in ascending order of a
corresponding field value.
    3) If P_{PSFCH,one} + 10·log₁₀ (Nₘₐₓ) ≤ P_{CMAX},
      - N_{Tx} = Nₘₐₓ and P_{PSFCH,k}(i) = P_{PSFCH,one} [dBm]
    3) If P_{PSFCH,one} + 10·log₁₀ (Nₘₐₓ) > P_{CMAX},
      - UE determines N_{Tx} number of PSFCH transmissions in consideration of
conditions below.
      - N_{Tx} ≥ max(1,Σ^{K}ᵢ=₁Mᵢ), Mᵢ is the number of PSFCHs having priority value i,
and K is the largest value satisfying P_{PSFCH,one} + 10·log₁₀ (max(1,Σ^{K}ᵢ=₁Mᵢ)) ≤ P_{CMAX} in
consideration of transmission of all PSFCHs allocated while having priority values 1, 2, ....
      - else, 0
      - P_{PSFCH,k}(i) = min(P_{CMAX} − 10·log₁₀ (N_{Tx,PSFCH}), P_{PSFCH,one}) [dBm]
  1) If no dl-P0-PSFCH is provided to UE,
    - P_{PSFCH,k}(i) = P_{CMAX} − 10·log₁₀ (N_{Tx,PSFCH}) [dBm]
    - UE autonomously determines N_{Tx,PSFCH} PSFCH transmissions in ascending order of
a corresponding priority field value.
  [pseudo code 1 end]
```

For example, FIG. 28 is described with reference to pseudo code 1 above. In a situation where dl-P0-PSFCH is provided to the UE, if five PSFCHs are scheduled (N_{sch,Tx}=5) and Nₘₐₓ is 4, one PSFCH needs to be excluded according to a priority. If PSFCH transmission 5 has the lowest priority in FIG. 28, PSFCH transmission 5 is not performed. Thereafter, the UE compares transmission power with P_{CMAX} with reference to a dl-P0-PSFCH configuration value for transmission of four PSFCHs. If a value of P_{PSFCH,one}+10·log₁₀ (Nₘₐₓ) is greater than P_{CMAX} as in FIG. 28, the UE selects PSFCHs according to priorities. Two, three, or four PSFCHs can be selected, and if two PSFCHs are selected, the UE determines transmission power of each of the PSFCHs according to P_{PSFCH,k}(i)=P_{PSFCH,one} [dBm]. When three or four PSFCHs are selected, the UE determines transmission power of each of the PSFCHs according to P_{PSFCH,k}(i)=P_{CMAX}−10·log₁₀ (N_{Tx,PSFCH}) [dBm]. This is because in a case where three or more PSFCHs are selected, if transmission is performed at P_{PSFCH,one}, P_{CMAX} is exceeded. Whether to select either two PSFCHs or four PSFCHs is selected by the UE. If no dl-P0-PSFCH is provided to the UE, the UE first selects four PSFCHs so that Nₘₐₓ is to be four, and then determines transmission power of each of the PSFCHs according to P_{PSFCH,k}(i)=P_{CMAX}−10·log₁₀ (N_{Tx,PSFCH}) [dBm].

A method is described below for determining a PSFCH transmission resource for PSSCHs received through multiple carriers by the UE supporting SL carrier aggregation. Basically, PSSCHs may be transmitted or received through multiple carriers, and the PSFCH is considered to be transmitted or received in a carrier in which the PSSCH is received. That is, Case 1 is considered in FIG. 27. The methods for determining transmission power for SL channels of the UE in such a situation are described.

There may be a case where different configurations for dl-P0-PSFCH are provided for each carrier. For example, in a situation where SL communication is performed for two carriers, when a dl-P0-PSFCH configuration is provided to a first carrier and no dl-P0-PSFCH configuration is provided to a second carrier, the UE determines whether dl-P0-PSFCH configuration is made for each carrier when determining whether dl-P0-PSFCH configuration information is provided, which corresponds to a condition first determined in [pseudo code 1]), and thus it is unclear to determine PSFCH transmission power thereafter. Accordingly, the UE may determine PSFCH transmission power by at least one of or a combination of the methods below. The methods are methods applied when the UE transmits PSFCHs for two or more multiple carriers, and the UE may operate based on [pseudo code 1] when a PSFCH is transmitted for one carrier.
Method A-1: A dl-P0-PSFCH configuration having the same value for each carrier is provided. Specifically, dl-P0-PSFCH values which can be configured for respective BWP resource pools of carriers are configured to have the same value over multiple carriers. By doing so, the UE may apply [pseudo code 1] in the same manner for one or multiple carriers scheduled to transmit or receive the PSFCH.
Method A-2: PSFCH transmission power can be allocated by prioritizing a carrier for which dl-P0-PSFCH is configured. If a sum of all transmission power of the PSFCH to be transmitted in the carrier for which dl-P0-PSFCH is configured is smaller than P_{CMAX}, the UE can perform transmission by allocating the remaining transmission power to PSFCHs in a carrier for which dl-P0-PSFCH is not configured. Specifically, the transmission power may be determined by Equation (3) below.

$${P}_{PSFCH , c 2} ( i ) = {P}_{cmax} - {P}_{tx , c 1} - 10 {log}_{10} ( {N}_{TX , PSFCH , c 2} ) [ dBm ] \qquad ( 3 )$$

P_{PSFCH,c2}(i) means transmission power for the k-th PSFCH in a carrier for which no dl-P0-PSFCH is configured. P_{tx,c1} means a sum of transmission power for all PSFCHs determined to be transmitted in a carrier for which dl-P0-PSFCH is configured. N_{TX,PSFCH,c2} is the number of PSFCHs determined to be transmitted in a carrier for which no dl-P0-PSFCH is configured, may be equal to or smaller than the number of PSFCHs scheduled in the corresponding carrier, is determined by the UE, where a priority value can be considered, and may be determined according to a UE capability value for transmission of the PSFCH by the UE. The priority value may be determined through SCI through which PSFCH scheduling information is provided. A high priority may mean that a priority-related field value in the corresponding SCI field is small. Alternatively, a high priority may mean that a priority-related field value in the corresponding SCI field is large. If a sum of total transmission power of the PSFCH to be transmitted in a carrier for which dl-P0-PSFCH is configured is equal to or greater than P_{CMAX}, the UE may allocate PSFCH transmission power according to an equation such as Equation (4).

$${P}_{PSFCH , k} ( i ) = {P}_{CMAX} - 10 {log}_{10} ( {N}_{TX , PSFCH} ) [ dBm ] \qquad ( 4 )$$

P_{PSFCH,k}(i) means transmission power of a PSFCH scheduled for each carrier regardless of configuration of dl-P0-PSFCH. N_{TX,PSFCH} means transmission power of a PSFCH to be transmitted for all carriers in which the UE operates. This may be equal to or smaller than the number of scheduled PSFCHs, and may be determined according to a UE capability value for transmission of a PSFCH by the UE. Alternatively, when a sum of total transmission power of the PSFCH to be transmitted in a carrier for which dl-P0-PSFCH is configured is equal to greater than P_{CMAX}, the UE may transmit only the PSFCH to be transmitted in the carrier for which dl-P0-PSFCH is configured, and may not perform PSFCH transmission for the carrier no dl-P0-PSFCH is configured. In addition, transmission power adjustment for the PSFCH to be transmitted in the carrier for which dl-P0-PSFCH is configured may be operated based on [pseudo code 1].
Method A-3: Allocating PSFCH transmission power may be allocated by prioritizing the carrier for which no dl-P0-PSFCH is configured. Specifically, PSFCH transmission is performed by allocating transmission power only to the PSFCH scheduled for the carriers for which no dl-P0-PSFCH is configured, as in Equation (4). In this case, N_{TX,PSFCH} in Equation (4) means the number of PSFCHs scheduled for carriers for which no dl-P0-PSFCH is configured. Accordingly, with respect to the PSFCH scheduled for the carrier for which dl-P0-PSFCH is configured, when at least one PSFCH is scheduled for the carrier for which no dl-P0-PSFCH is configured, the UE does not perform transmission, and when there is no PSFCH scheduled for the carrier for which no dl-P0-PSFCH is configured, the UE may determine transmission power based on [pseudo code 1]. Alternatively, after allocating transmission power by applying Equation (4) to the PSFCH scheduled for carriers no dl-P0-PSFCH is configured, the UE may allocate the remaining transmission power to scheduled PSFCHs in the carrier for which dl-P0-PSFCH is configured, and in this case, [pseudo code 1] is applied. In this case, instead of P_{cmax}, P_{cmax}−P_{tx,c2} is considered, and P_{tx,c2} is a sum of transmission power of the PSFCH scheduled for carriers for which no dl-P0-PSFCH is configured.
Method A-4: When no dl-P0-PSFCH is configured for at least one carrier, the UE may determine PSFCH transmission power by applying the method such as Equation (4) also for the carrier for which dl-P0-PSFCH is configured.
Method A-5: It may be possible to apply method A-2 or method A-3 by selecting a carrier having the highest priority or a carrier including many PSFCHs having high priority values in consideration of the PSFCH priority and determining whether dl-P0-PSFCH is configured or not configured for the corresponding carrier. Alternatively, it may be possible to apply method A-2 or method A-3 by determining whether the lowest carrier index (or the highest carrier index) for which dl-P0-PSFCH is configured or not configured, in consideration of a carrier index.
Method A-6: When configured dl-P0-PSFCH has different values even though dl-P0-PSFCH is configured for each carrier, it may be possible to sequentially allocating PSFCH transmission power by prioritizing a carrier for which the largest dl-P0-PSFCH value is configured. For example, when there are a total of four carriers and dl-P0-PSFCH values are configured in a descending order of a first carrier, a second carrier, a third carrier, and a fourth carrier, transmission power of the PSFCH scheduled for the first carrier is determined. When the sum of transmission power of the PSFCHs scheduled for the first carrier does not exceed P_{CMAX}, transmission power of the PSFCHs scheduled for the second carrier is determined. When the sum of transmission power of the PSFCHs scheduled for the first carrier and the second carrier does not exceed P_{CMAX}, transmission power of the PSFCH scheduled for the third carrier is determined. When the sum of transmission power of the PSFCHs scheduled for the first carrier, the second carrier, and the third carrier does not exceed P_{CMAX}, transmission power of the PSFCH scheduled for the fourth carrier is determined. When the sum of transmission power of the PSFCH scheduled for the first carrier does not exceed P_{CMAX}, transmission power of the PSFCH scheduled for the second carrier is determined. When the sum of transmission power of the PSFCHs scheduled for the first carrier and the second carrier does not exceed P_{CMAX}, the UE may cause P_{CMAX} not to be exceeded by equally reducing the transmission power for each of the PSFCHs scheduled for the second carrier, or may cause P_{CMAX} not to be exceeded by selecting only some PSFCHs having high priorities. In addition, the PSFCHs scheduled for the third carrier and the fourth carrier are not transmitted by the UE. In the above-described example, four carriers are assumed, but two or more carriers may be configured, and it may be possible to sequentially allocating PSFCH transmission power by prioritizing a carrier for dl-P0-PSFCH having the smallest value is configured.
Method A-7: The UE may apply [pseudo code 1] by assuming P_{CMAX} for each carrier. That is, when three carriers are configured, the UE may determine PSFCH transmission power while having the same or different P_{CMAX} value for each carrier. Specifically, when P_{CMAX} is a total of transmission power, a maximum transmission power value (P_{CMAX,c}) for each carrier may be determined by Equation (5) below.

$${P}_{CMAX , c} = {P}_{CMAX} - 10 {log}_{10} ( {N}_{carrier} ) [ dBm ] \qquad ( 5 )$$

N_{carrier} means a total number of carriers configured or activated for SL communication by the UE. Alternatively, the maximum transmission power value (P_{CMAX,c}) for each carrier may be determined in proportion to the number of PSFCHs scheduled for each carrier (or a maximum number of PSFCHs indicated by a UE capability report), and may be determined by Equation (6) below.

$${P}_{CMAX , c} = {P}_{CMAX} - 10 {log}_{10} ( \frac{{N}_{tx}}{{N}_{tx , c}} [ dBm ] \qquad ( 6 )$$

Nₜₓ may mean the number of PSFCHs scheduled for all carriers (or a maximum number of PSFCHs which can be transmitted by the UE for all carriers), and N_{tx,c} may mean the number of PSFCHs scheduled for carrier c (or a maximum number of PSFCHs which can be transmitted by the UE for carrier c).

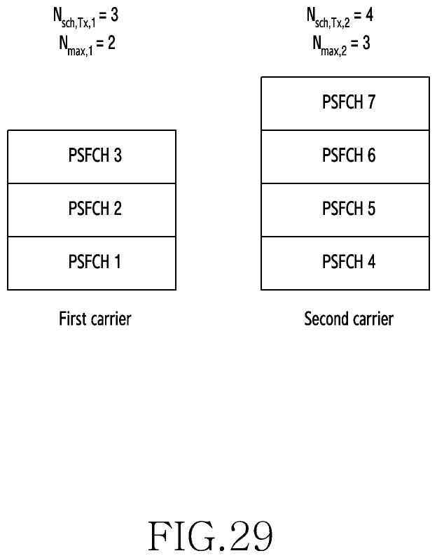

The UE may report different maximum numbers of PSFCHs which can be transmitted for multiple pools configured for multiple carriers, respectively. For example, N_{max,1} of the first carrier and N_{max,2} of the second carrier may have different values from each other. Accordingly, in a situation where multiple carriers are configured, when the number of PSFCHs scheduled for the carriers, respectively, is greater than a maximum number of transmittable PSFCHs which can be supported by the UE, a method for determining the number of PSFCHs in consideration of the priority is required. Therefore, the UE may determine the number of PSFCH transmissions in consideration of at least one the following methods.
Method B-1: The UE considers N_{max,c} reported for each carrier, and when the number N_{sch,Tx,c} of PSFCHs scheduled for the corresponding carrier is greater than N_{max,c}, the UE selects N_{max,c} PSFCHs in consideration of priority information. In a situation where multiple PSFCHs have the same priority, if only some of the PSFCHs need to be selected, the UE may randomly select only some of the PSFCHs. N_{max,c} is a maximum number of PSFCHs which can be transmitted by the UE in a resource pool within carrier c, and is reported as UE capability. N_{sch,Tx,c} is the number of PSFCHs to be transmitted by the UE in the resource pool within carrier c. If the number N_{sch,Tx,c} of PSFCHs scheduled for the corresponding carrier is equal to or smaller than N_{max,c}, the UE may determine to transmit N_{sch,Tx,c} PSFCHs in the corresponding carrier. FIG. 29 illustrates a situation in which PSFCHs are scheduled in resource pools in multiple carriers. In a situation where a total of three PSFCHs are scheduled for a first carrier and a total of four PSFCHs are scheduled for a second carrier, a maximum number of PSFCHs which can be transmitted in the first carrier by the UE is 2 and a maximum number of PSFCHs which can be transmitted by the UE in the second carrier is 3, the UE needs to select PSFCHs having higher priorities in each carrier. Accordingly, a PSFCH having the lowest priority in the first carrier is dropped, and a PSFCH having the lowest priority in the second carrier is dropped.
Method B-2: For N_{max,c} reported for each carrier, the UE may select a PSFCH with reference to a sum Nₘₐₓ of N_{max,c} values of the respective carriers. To explain this with an example in FIG. 29, when the maximum number of PSFCHs which can be transmitted by the UE in the first carrier is 2 and the maximum number of PSFCHs which can be transmitted by the UE in the second carrier is 3, the UE determines that the maximum number of PSFCHs which can be transmitted by the UE over the first carrier and the second carrier is 5. For a total of seven PSFCHs scheduled over the first carrier and the second carrier, the UE may select five PSFCHs having higher priorities and transmit the same. Accordingly, in the same situation, according to method B-1, one PSFCH is dropped for each carrier, but according to method B-2, there may be a case where two PSFCHs are dropped only in the first carrier or two PSFCHs are dropped only in the second carrier.
Method B-3: The UE may separately report a maximum number Nₘₐₓ of PSFCHs which can be simultaneously transmitted in multiple carriers, in addition to a maximum number N_{max,c} of PSFCHs which can be transmitted for each carrier. Unlike method B-2, the Nₘₐₓ value may be the same as or different from a total number of N_{max,c} values of the respective carriers. For example, in FIG. 29, in a situation where N_{max,1}=2 and N_{max,2}=3, Nₘₐₓ may have a value equal to 5 or a value of a natural value other than 5. Accordingly, when PSFCHs are scheduled only for specific carrier c, the UE may determine PSFCH resources according to priorities with reference to a maximum number N_{max,c} of PSFCHs which can be transmitted in the corresponding carrier c, and when PSFCHs are scheduled for multiple carriers, the UE may determine PSFCH resources according to priorities with reference to Nₘₐₓ. In addition, when there are multiple carriers, the same value may be applied to Nₘₐₓ, or different values may be defined therefor according to a combination of carriers. For example, in a situation where a total of three carriers are configured for the UE, Nₘₐₓ may have different values in a case where PSFCHs are scheduled only for the first carrier and the second carrier, a case where PSFCHs are scheduled only for the second carrier and the third carrier, a case where PSFCHs are scheduled only for the first carrier and the third carrier, and a case where PSFCHs are scheduled only in the first carrier, the second carrier, and the third carrier, respectively, and the UE may determine the Nₘₐₓ value related to a combination of carriers for which the PSFCHs are scheduled according to the combination.
Method B-4: The UE may assume that a maximum number of PSFCHs which can be transmitted in the resource pools existing in multiple carriers, respectively, is always the same for the multiple carriers, and report the same. Alternatively, when a maximum transmittable PSFCH number reported in specific carrier c is N_{max,c} and the number of multiple carriers which is configured for the UE or in which the UE operate is C, a maximum number of PSFCHs which can be transmitted by the UE for the corresponding multiple carriers may be determined by C·N_{max,c}.

When the number of PSFCHs scheduled for multiple carriers, respectively, is greater than a maximum transmittable PSFCHs or exceeds maximum transmission power P_{CMAX}, the UE may need to drop some PSFCHs. In this case, the UE may drop a PSFCH having a lower priority in consideration of priorities in units of carriers, or may drop a PSFCH having a lower priority by comprehensively consider multiple carriers and priorities. Specifically, the UE may determine PSFCHs to be transmitted, in consideration of at least one of or a combination of some of the methods below.
Method C-1: The UE may drop PSFCHs having lower priorities in consideration of carrier-specific priority information. For example, in FIG. 29, in a situation where three PSFCHs are scheduled for the first carrier and four PSFCHs are scheduled for the second carrier, when a maximum transmittable PSFCH number in the first carrier is 2 and a maximum transmittable PSFCH number in the second carrier is 3, the UE may transmit PSFCHs having higher priorities for each carrier in consideration of the maximum transmittable PSFCH number for each carrier. In addition, when a maximum transmission power value is divided for each carrier and allocated even though the maximum transmittable PSFCH number is satisfied, the UE may transmit only PSFCHs having higher priorities in consideration of the priorities. For example, even though two maximum transmittable PSFCHs are selected in the first carrier, when a sum of transmission power values of the corresponding PSFCHs exceeds a maximum transmission power value (P_{CMAX,1}) allocated to the first carrier, the UE may select only PSFCHs having higher priorities, and in this case, a maximum of PSFCHs not exceeding P_{CMAX,1} may be selected. The above-described methods are described with reference to a case where the priorities are different for each PSFCH, but when some PSFCHs have the same priority information, the UE may randomly select specific PSFCHs.
Method C-2: The UE may drop, based on priority information of the PSFCHs, PSFCHs having lower priorities in consideration of all carriers. For example, in FIG. 29, in a situation where three PSFCHs are scheduled for the first carrier and four PSFCHs are scheduled for the second carrier, when the maximum number of PSFCHs which can be transmitted by the UE in the first carrier and the second carrier is four, the UE may determine priority information of all PSFCHs scheduled for the first carrier and the second carrier and drop PSFCHs having lower priorities. When PSFCHs 1, 2, and 3 of the first carrier have lower priorities than PSFCHs 4, 5, 6, and 7 of the second carrier, PSFCHs 1, 2, and 3 of the first carrier may be all dropped. As another example, the UE may select PSFCH resources having higher priorities in consideration of priorities for each carrier in consideration of a maximum transmittable PSFCH number for each carrier. In FIG. 29, in a situation where PSFCHs 1 and 2 are selected in the first carrier and PSFCHs 4, 5, and 6 are selected in the second carrier, there may be a case where transmission power for transmission of five PSFCHs exceeds UE maximum transmission power (P_{CMAX}). In such a situation, the UE may select PSFCHs having higher priorities in consideration of priority information of PSFCHs selected in the first carrier and the second carrier. Specifically, in a situation where P_{CMAX} is not exceeded, the UE may select a maximum number of PSFCHs. When PSFCH 1 has the lowest priority and a sum of transmission power values of PSFCHs 2, 4, 5, and 6 remaining after excluding PSFCH 1 does not exceed P_{CMAX}, the UE may select PSFCHs 2, 4, 5, and 6.
Method C-3: The UE may determine PSFCHs to be transmitted, in consideration of carrier index information. When a sum of transmission power values calculated after the UE selects PSFCHs according to priority information in consideration of a maximum transmittable PSFCHs, the UE may consider the priorities in an ascending or descending order of determined indices of each carrier. For example, in FIG. 29, in a situation where PSFCHs 1 and 2 are selected in the first carrier and PSFCHs 4, 5, and 6 are selected in the second carrier, when transmission power for transmission of five PSFCHs exceeds UE maximum transmission power (P_{CMAX}) and the UE determines a PSFCH to be dropped in an ascending order of the carrier index, the UE may drop each of the PSFCHs having lower priorities among PSFCHs 1 and 2 selected in the first carrier and determine whether a sum of transmission power values of the remaining PSFCHs exceeds P_{CMAX}. When both PSFCHs 1 and 2 are dropped and a sum of transmission power values of the remaining PSFCHs still exceeds P_{CMAX}, the UE drops each of the PSFCHs having lower priorities among PSFCHs 4, 5, and 6 of the second carrier and determines whether a sum of transmission power values of the remaining PSFCHs exceeds P_{CMAX}. Accordingly, the UE may select a maximum number of PSFCHs while P_{CMAX} is not exceeded. In the above-described example, whether to drop a PSFCH is determined in ascending order of the carrier index, but the UE may determine whether to drop a PSFCH in descending order of the carrier index. Alternatively, when dl-P0-PSFCH values configured for each carrier are different, the UE may determine whether to drop a PSFCH starting from a carrier having the largest dl-P0-PSFCH value. Alternatively, when dl-P0-PSFCH values configured for each carrier are different, the UE may determine whether to drop a PSFCH starting from a carrier having the smallest dl-P0-PSFCH value.
Method C-4: In the methods above, when a sum of transmission power values of the PSFCHs exceeds maximum transmission power (P_{CMAX}), it is mainly considered that PSFCHs having lower priorities are to be dropped in consideration of priority information, whereas this method is a method for transmitting PSFCHs by adjusting transmission power of an individual PSFCH without considering the priority information. For example, in FIG. 29, in a situation where PSFCHs 1 and 2 are selected in the first carrier and PSFCHs 4, 5, and 6 are selected in the second carrier, when transmission power for transmission of five PSFCHs exceeds UE maximum transmission power (P_{CMAX}), the UE may determine each PSFCH transmission power by applying the method of Equation (4). In this case, N_{TX,PSFCH} in Equation (4) means the number of PSFCHs selected in the first carrier and the second carrier.

In a case where the UE is configured or scheduled to simultaneously perform transmission via a UL and an SL in one carrier or different carriers, when the UE has no capability for simultaneously performing transmission via the UL and the SL in one carrier or different carriers, the UE perform transmission only via a link having the higher priority, i.e., either the UL or the SL.

In a case where the UE is configured or scheduled to perform transmission via the UL and reception via the SL in one carrier, or a case where the UE are configured or scheduled to simultaneously perform transmission via the UL and reception via the SL in different carriers, when the UE has no capability for simultaneously perform transmission via the UL and reception via the SL in different carriers, the UE selects only a link having a higher priority, and if the UL has a higher priority than the SL, the UE performs only transmission via the UL, and if the SL has a higher priority than the UL, the UE performs only reception via the SL.

In a case where the UE can simultaneously perform transmission via the UL and the SL in different carriers, the UE is scheduled or configured to perform transmission via the UL and the SL in each carrier, UL transmission resources and SL transmission resources are overlapped in a specific interval, and a total of UE transmission power values during the corresponding time interval exceeds UE maximum transmission power (P_{CMAX}), when SL transmission has a higher priority than UL transmission, the UE reduces UL transmission power before starting the UL transmission so that the entire UE transmission power does not exceed P_{CMAX}. If the UL transmission has a higher priority than the SL transmission, the UE reduces SL transmission power before starting the side transmission so that the entire UE transmission power does not exceed P_{CMAX}.

For example, the UE may determine priorities between SL transmission/reception and UL transmission by comparing priority threshold information configured via a specific higher-layer signal and priority information of SCI scheduled for SL transmission or reception. When a priority value of the SCI scheduled for SL transmission or reception is smaller than a priority threshold value configured via the higher-layer signal, the UE may determine that the SL transmission/reception has a higher (or lower) priority than the UL transmission. Alternatively, a priority value of the SCI scheduled for SL transmission or reception is equal to or greater than a priority threshold value configured via the higher-layer signal, the UE may determine that the SL transmission/reception has a higher (or lower) priority than the UL transmission.

In a situation where the UE performs SL channel transmission or reception for multiple carriers, when at least some of the corresponding SL resources are overlapped with a UL channel, the UE may determine a priority between the UL and the SL in consideration of at least one of or a combination of some of the methods below.
Method D-1: When a priority of at least one of SL channels transmitted or received by the UE in multiple carriers has a value smaller than a priority threshold value configured via a higher-layer signal, the UE may determine that all SL channels transmitted or received by the UE in the corresponding multiple carriers have a higher (or lower) priority than the UL. If not, the UE may determine that all SL channels transmitted or received by the UE in the corresponding multiple carriers have a lower (or higher) priority than the UL.
Method D-2: When a priority of at least one of SL channels transmitted or received by the UE in multiple carriers has a value equal to or greater than a priority threshold value configured via a higher-layer signal, the UE may determine that all SL channels transmitted or received by the UE in the corresponding multiple carriers have a lower (or higher) priority than the UL. If not, the UE may determine that all SL channels transmitted or received by the UE in the corresponding multiple carriers have a higher (or lower) priority than the UL.
Method D-3: When a priority of an SL channel of a specific carrier among SL channels transmitted or received by the UE in multiple carriers has a value smaller than a priority threshold value configured via a higher-layer signal, the UE may determine that all SL channels transmitted or received by the UE in the corresponding multiple carriers have a higher (or lower) priority than the UL. If not, the UE may determine that all SL channels transmitted or received by the UE in the corresponding multiple carriers have a lower (or higher) priority than the UL. The specific carrier may be configured in advance via the higher-layer signal, or the UE may randomly select the same. Alternatively, the specific carrier may be identical to the UL carrier. Alternatively, the specific carrier may be a carrier having the largest configured dl-P0-PSFCH value. Alternatively, the specific carrier may be a carrier having the smallest dl-P0-PSFCH value.
Method D-4: When a priority of an SL channel of a specific carrier among SL channels transmitted or received by the UE in multiple carriers has a value equal to or greater than a priority threshold value configured via a higher-layer signal, the UE may determine that all SL channels transmitted or received by the UE in the corresponding multiple carriers have a lower (or higher) priority than the UL. If not, the UE may determine that all SL channels transmitted or received by the UE in the corresponding multiple carriers have a higher (or lower) priority than the UL. The specific carrier may be configured in advance via the higher-layer signal, or the UE may select a carrier having the smallest (or largest) index value. Alternatively, the specific carrier may correspond to a carrier identical to the UL carrier. Alternatively, the specific carrier may be a carrier having the largest configured dl-P0-PSFCH value. Alternatively, the specific carrier may be a carrier having the smallest dl-P0-PSFCH value.
Method D-5: When a sum of priorities of SL channels transmitted or received by the UE in multiple carriers is smaller than a priority threshold value configured via a higher-layer signal, the UE may determine that all SL channels transmitted or received by the UE in the corresponding multiple carriers have a higher (or lower) priority than the UL. If not, the UE may determine that all SL channels transmitted or received by the UE in the corresponding multiple carriers have a lower (or higher) priority than the UL. The priority threshold value configured via the higher-layer signal may be information identical to or different from the threshold value described in other methods.
Method D-6: For SL channels transmitted or received by the UE in multiple carriers, the UE may compare priority information and a priority threshold configured in advance via a higher-layer signal for each SL channel scheduled for each carrier. When a priority value of the SCI scheduled for SL transmission/reception is smaller than a priority threshold value configured via the higher-layer, the UE may determine that the SL transmission/reception has a higher (or lower) priority than the UL transmission. Alternatively, when a priority value of the SCI scheduled for SL transmission/reception is equal to or greater than a priority threshold value configured via the higher-layer, the UE may determine that the SL transmission/reception has a lower (or higher) priority than the UL transmission.

The above-described embodiments may be applied in consideration of a combination of all or some of the embodiments according to a UE capability, a base station configuration, or a specific condition.

Methods disclosed in the claims and/or methods described herein may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program includes instructions that cause the electronic device to perform the methods as defined by the appended claims and/or disclosed herein.

These programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form a memory in which the program is stored. In addition, a plurality of such memories may be included in the electronic device.

In addition, the programs may be stored in an attachable storage device which can access the electronic device through communication networks such as the Internet, Intranet, Local Area Network (LAN), Wide LAN (WLAN), and Storage Area Network (SAN) or a combination thereof. Such a storage device may access the electronic device via an external port. Also, a separate storage device on the communication network may access a portable electronic device.

Herein, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

Although specific embodiments have been described in the detailed description of the disclosure, it will be apparent that various modifications and changes may be made thereto without departing from the scope of the disclosure. Therefore, the scope of the disclosure should not be defined as being limited to the embodiments set forth herein, but should be defined by the appended claims and equivalents thereof.

What is claimed is:

1. A method performed by a first user equipment (UE) in a wireless communication system, the method comprising:
receiving, from a second UE, a plurality of physical sidelink shared channels (PSSCHs) on a first plurality of carriers; and
transmitting, to the second UE, a plurality of physical sidelink feedback channels (PSFCHs) on a second plurality of carriers based on a first maximum number of simultaneous PSFCH transmissions in a slot,
wherein each PSFCH of the plurality of PSFCHs corresponds to a respective PSSCH of the plurality of PSSCHs.

2. The method of claim 1, wherein in case that the plurality of PSFCHs are transmitted on a carrier, the plurality of PSFCHs are transmitted based on a second maximum number of simultaneous PSFCH transmissions in a slot.

3. The method of claim 1, wherein the plurality of PSFCHs are transmitted based on a maximum transmission power (P_{CMAX}) for the first UE.

4. The method of claim 1, wherein the plurality of PSFCHs to be transmitted are determined based on priorities of the plurality of PSFCHs.

5. A method performed by a second user equipment (UE) in a wireless communication system, the method comprising:
transmitting, to a first UE, a plurality of physical sidelink shared channels (PSSCHs) on a first plurality of carriers; and
receiving, from the first UE, a plurality of physical sidelink feedback channels (PSFCHs) on a second plurality of carriers based on a first maximum number of simultaneous PSFCH transmissions in a slot,
wherein each PSFCH of the plurality of PSFCHs corresponds to a respective PSSCH of the plurality of PSSCHs.

6. The method of claim 5, wherein in case that the plurality of PSFCHs are transmitted on a carrier, the plurality of PSFCHs are transmitted based on a second maximum number of simultaneous PSFCH transmissions in a slot.

7. The method of claim 5, wherein the plurality of PSFCHs are transmitted based on a maximum transmission power (P_{CMAX}) for the first UE.

8. The method of claim 5, wherein the plurality of PSFCHs to be transmitted are determined based on priorities of the plurality of PSFCHs.

9. A first user equipment (UE) in a wireless communication system, the first UE comprising:
a transceiver; and
a controller coupled to the transceiver; the controller configured to:
receive, from a second UE, a plurality of physical sidelink shared channels (PSSCHs) on a first plurality of carriers; and
transmit, to the second UE, a plurality of physical sidelink feedback channels (PSFCHs) on a second plurality of carriers based on a first maximum number of simultaneous PSFCH transmissions in a slot,
wherein each PSFCH of the plurality of PSFCHs corresponds to a respective PSSCH of the plurality of PSSCHs.

10. The first UE of claim 9, wherein in case that the plurality of PSFCHs are transmitted on a carrier, the plurality of PSFCHs are transmitted based on a second maximum number of simultaneous PSFCH transmissions in a slot.

11. The first UE of claim 9, wherein the plurality of PSFCHs are transmitted based on a maximum transmission power (P_{CMAX}) for the first UE.

12. The first UE of claim 9, wherein the plurality of PSFCHs to be transmitted are determined based on priorities of the plurality of PSFCHs.

13. A second user equipment (UE) in a wireless communication system, the second UE comprising:
a transceiver; and
a controller coupled to the transceiver; the controller configured to:
transmit, to a first UE, a plurality of physical sidelink shared channels (PSSCHs) on a first plurality of carriers; and
receive, from the first UE, a plurality of physical sidelink feedback channels (PSFCHs) on a second plurality of carriers based on a first maximum number of simultaneous PSFCH transmissions in a slot,
wherein each PSFCH of the plurality of PSFCHs corresponds to a respective PSSCH of the plurality of PSSCHs.

14. The second UE of claim 13, wherein in case that the plurality of PSFCHs are transmitted on a carrier, the plurality of PSFCHs are transmitted based on a second maximum number of simultaneous PSFCH transmissions in a slot.

15. The second UE of claim 13, wherein the plurality of PSFCHs are transmitted based on a maximum transmission power (P_{CMAX}) for the first UE.

16. The second UE of claim 13, wherein the plurality of PSFCHs to be transmitted are determined based on priorities of the plurality of PSFCHs.
